(19) United States
(12) Patent Application Publication
(10) Pub. No.: US 2025/0294378 A1
(43) Pub. Date: Sep. 18, 2025

(54) METHOD FOR SENSING BY PROXY AND COMMUNICATION DEVICE

(71) Applicant: GUANGDONG OPPO MOBILE TELECOMMUNICATIONS CORP., LTD., Dongguan (CN)

(72) Inventors: Shiwen HE, Dongguan (CN); Ning GAO, Dongguan (CN); Chaoming LUO, Dongguan (CN); Shiyue HUANG, Dongguan (CN); Kangli CAI, Dongguan (CN)

(21) Appl. No.: 19/222,503

(22) Filed: May 29, 2025

Related U.S. Application Data
(63) Continuation of application No. PCT/CN2022/136380, filed on Dec. 2, 2022.

(51) Int. Cl. H04W 24/02; H04W 84/12

(52) U.S. Cl. CPC H04W 24/02; H04W 84/12

(57) ABSTRACT

Provided is a method for sensing by proxy (SBP). The method is applicable to an SBP initiator supporting a first frequency band and the method includes: transmitting an SBP Request frame to an SBP responder, wherein the SBP Request frame is used to request the SBP responder to perform sensing measurement of a second frequency band in a proxy mode, or request the SBP responder to perform sensing measurement of the first frequency band and the second frequency band in a proxy mode; and receiving an SBP Response frame from the SBP responder, wherein the SBP responder is a device that supports both the first frequency band and the second frequency band.

### CROSS-REFERENCE TO RELATED APPLICATION

This application is a continuation of International Application No. PCT/CN2022/136380, filed Dec. 2, 2022, the entire disclosure of which is incorporated herein by reference.

### TECHNICAL FIELD

Embodiments of the present disclosure relate to the field of wireless local area network (WLAN) sensing, and in particular, relate to a method for sensing by proxy (SBP), and a communication device thereof.

### RELATED ART

WLAN sensing refers to a method and application for sensing a person or an object in an environment by measuring changes in WLAN signals upon scattering and/or reflection by the person or the object. That is, the WLAN sensing measures and senses the surrounding environment based on wireless signals, thereby enabling functions such as detecting indoor intrusions/movements/falls, posture recognition, and establishment of three-dimensional spatial images.

### SUMMARY

Embodiments of the present disclosure provides a method for SBP, and a communication device thereof. The technical solutions are as follows.

According to some embodiments of the present disclosure, a method for SBP is provided. The method is applicable to an SBP initiator supporting a first frequency band. The method includes: transmitting an SBP Request frame to an SBP responder, wherein the SBP Request frame is used to request the SBP responder to perform sensing measurement of a second frequency band in a proxy mode, or request the SBP responder to perform sensing measurement of the first frequency band and the second frequency band in a proxy mode; and receiving an SBP Response frame from the SBP responder, wherein the SBP responder is a device that supports both the first frequency band and the second frequency band.

According to some embodiments of the present disclosure, a communication device is provided. The communication device includes: a processor; and a memory, configured to store one or more executable instructions of the processor, wherein the processor is configured to load the one or more executable instructions to cause the communication device to: transmit an SBP Request frame to an SBP responder, wherein the SBP Request frame is used to request the SBP responder to perform sensing measurement of a second frequency band in a proxy mode, or request the SBP responder to perform sensing measurement of the first frequency band and the second frequency band in a proxy mode; and receive an SBP Response frame from the SBP responder, wherein the SBP responder is a device that supports both the first frequency band and the second frequency band.

According to some embodiments of the present disclosure, a communication device is provided. The communication device includes: a processor; and a memory, configured to store one or more executable instructions of the processor, wherein the processor is configured to load the one or more executable instructions to cause the communication device to: receive an SBP Request frame from an SBP initiator, wherein the SBP Request frame is used to request the SBP responder to perform sensing measurement of the second frequency band in a proxy mode, or request the SBP responder to perform sensing measurement of the first frequency band and the second frequency band in a proxy mode; and transmit an SBP Response frame to the SBP initiator, wherein the SBP initiator is a device that supports the first frequency band but does not support the second frequency band.

### BRIEF DESCRIPTION OF THE DRAWINGS

For clearer descriptions of the technical solutions in embodiments of the present disclosure, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of an SBP measurement establishing process provided in the related art;

FIG. 2 is a schematic diagram of a millimeter wave SBP measurement establishment process provided in the related art;

FIG. 3 is a schematic diagram of a Sub-7 frequency band SBP measurement establishment process provided in the related art;

FIG. 4 is a schematic diagram of a wireless communication system according to some embodiments of the present disclosure;

FIG. 5 is a flowchart of a method for SBP according to some embodiments of the present disclosure;

FIG. 6 is a flowchart of a method for SBP according to some embodiments of the present disclosure;

FIG. 7 is a flowchart of a method for SBP according to some embodiments of the present disclosure;

FIG. 8 is a flowchart of a method for SBP according to some embodiments of the present disclosure;

FIG. 9 is a diagram of a scenario in which a low-frequency band device requests to perform SBP in a high-frequency band according to some embodiments of the present disclosure;

FIG. 10 is a flowchart in which a low-frequency band device requests to perform SBP in a high-frequency band according to some embodiments of the present disclosure;

FIG. 11 is a diagram of a scenario in which a low-frequency band device simultaneously requests to perform SBP in a low-frequency band and a high-frequency band according to some embodiments of the present disclosure;

FIG. 12 is a flowchart in which a low-frequency band device simultaneously requests to perform SBP in a low-frequency band and a high-frequency band according to some embodiments of the present disclosure;

FIG. 13 is a schematic diagram of a frame structure of an SBP Request frame according to some embodiments of the present disclosure;

FIG. 14 is a schematic diagram of a frame structure of an SBP Request frame according to some embodiments of the present disclosure;

FIG. 15 is a schematic diagram of a frame structure of an SBP Response frame according to some embodiments of the present disclosure;

FIG. 16 is a schematic diagram of a frame structure of an SBP Report frame according to some embodiments of the present disclosure;

FIG. 17 is a schematic diagram of a frame structure of an SBP Termination frame according to some embodiments of the present disclosure;

FIG. 18 is a diagram of a scenario in which a high-frequency band device requests to perform SBP in a low-frequency band according to some embodiments of the present disclosure;

FIG. 19 is a flowchart in which a high-frequency band device requests to perform SBP in a low-frequency band according to some embodiments of the present disclosure;

FIG. 20 is a diagram of a scenario in which a high-frequency band device simultaneously requests to perform SBP in a low-frequency band and a high-frequency band according to some embodiments of the present disclosure;

FIG. 21 is a flowchart in which a high-frequency band device simultaneously requests to perform SBP in a low-frequency band and a high-frequency band according to some embodiments of the present disclosure;

FIG. 22 is a schematic diagram of a frame structure of a Directional Multi-Gigabit (DMG) SBP Request frame according to some embodiments of the present disclosure;

FIG. 23 is a schematic diagram of a frame structure of a DMG SBP Request frame according to some embodiments of the present disclosure;

FIG. 24 is a schematic diagram of a frame structure of a DMG SBP Response frame according to some embodiments of the present disclosure;

FIG. 25 is a schematic diagram of a frame structure of a DMG SBP Report frame according to some embodiments of the present disclosure;

FIG. 26 is a schematic diagram of a frame structure of a DMG SBP Termination frame according to some embodiments of the present disclosure;

FIG. 27 is a diagram of a scenario of cross-frequency band SBP according to some embodiments of the present disclosure;

FIG. 28 is a schematic diagram of a field structure of a Public Action field of a Sub-7 device according to some embodiments of the present disclosure;

FIG. 29 is a flowchart in which a low-frequency band device requests to perform SBP in a high-frequency band according to some embodiments of the present disclosure;

FIG. 30 is a schematic diagram of a field structure of an Unprotected DMG Action field of a DMG device according to some embodiments of the present disclosure;

FIG. 31 is a flowchart in which a high-frequency band device requests to perform SBP in a low-frequency band according to some embodiments of the present disclosure;

FIG. 32 is a structural block diagram of an apparatus for SBP according to some embodiments of the present disclosure;

FIG. 33 is a structural block diagram of an apparatus for SBP according to some embodiments of the present disclosure; and

FIG. 34 is a structural block diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. Reference is made in detail to the embodiments, examples of which are illustrated in the accompanying drawings. When the following description refers to the accompanying drawings, the same numbers in different accompanying drawings represent the same or similar elements unless otherwise indicated. The embodiments described in the following embodiments do not represent all embodiments consistent with the present disclosure. Rather, they are merely examples of apparatus and methods consistent with some aspects of the present disclosure, as detailed in the appended claims.

The terms used in the present disclosure are for the purpose of describing particular embodiments only and are not intended to be limiting to the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” “third,” or the like may be used herein to describe various information, such information should not be limited to these terms. These terms are only used to distinguish one type of information from another. For example, first information may also be referred to as second information, and similarly, second information may also be referred to as first information, without departing from the scope of the present disclosure. The word “if,” or “when” as used herein, may be interpreted as “in a case that,” “in a case where,” “in the case that,” “in the case of,” or “in response to determining that,” depending on the context.

### Terms Involved in the Embodiments of the Present Disclosure are Described as Follows.

WLAN sensing: sensing a person or an object in an environment by measuring changes in WLAN signals upon scattering and/or reflection by the person or the object. That is, WLAN sensing measures and senses the surrounding environment based on wireless signals, thereby enabling various functions such as detecting indoor intrusions/movements/falls, posture recognition, and the establishment of three-dimensional spatial images.

SBP: a process of requesting other devices to initiate sensing measurement and acquiring a sensing result. That is, other devices perform sensing measurement in a proxy mode, such that the sensing result is acquired.

WLAN devices participating in the WLAN sensing may play the following roles.

Sensing responder: a device other than an SBP initiator that participates in sensing measurement.

Sensing initiator: also referred to as a sensing session initiator, a sensing initiating device, or a sensing initiating apparatus. The sensing initiator is a device that initiates sensing measurement and desires to acquire the sensing result.

SBP initiator: also referred to as a proxy request device or SBP request device, which is a device that requests other devices to initiate sensing measurement and desires to acquire the sensing result.

SBP responder: also referred to as a sensing proxy station (STA) or SBP response device, which is a device that responds to a request from the SBP initiator and initiates sensing measurement.

Sensing participant: in the embodiments of the present disclosure, the sensing participant may include the SBP initiator participating in sensing measurement, or only include a device other than the SBP initiator that participates in sensing measurement. That is, in this case, the meaning of the sensing participant is the same as that of the sensing responder.

A WLAN terminal may have one or more roles in one sensing measurement, for example, the SBP initiator may be only the SBP initiator, may also be the SBP responder, or may also be both the SBP initiator and the SBP responder.

### SBP Process

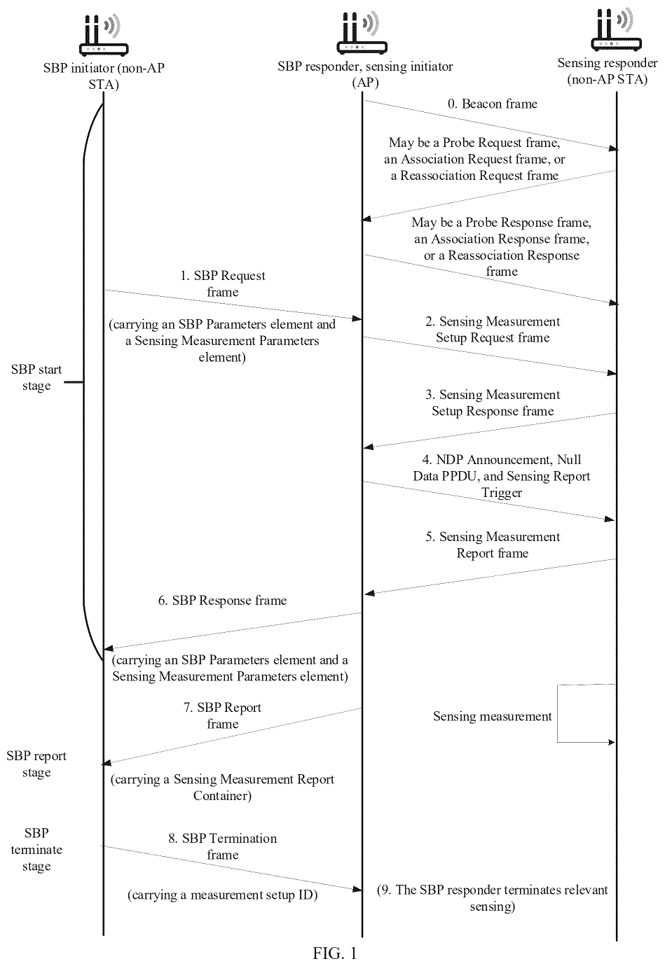

In some embodiments, FIG. 1 is a schematic diagram of an SBP measurement establishment process provided in the related art.

FIG. 1 illustrates an SBP initiator, an SBP responder, a sensing initiator, and a sensing responder. The SBP responder is configured to respond to an SBP request of the SBP initiator, and meanwhile acts as the sensing initiator for initiating sensing.

Establishing SBP measurement includes an SBP start stage, an SBP report stage, and an SBP terminate stage. An SBP measurement establishment process is briefly described hereinafter.
0. The sensing initiator (AP) broadcasts a Beacon frame, and the sensing responder (non-AP STA) actively transmits a Probe Request frame, an Association Request frame, or a Reassociation Request frame to the sensing initiator; and receives the Probe Request frame, the Association Request frame, or the Reassociation Request frame returned by the sensing initiator for exchanging capability information of the sensing initiator and the sensing responder.
1. The SBP initiator (non-AP STA) requests the SBP responder (AP) to establish SBP measurement (such as WLAN sensing) by transmitting an SBP Request frame to the SBP responder.

In some embodiments, the SBP Request frame carries at least one of an SBP Parameters element or a Sensing Measurement Parameters element. The SBP Parameters element indicates operation parameters of an SBP process. The Sensing Measurement Parameters element indicates operation parameters of a sensing measurement process.
2. The SBP responder negotiates with the sensing responder the operation parameters in the sensing measurement process by transmitting a Sensing Measurement Setup Request frame to the sensing responder.
3. The sensing responder indicates confirmation of establishing the sensing measurement by transmitting a Sensing Measurement Setup Response frame to the SBP responder.
4. The SBP responder triggers the sensing measurement process by transmitting at least one of an NDP Announcement (NDPA) frame, a Null Data PPDU (NDP) frame, or a Sensing Report Trigger frame to the sensing responder.
5. The sensing responder accepts the sensing measurement process and transmits a sensing measurement report by transmitting a Sensing Measurement Report frame to the SBP responder.
6. The SBP responder indicates acceptance of an SBP task by transmitting an SBP Response frame to the SBP initiator.

In some embodiments, the SBP Response frame carries at least one of the SBP Parameters element or the Sensing Measurement Parameters element.

Processes 0 to 6 described above belong to the SBP start stage.
7. The sensing responder completes sensing measurement and reports a sensing measurement result to the SBP responder. The SBP responder notifies the sensing measurement result by transmitting an SBP Report frame to the SBP initiator.

In some embodiments, the SBP Report frame carries a Sensing Measurement Report Container. The Sensing Measurement Report Container is used to carry the sensing measurement report.

Process 7 described above belongs to the SBP report stage.
8. The SBP initiator indicates termination of the sensing measurement process by transmitting an SBP Termination frame to the SBP responder.

In some embodiments, the SBP Termination frame carries a Measurement Setup ID. The Measurement Setup ID indicates a sensing measurement process established by the SBP responder.
9. The SBP responder terminates relevant sensing.

Processes 8 to 9 described above belong to the SBP terminate stage.

### SBP Process of High-Frequency Band

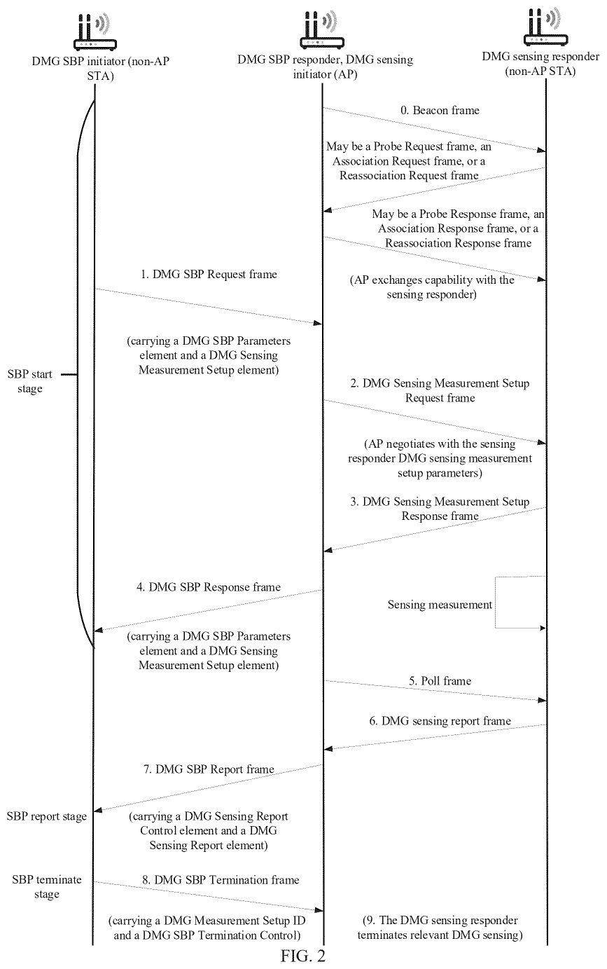

In some embodiments, FIG. 2 is a schematic diagram of a millimeter wave (DMG) SBP measurement establishment process provided in the related art.

FIG. 2 illustrates a DMG SBP initiator, a DMG SBP responder, a DMG sensing initiator, and a DMG sensing responder. The DMG SBP responder is configured to respond to an SBP request of the DMG SBP initiator, and meanwhile acts as the DMG sensing initiator for initiating sensing.

Establishing millimeter wave SBP measurement includes an SBP start stage, an SBP report stage, and an SBP terminate stage. A DMG SBP measurement establishment process is briefly described hereinafter.
0. The DMG sensing initiator (AP) broadcasts a Beacon frame, and the DMG sensing responder (non-AP STA) actively transmits a Probe Request frame, an Association Request frame, or a Reassociation Request frame to the DMG sensing initiator, and receives the Probe Request frame, the Association Request frame, or the Reassociation Request frame returned by the DMG sensing initiator for exchanging capability information of the DMG sensing initiator and the DMG sensing responder.
1. The DMG SBP initiator (non-AP STA) requests the DMG SBP responder (AP) to establish DMG SBP measurement (such as DMG sensing) by transmitting a DMG SBP Request frame to the DMG SBP responder.

In some embodiments, the DMG SBP Request frame carries at least one of a DMG SBP Parameters element or a DMG Sensing Measurement Setup element. The DMG SBP Parameters element indicates operation parameters of an SBP process. The DMG Sensing Measurement Setup element indicates operation parameters of a sensing measurement process.
2. The DMG SBP responder negotiates with the DMG sensing responder operation parameters in a DMG sensing measurement process by transmitting a DMG Sensing Measurement Setup Request frame to the DMG sensing responder.
3. The DMG sensing responder indicates confirmation of establishing DMG sensing measurement by transmitting a DMG Sensing Measurement Setup Response frame to the DMG SBP responder.
4. The DMG SBP responder indicates acceptance of an SBP task by transmitting a DMG SBP Response frame to the DMG SBP initiator.

In some embodiments, the DMG SBP Response frame carries at least one of the DMG SBP Parameters element or the DMG Sensing Measurement Setup element.

Processes 0 to 4 described above belong to the SBP start stage.
5. The DMG sensing responder completes sensing measurement, and the DMG SBP responder triggers the DMG sensing responder to report a DMG sensing measurement result by transmitting a Poll frame to the DMG sensing responder.
6. The DMG sensing responder reports the DMG sensing measurement result by transmitting a DMG Sensing Report frame to the DMG SBP responder.
7. The DMG SBP responder notifies the DMG sensing measurement result by transmitting a DMG SBP Report frame to the DMG SBP initiator.

In some embodiments, the DMG SBP Report frame carries at least one of a DMG Sensing Report Control element or a DMG Sensing Report element. The DMG Sensing Report Control element and the DMG Sensing Report element indicate the DMG sensing measurement result. Processes 5 to 7 described above belong to the SBP report stage.
8. The DMG SBP initiator indicates termination of the DMG sensing measurement process by transmitting a DMG SBP Termination frame to the DMG SBP responder.

In some embodiments, the DMG SBP Termination frame carries a DMG Measurement Setup ID and a DMG SBP Termination Control field. The DMG Measurement Setup ID indicates a DMG sensing measurement process established by the DMG SBP responder. The DMG SBP Termination Control field is used to control the termination of the DMG sensing measurement process.
9. The DMG SBP responder terminates relevant DMG sensing.

Processes 8 to 9 described above belong to the SBP terminate stage.

### SBP Process of Low-Frequency Band

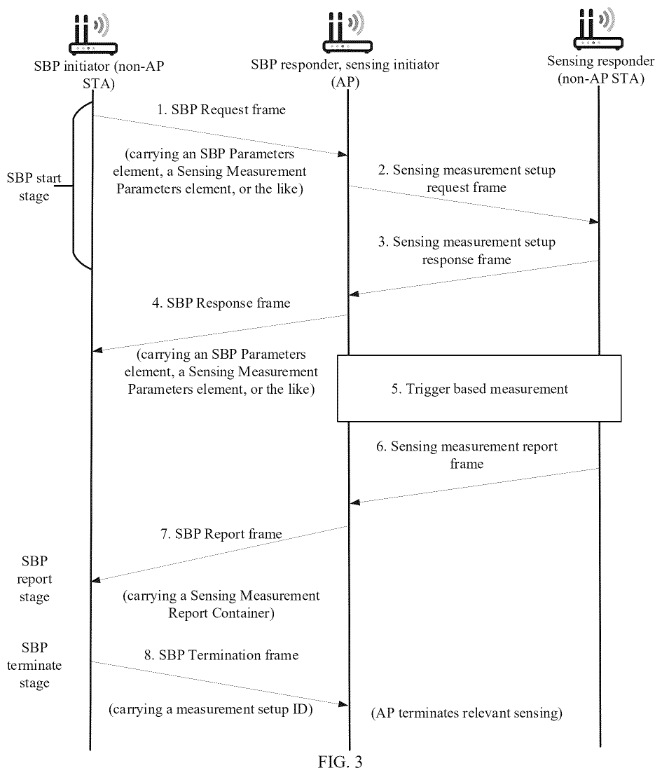

In some embodiments, FIG. 3 is a schematic diagram of a Sub-7 frequency band SBP measurement establishment process provided in the related art.

FIG. 3 illustrates an SBP initiator, an SBP responder, a sensing initiator, and a sensing responder. The SBP responder is configured to respond to an SBP request of the SBP initiator, and meanwhile acts as the sensing initiator for initiating sensing.

Establishing Sub-7 frequency band SBP measurement includes an SBP start stage, an SBP report stage, and an SBP terminate stage. A Sub-7 frequency band SBP measurement establishment process is briefly described hereinafter.
0. The sensing initiator (AP) broadcasts a Beacon frame, and the sensing responder (non-AP STA) actively transmits a Probe Request frame, an Association Request frame, or a Reassociation Request frame to the sensing initiator; and receives the Probe Request frame, the Association Request frame, or the Reassociation Request frame returned by the sensing initiator for exchanging capability information of the sensing initiator and the sensing responder.
1. The SBP initiator (non-AP STA) requests the SBP responder (AP) to establish Sub-7 frequency band SBP measurement by transmitting an SBP Request frame to the SBP responder.

In some embodiments, the SBP Request frame carries at least one of an SBP Parameters element or a Sensing Measurement Setup element. The SBP Parameters element indicates operation parameters of an SBP process. The Sensing Measurement Setup element indicates operation parameters of a sensing measurement process.
2. The SBP responder negotiates with the sensing responder the operation parameters in the sensing measurement process by transmitting a Sensing Measurement Setup Request frame to the sensing responder.
3. The sensing responder indicates confirmation of establishing the sensing measurement by transmitting a Sensing Measurement Setup Response frame to the SBP responder.
4. The SBP responder indicates acceptance of an SBP task by transmitting an SBP Response frame to the SBP initiator.

In some embodiments, the SBP Response frame carries at least one of the SBP Parameters element or the Sensing Measurement Setup element.

Processes 0 to 4 described above belong to the SBP start stage.
5. The SBP responder and the sensing responder complete sensing measurement through a Trigger based (TF) measurement process (TF Sounding).
6. The sensing responder reports a sensing measurement result by transmitting a Sensing Measurement Report frame to the SBP responder.
7. The SBP responder notifies the sensing measurement result to the SBP initiator by transmitting an SBP Report frame to the SBP initiator.

In some embodiments, the SBP Report frame carries a Sensing Measurement Report Container.

Processes 5 to 7 described above belong to the SBP report stage.
8. The SBP initiator indicates termination of the sensing measurement process by transmitting an SBP Termination frame to the SBP responder, and the SBP responder terminates relevant sensing.

In some embodiments, the SBP Termination frame carries a Measurement Setup ID.

Process 8 described above belongs to the SBP terminate stage.

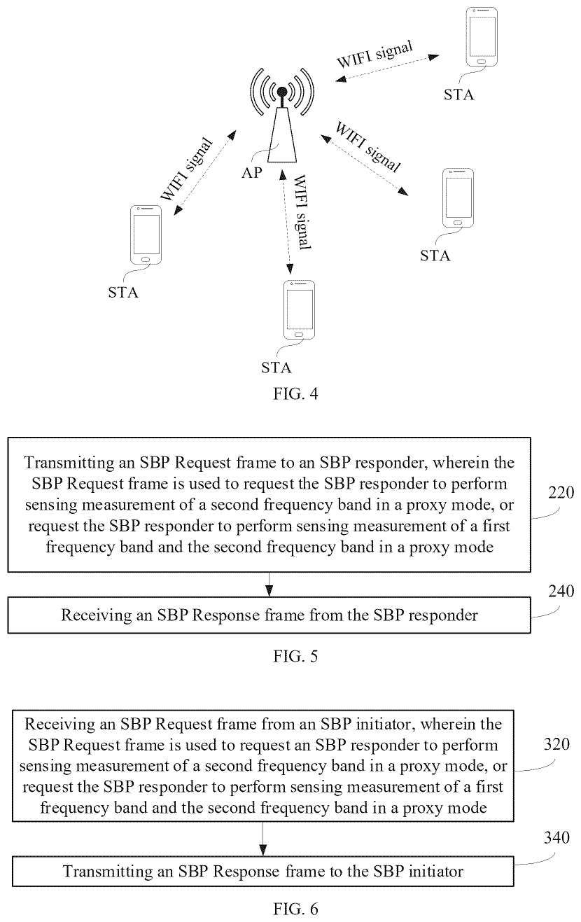

FIG. 4 is a schematic diagram of a wireless communication system according to some embodiments of the present disclosure. As illustrated in FIG. 4, the wireless communication system includes an access point (AP) and stations (STAs).

In some scenarios, the AP is also referred to as an AP STA. That is, the AP is also a type of STA in certain sense. In some scenarios, the STA is also referred to as a non-AP STA.

In some embodiments, STAs include an AP STA and a non-AP STA. The communication within the communication system may be communication between the AP and the non-AP STA, communication between the non-AP STAs, or communication between the STA and a peer STA. The peer STA refers to a device that is in peer-to-peer communication with the STA. For example, the peer STA is an AP or a non-AP STA.

The AP functions as a bridge connecting wired and wireless networks, primarily serving to connect various wireless network clients together and then access the wireless network to the Ethernet. An AP device may be a terminal device (e.g., mobile phone) equipped with a Wi-Fi chip or a network device (e.g., wireless router).

It is understandable that the role of the STA in the communication system is not absolute. For example, in some scenarios, the mobile phone is a non-AP STA in a case where a mobile phone connects to a router, and the mobile phone is an AP in a case where the mobile phone is a hotspot for other mobile phones.

Both the AP and the non-AP STA are devices applicable to the Internet of vehicles, nodes and sensors in the Internet of things (IoT), smart cameras, smart remotes, smart water meters and electricity meters in smart homes, sensors in smart cities, or the like.

In some embodiments, the non-AP STA supports the 802.11be standard. The non-AP STA also supports various current and future WLAN standards of the 802.11 series, such as 802.11ax, 802.11ac, 802.11n, 802.11g, 802.11b, and 802.11a.

In some embodiments, the AP is a device that supports the 802.11be standard. The AP may also a device that supports various current and future WLAN standards of the 802.11 series, such as the 802.11ax, the 802.11ac, the 802.11n, the 802.11g, the 802.11b, and the 802.11a.

It should be noted that the above protocols are only examples, and the protocols supported by the AP and the STA are not limited to the above protocols.

In the embodiments of the present disclosure, the STA may be a device that supports WLAN/Wi-Fi technology, such as a mobile phone, a pad, a computer, a virtual reality (VR) device, an augmented reality (AR) device, a wireless device in industrial control, a set-top box, a wireless device in self-driving, an in-vehicle communication device, a wireless device in remote medical, a wireless device in smart grids, a wireless device in transportation safety, a wireless device in smart cities, a wireless device in smart homes, a wireless communication chip, an application specific integrated circuit (ASIC), a system on chip (SoC), or the like.

Frequency bands supported by the WLAN technology include but are not limited to low-frequency bands (2.4 GHz, 5 GHz, and 6 GHz) and high-frequency bands (45 GHz and 60 GHz).

One or more links are present between the STA and the AP. In some embodiments, the STA and the AP support multi-frequency-band communication, for example, simultaneous communications at frequency bands of 2.4 GHz, 5 GHz, 6 GHz, 45 GHz, and 60 GHz, or simultaneous communications in different channels at a same frequency band (or different frequency bands), such that the communication throughput and/or reliability between devices are improved. Such devices are often referred to as multi-frequency-band devices, multi-link devices (MLDs), multi-link entities, or multi-frequency-band entities. The MLD is an AP device or an STA device. In a case where the MLD is an AP device, the MLD includes one or more APs. In a case where the MLD is an STA device, the MLD includes one or more non-AP STAs.

The MLD including one or more APs is referred to as an AP, and the MLD including one or more non-AP STAs is referred to as a non-AP.

In some embodiments of the present disclosure, the AP includes a plurality of APs, the non-AP includes a plurality of STAs, a plurality of links are formed between the plurality of APs in the AP and the plurality of STAs in the non-AP, and data communication between the plurality of APs in the AP and the corresponding STAs in the non-AP is achieved over the corresponding links.

The AP is a device deployed in a WLAN to provide a wireless communication function for the STA. The STA includes: a user equipment (UE), an access terminal, a subscriber unit, a subscriber station, a mobile station, a mobile console, a remote station, a remote terminal, a mobile device, a wireless communication device, a user agent, a user device, or the like. In some embodiments, the STA is a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, or a wearable device, which is not limited in the embodiments of the present disclosure.

In a wireless communication protocol version of the related art, SBP processes supporting a DMG frequency band and a Sub-7 frequency band are similar in term of procedure. However, the related art does not consider how an SBP initiator supporting the Sub-7 frequency band requests an SBP initiator supporting the DMG frequency band to perform SBP in a case where the SBP initiator supporting the Sub-7 frequency band imposes a high-precision sensing requirement or devices operating in the same frequency band are unavailable, and how the SBP initiator supporting the DMG frequency band requests the SBP initiator supporting the Sub-7 frequency band to perform SBP in a case where the SBP initiator supporting the DMG frequency band imposes a low-precision sensing requirement or devices operating in the same frequency band are unavailable.

Based on this, the embodiments of the present disclosure provide a design solution for the SBP processes under the DMG frequency band and the Sub-7 frequency band in the related art. Compared with the SBP processes which are distinguished under the DMG frequency band and the Sub-7 frequency band in the related art, an SBP initiator according to the embodiments of the present disclosure is capable of requesting to perform cross-frequency band SBP, and the application of SBP may be effectively extended.

In some embodiments, requesting to perform cross-frequency band SBP according to some embodiments of the present disclosure includes the following scenarios.
1. A low-frequency band device requests to perform SBP in a high-frequency band.
2. A high-frequency band device requests to perform SBP in a low-frequency band.
3. Simultaneously requesting SBP in different frequency bands (low-frequency bands and high-frequency bands).

In a case where the cross-frequency band design is to be realized, an SBP initiator needs to indicate a frequency band to be requested by the SBP initiator to an SBP responder and carry relevant information of SBP in the corresponding frequency band, and then the SBP responder responds to a request of the SBP initiator and initiates sensing measurement of the corresponding frequency band.

### Based on This:

For scenario 1, in a case where the low-frequency band device serves as the SBP initiator, the SBP initiator needs to indicate to the SBP responder that a frequency band to be requested by the SBP initiator is a high-frequency band, and carry relevant information of SBP in the high-frequency band.

For scenario 2, in a case where the high-frequency band device serves as the SBP initiator, the SBP initiator needs to indicate to the SBP responder that a frequency band to be requested by the SBP initiator is a low-frequency band, and carry relevant information of SBP in the low-frequency band.

For scenario 3, in a case where the low-frequency band device or the high-frequency band device serves as the SBP initiator, the SBP initiator needs to indicate to the SBP responder that a frequency band to be requested by the SBP initiator is a low-frequency band and a high-frequency band, and carry relevant information of SBP in both the low-frequency band and the high-frequency band.

Hereinafter, descriptions are given of sensing flows on the SBP initiator and the SBP responder in the embodiments of the present disclosure.

### SBP Initiator:

FIG. 5 is a flowchart of a method for SBP according to some embodiments of the present disclosure. The method which is applicable to an SBP initiator supporting a first frequency band is described as an example, and the SBP initiator may be the STA or the AP illustrated in FIG. 4. The method includes at least part of the following processes.

In process 220, the SBP initiator transmits an SBP Request frame to an SBP responder, wherein the SBP Request frame is used to request the SBP responder to perform sensing measurement of a second frequency band in a proxy mode, or request the SBP responder to perform sensing measurement of a first frequency band and the second frequency band in a proxy mode.

In process 240, the SBP initiator receives an SBP Response frame from the SBP responder.

### SBP Responder:

FIG. 6 is a flowchart of a method for SBP according to some embodiments of the present disclosure. The method which is applicable to an SBP responder supporting both a first frequency band and a second frequency band is described as an example, and the SBP responder may be the AP or the STA illustrated in FIG. 4. The method includes at least part of the following processes.

In process 320, the SBP responder receives an SBP Request frame from an SBP initiator, wherein the SBP Request frame is used to request the SBP responder to perform sensing measurement of the second frequency band in a proxy mode, or request the SBP responder to perform sensing measurement of the first frequency band and the second frequency band in a proxy mode.

In process 340, the SBP responder transmits an SBP Response frame to the SBP initiator.

In some embodiments, the first frequency band is a low-frequency band, such as a Sub-7 frequency band, and the SBP initiator supporting the first frequency band is an SBP initiator supporting the Sub-7 band, and also referred to as a Sub-7 device or a low-frequency band device.

In some embodiments, the first frequency band is a high-frequency band, such as a DMG frequency band, a millimeter wave frequency band, a terahertz frequency band, or a visible light frequency band. The present embodiment takes the DMG frequency band as an example, and the SBP initiator supporting the first frequency band is an SBP initiator supporting the DMG frequency band, and also referred to as a DMG device or a high-frequency band device.

### 1. Design of a Frame Format of the SBP Request Frame:

In some embodiments, the SBP Request frame is used to request the SBP responder to perform sensing measurement of the second frequency band in a proxy mode, or request the SBP responder to perform sensing measurement of the first frequency band and the second frequency band in a proxy mode.

In some embodiments, the SBP Request frame needs to indicate to the SBP responder a frequency band to be requested by the SBP initiator, and carry relevant information of SBP in the corresponding frequency band.

In some embodiments, based on FIGS. 5 and 6, the SBP Request frame carries at least one of the following elements or fields.
Information related to an SBP type, indicating a frequency band of sensing measurement requested to be performed by the SBP responder in a proxy mode.

The information related to the SBP type may be explicitly indicated by adopting a mode of increasing values to existing information fields in the SBP Request frame; or explicitly indicated by adopting a method of newly added information fields in the SBP Request frame; or cooperatively indicated by existing information fields and newly added information fields in the SBP Request frame. An “information field” herein is at least one of a field, an element, or a container.

For example, the information related to the SBP type includes an SBP Type field.
Information related to measurement parameters, indicating at least one of operation parameters of an SBP process or measurement parameters of a sensing measurement process.

The information related to the measurement parameters may be explicitly indicated by adopting a mode of increasing values to existing information fields in the SBP Request frame; or explicitly indicated by adopting a method of newly added information fields in the SBP Request frame; or cooperatively indicated by existing information fields and newly added information fields in the SBP Request frame.

For example, the information related to the measurement parameters includes at least one of an SBP Parameters element, a Sensing Measurement Parameters element, or a Sensing Measurement Setup element.
Information related to sensing measurement results, indicating when the SBP initiator is capable of receiving a sensing report and/or participating in a sensing measurement instance.

The information related to the sensing measurement results may be explicitly indicated by adopting a mode of increasing values to existing information fields in the SBP Request frame; or explicitly indicated by adopting a method of newly added information fields in the SBP Request frame; or cooperatively indicated by existing information fields and newly added information fields in the SBP Request frame.

For example, the information related to the sensing measurement results includes an ISTA Availability Window element.

In some embodiments, the SBP Request frame carries at least one of the following elements or fields: an SBP Type field; an SBP Parameters element corresponding to the first frequency band; a Sensing Measurement Parameters element corresponding to the first frequency band; an SBP Parameters element corresponding to the second frequency band; a Sensing Measurement Setup element corresponding to the second frequency band; or an ISTA Availability Window element.

In some embodiments, the SBP type includes one of SBP in the first frequency band, SBP in the second frequency band, or SBP in the first frequency band and the second frequency band.

In some embodiments, the SBP Parameters element indicates the operation parameters of the SBP process.

In some embodiments, the Sensing Measurement Setup element and the Sensing Measurement Parameters element indicate the operation parameters of the sensing measurement process.

In some embodiments, the ISTA Availability Window element indicates when the SBP initiator is capable of receiving the sensing report and/or participating in a trigger frame-based sensing measurement instance.

In some embodiments, in a case where the SBP Request frame is used to request the SBP responder to perform sensing measurement of the first frequency band in a proxy mode, the SBP Request frame needs to indicate the first frequency band and carry relevant information of SBP in the first frequency band. The SBP Request frame carries at least one of the following elements or fields: the SBP Type field; the SBP Parameters element corresponding to the first frequency band; the Sensing Measurement Parameters element corresponding to the first frequency band; or the ISTA Availability Window element.

In some embodiments, in a case where the SBP Request frame is used to request the SBP responder to perform sensing measurement of the second frequency band in a proxy mode, the SBP Request frame needs to carry relevant information of SBP in the second frequency band. The SBP Request frame carries at least one of the following elements or fields: the SBP Type field; the SBP Parameters element corresponding to the second frequency band; or the Sensing Measurement Setup element corresponding to the second frequency band.

In some embodiments, in a case where the SBP Request frame is used to request the SBP responder to perform sensing measurement of the first frequency band and the second frequency band in a proxy mode, the SBP Request frame needs to indicate the first frequency band and the second frequency band, and carry relevant information of SBP in both the first frequency band and the second frequency band. The SBP Request frame carries at least one of the following elements or fields: the SBP Type field; the SBP Parameters element corresponding to the first frequency band; the Sensing Measurement Parameters element corresponding to the first frequency band; the ISTA Availability Window element; the SBP Parameters element corresponding to the second frequency band; or the Sensing Measurement Setup element corresponding to the second frequency band.

In some embodiments, in the case where the first frequency band is the Sub-7 frequency band, the SBP Request frame carries at least one of the following elements or fields: the SBP Type field; a Sub-7 Frequency Band SBP Parameters element; a Sub-7 Frequency Band Sensing Measurement Parameters element; the ISTA Availability Window element; a DMG Sensing Measurement Setup element; or a DMG SBP Parameters element.

In some embodiments, in a case where the first frequency band is the Sub-7 frequency band, and the SBP Request frame is used to request the SBP responder to perform sensing measurement of the second frequency band in a proxy mode, the SBP Request frame carries at least one of the following elements or fields: the SBP Type field; the DMG Sensing Measurement Setup element; or the DMG SBP Parameters element.

In some embodiments, in a case where the first frequency band is the Sub-7 frequency band, and the SBP Request frame is used to request the SBP responder to perform sensing measurement of the first frequency band and the second frequency band in a proxy mode, the SBP Request frame carries at least one of the following elements or fields: the SBP Type field; the DMG SBP Parameters element; the DMG Sensing Measurement Setup element; the Sub-7 Frequency Band SBP Parameters element; the Sub-7 Frequency Band Sensing Measurement Parameters element; or the ISTA Availability Window element.

In some embodiments, in the case where the first frequency band is the DMG frequency band, the SBP Request frame carries at least one of the following elements or fields: the SBP Type field; the DMG Sensing Measurement Setup element; the DMG SBP Parameters element; the ISTA Availability Window element; the Sub-7 Frequency Band SBP Parameters element; or the Sub-7 Frequency Band Sensing Measurement Parameters element.

In some embodiments, in a case where the first frequency band is the DMG frequency band, and the SBP Request frame is used to request the SBP responder to perform sensing measurement of the second frequency band in a proxy mode, the SBP Request frame carries at least one of the following elements or fields: the SBP Type field; the Sub-7 Frequency Band SBP Parameters element; the Sub-7 Frequency Band Sensing Measurement Parameters element; or the ISTA Availability Window element.

In some embodiments, in a case where the first frequency band is the DMG frequency band, and the SBP Request frame is used to request the SBP responder to perform sensing measurement of the first frequency band and the second frequency band in a proxy mode, the SBP Request frame carries at least one of the following elements or fields: the SBP Type field; the DMG Sensing Measurement Setup element; the DMG SBP Parameters element; the ISTA Availability Window element; the Sub-7 Frequency Band SBP Parameters element; or the Sub-7 Frequency Band Sensing Measurement Parameters element.

In some embodiments, the first frequency band is the Sub-7 frequency band, and the second frequency band is the DMG frequency band. The SBP initiator supporting the first frequency band is a Sub-7 device, wherein the Sub-7 device transmits an SBP Request frame to the SBP responder. The SBP Request frame is used to request the SBP responder to perform a Sub-7 frequency band SBP process (WLAN Sensing procedure) in a proxy mode, or the SBP Request frame is used to request the SBP responder to perform a DMG frequency band SBP process (DMG Sensing procedure) in a proxy mode, or the SBP Request frame is used to request the SBP responder to perform SBP in the Sub-7 frequency band and the DMG frequency band simultaneously.

In some embodiments, the first frequency band is the DMG frequency band, and the second frequency band is the Sub-7 frequency band. The SBP initiator supporting the first frequency band is a DMG device, wherein the DMG device transmits an SBP Request frame (DMG SBP Request frame) to the SBP responder. The SBP Request frame is used to request the SBP responder to perform sensing measurement of the DMG frequency band in a proxy mode, or the SBP Request frame is used to request the SBP responder to perform sensing measurement of the Sub-7 frequency band and the DMG frequency band simultaneously.

In some embodiments, the SBP type is indicated by a value of an SBP Type field.
A value of the SBP Type field includes a first value, wherein the first value indicates that the SBP Request frame is used to request the SBP responder to perform sensing measurement of the second frequency band in a proxy mode.
A value of the SBP Type field includes a second value, wherein the second value indicates that the SBP Request frame is used to request the SBP responder to perform sensing measurement of the first frequency band and the second frequency band in a proxy mode.
A value of the SBP Type field includes a third value, wherein the third value indicates that the SBP Request frame is used to request the SBP responder to perform sensing measurement of the first frequency band in a proxy mode.

In some embodiments, the first frequency band is the Sub-7 frequency band, and the second frequency band is the DMG frequency band. The SBP initiator supporting the first frequency band is the Sub-7 device, the first value is set to be 1, the second value is set to be 2, and the third value is set to be 0.

In some embodiments, with respect to the Sub-7 device, the SBP Type field taking the value of 1 indicates that the Sub-7 device requests to perform sensing measurement of the DMG frequency band. The SBP Type field taking the value of 2 indicates that the Sub-7 device requests to perform sensing measurement of the Sub-7 frequency band and the DMG frequency band simultaneously. The SBP Type field taking the value of 0 indicates that the Sub-7 device requests to perform sensing measurement of the Sub-7 frequency band.

In some embodiments, the first frequency band is the DMG frequency band, and the second frequency band is the Sub-7 frequency band. The SBP initiator supporting the first frequency band is the DMG device, the first value is set to be 0, the second value is set to be 2, and the third value is set to be 1.

In some embodiments, with respect to the DMG device, the SBP Type field taking the value of 0 indicates that the DMG device requests to perform sensing measurement of the Sub-7 frequency band. The SBP Type field taking the value of 2 indicates that the DMG device requests to perform sensing measurement of the Sub-7 frequency band and the DMG frequency band simultaneously. The SBP Type field taking the value of 1 indicates that the DMG device requests to perform sensing measurement of the DMG frequency band.

It should be noted that the specific values of the first value, the second value, and the third value are only used as an example, and may be adaptively modified or set to be other values based on actual technical requirements.

### 2. Design of a Frame Format of the SBP Response Frame:

In some embodiments, the SBP responder is a device that supports both the first frequency band and the second frequency band. Therefore, the SBP responder is capable of performing sensing measurement of the second frequency band in a proxy mode, or performing sensing measurement of the first frequency band and the second frequency band in a proxy mode.

In some embodiments, after the SBP responder negotiates sensing parameters with other devices, the SBP responder transmits the SBP Response frame to the SBP initiator. The SBP initiator receives the SBP Response frame from the SBP responder.

In some embodiments, corresponding to the SBP Request frame, the SBP Response frame indicates a frequency band corresponding to an SBP task accepted by the SBP responder, and carries relevant information of SBP in the corresponding frequency band.

In some embodiments, based on FIGS. 5 and 6, the SBP Response frame carries at least one of the following elements or fields.
Information related to an SBP type, indicating a frequency band of sensing measurement requested to be performed by the SBP responder in a proxy mode.

The information related to the SBP type may be explicitly indicated by adopting a mode of increasing values to existing information fields in the SBP Response frame; or explicitly indicated by adopting a method of newly added information fields in the SBP Response frame; or cooperatively indicated by existing information fields and newly added information fields in the SBP Response frame.

For example, the information on the SBP type includes an SBP Type field.
Information related to measurement parameters, indicating operation parameters of an SBP process and measurement parameters of a sensing measurement process.

The information related to the measurement parameters may be explicitly indicated by adopting a mode of increasing values to existing information fields in the SBP Response frame; or explicitly indicated by adopting a method of newly added information fields in the SBP Response frame; or cooperatively indicated by existing information fields and newly added information fields in the SBP Response frame.

For example, an element related to the measurement parameters includes at least one of an SBP Parameters element, a Sensing Measurement Parameters element, or a Sensing Measurement Setup element.
Information related to establishing a sensing measurement process, indicating that the SBP

responder establishes sensing measurement.

The information related to establishing the sensing measurement process may be explicitly indicated by adopting a mode of increasing values to existing information fields in the SBP Response frame; or explicitly indicated by adopting a method of newly added information fields in the SBP Response frame; or cooperatively indicated by existing information fields and newly added information fields in the SBP Response frame.

For example, an element or field related to establishing the sensing measurement process includes a Measurement Setup ID field.
Element or field related to sensing measurement results, indicating when the SBP responder is capable of transmitting a sensing report and/or participating in a sensing measurement instance.

The information related to the sensing measurement results may be explicitly indicated by adopting a mode of increasing values to existing information fields in the SBP Response frame; or explicitly indicated by adopting a method of newly added information fields in the SBP Response frame; or cooperatively indicated by existing information fields and newly added information fields in the SBP Response frame.

For example, the element or field related to the sensing measurement results includes an RSTA Availability Window element.
Information related to assisting in parsing sensing measurement results, used to assist the SBP initiator in parsing a sensing measurement report.

The information related to assisting in parsing the sensing measurement results may be explicitly indicated by adopting a mode of increasing values to existing information fields in the SBP Response frame; or explicitly indicated by adopting a method of newly added information fields in the SBP Response frame; or cooperatively indicated by existing information fields and newly added information fields in the SBP Response frame.

For example, an element related to assisting in parsing the sensing measurement results include at least one of a Sensing Image Range Axis Look-Up Table (LUT) element, or a Sensing Image Doppler Axis LUT element.

In some embodiments, the SBP Response frame carries at least one of the following elements or fields: an SBP Type field; an SBP Parameters element corresponding to the first frequency band; a Sensing Measurement Parameters element corresponding to the first frequency band; a Measurement Setup ID corresponding to the first frequency band; an RSTA Availability Window element; a Measurement Setup ID corresponding to the second frequency band; an SBP Parameters element corresponding to the second frequency band; a Sensing Measurement Setup element corresponding to the second frequency band; a Sensing Image Range Axis LUT element corresponding to the second frequency band; or a Sensing Image Doppler Axis LUT element corresponding to the second frequency band.

In some embodiments, the Measurement Setup ID identifies a sensing measurement process established by the SBP responder.

In some embodiments, the RSTA Availability Window element indicates when the SBP responder is capable of transmitting the sensing report and/or participating in the frame-based sensing measurement instance.

In some embodiments, the Sensing Image Range Axis LUT element and the Sensing Image Doppler Axis LUT element are used to assist the SBP initiator in parsing a sensing measurement report acquired after the SBP process is finished.

In some embodiments, in a case where the SBP Request frame is used to request the SBP responder to perform sensing measurement of the first frequency band in a proxy mode, the SBP Request frame needs to indicate the first frequency band and carry relevant information of SBP in the first frequency band. Accordingly, the SBP Response frame carries at least one of the following elements or fields: the Measurement Setup ID corresponding to the first frequency band; the SBP Parameters element corresponding to the first frequency band; the Sensing Measurement Parameters element corresponding to the first frequency band; or the RSTA Availability Window element.

In some embodiments, in a case where the SBP Request frame is used to request the SBP responder to perform sensing measurement of the second frequency band in a proxy mode, the SBP Request frame needs to indicate the second frequency band and carry relevant information of SBP in the second frequency band. Accordingly, the SBP Response frame carries at least one of the following elements or fields: the SBP Type field; the Measurement Setup ID corresponding to the second frequency band; the SBP Parameters element corresponding to the second frequency band; the Sensing Measurement Setup element corresponding to the second frequency band; the Sensing Image Range Axis LUT element corresponding to the second frequency band; or the Sensing Image Doppler Axis LUT element corresponding to the second frequency band.

In some embodiments, in a case where the SBP Request frame is used to request the SBP responder to perform sensing measurement of the first frequency band and the second frequency band in a proxy mode, the SBP Request frame needs to indicate the first frequency band and the second frequency band, and carry relevant information of SBP in both the first frequency band and the second frequency band. Accordingly, the SBP Response frame carries at least one of the following elements or fields: the SBP Type field; the Measurement Setup ID corresponding to the first frequency band; the SBP Parameters element corresponding to the first frequency band; the Sensing Measurement Parameters element corresponding to the first frequency band; the RSTA Availability Window element; the Measurement Setup ID corresponding to the second frequency band; the SBP Parameters element corresponding to the second frequency band; the Sensing Measurement Setup element corresponding to the second frequency band; the Sensing Image Range Axis LUT element corresponding to the second frequency band; or the Sensing Image Doppler Axis LUT element corresponding to the second frequency band.

In some embodiments, in the case where the first frequency band is the Sub-7 frequency band, the SBP Response frame carries at least one of the following elements or fields: the SBP Type field; a Sub-7 Frequency Band Measurement Setup ID; a Sub-7 Frequency Band SBP Parameters element; a Sub-7 Frequency Band Sensing Measurement Parameters element; the RSTA Availability Window element; a DMG Measurement Setup ID; a DMG Sensing Measurement Setup element; a DMG SBP Parameters element; a DMG Sensing Image Range Axis LUT element; or a DMG Sensing Image Doppler Axis LUT element.

In some embodiments, in a case where the first frequency band is the Sub-7 frequency band, and the SBP Request frame is used to request the SBP responder to perform sensing measurement of the second frequency band in a proxy mode, the SBP Response frame carries at least one of the following elements or fields: the SBP Type field; the DMG Measurement Setup ID; the DMG Sensing Measurement Setup element; the DMG SBP Parameters element; the DMG Sensing Image Range Axis LUT element; or the DMG Sensing Image Doppler Axis LUT element.

In some embodiments, in a case where the first frequency band is the Sub-7 frequency band, and the SBP Request frame is used to request the SBP responder to perform sensing measurement of the first frequency band and the second frequency band in a proxy mode, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; the RSTA Availability Window element; the DMG Measurement Setup ID; the DMG Sensing Measurement Setup element; the DMG SBP Parameters element; the DMG Sensing Image Range Axis LUT element; or the DMG Sensing Image Doppler Axis LUT element.

In some embodiments, in the case where the first frequency band is the DMG frequency band, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; the RSTA Availability Window element; the DMG Measurement Setup ID; the DMG Sensing Measurement Setup element; the DMG SBP Parameters element; the DMG Sensing Image Range Axis LUT element; or the DMG Sensing Image Doppler Axis LUT element.

In some embodiments, in a case where the first frequency band is the DMG frequency band, and the SBP Request frame is used to request the SBP responder to perform sensing measurement of the second frequency band in a proxy mode, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; or the RSTA Availability Window element.

In some embodiments, in a case where the first frequency band is the DMG frequency band, and the SBP Request frame is used to request the SBP responder to perform sensing measurement of the first frequency band and the second frequency band in a proxy mode, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; the RSTA Availability Window element; the DMG Measurement Setup ID; the DMG Sensing Measurement Setup element; the DMG SBP Parameters element; the DMG Sensing Image Range Axis LUT element; or the DMG Sensing Image Doppler Axis LUT element.

It should be noted that each frame and the frame format thereof in the above embodiments may be designed or adjusted based on actual technical requirements, and the above embodiments may also be arbitrarily combined, which is not limited in the embodiments of the present disclosure.

In summary, the embodiments of the present disclosure can realize, based on the SBP responder that supports both the first frequency band and the second frequency band, that the SBP initiator supporting the first frequency band requests the SBP responder to perform sensing measurement of the second frequency band in a proxy mode, or requests the SBP responder to perform sensing measurement of the first frequency band and the second frequency band in a proxy mode. By adopting the methods according to the embodiments of the present disclosure, a low-frequency band device is capable of requesting a high-frequency band device to perform SBP, a low-frequency band device is capable of simultaneously requesting devices of different frequency bands to perform SBP, a high-frequency band device is capable of requesting a low-frequency band device to perform SBP, and a high-frequency band device is capable of simultaneously requesting devices of different frequency bands to perform SBP, such that the cross-frequency band SBP is implemented, and the application scope of SBP is extended.

In some embodiments, upon completing sensing measurement that meets SBP requirements of the SBP initiator, the SBP responder transmits an SBP Report frame to the SBP initiator. The SBP initiator receives the SBP Report frame from the SBP responder.

In some embodiments, upon receiving the SBP Report frame from the SBP responder, the SBP initiator transmits an SBP Termination frame to the SBP responder, and the SBP responder receives the SBP Termination frame from the SBP initiator. Therefore, the SBP responder terminates the designated SBP process.

In some embodiments, terminating the designated SBP process includes at least one of terminating sensing measurement of the first frequency band, terminating sensing measurement of the second frequency band, or terminating sensing measurement of the first frequency band and the second frequency band.

Hereinafter, descriptions are further given of the sensing flows on the SBP initiator and the SBP responder in the embodiments of the present disclosure.

### SBP Initiator:

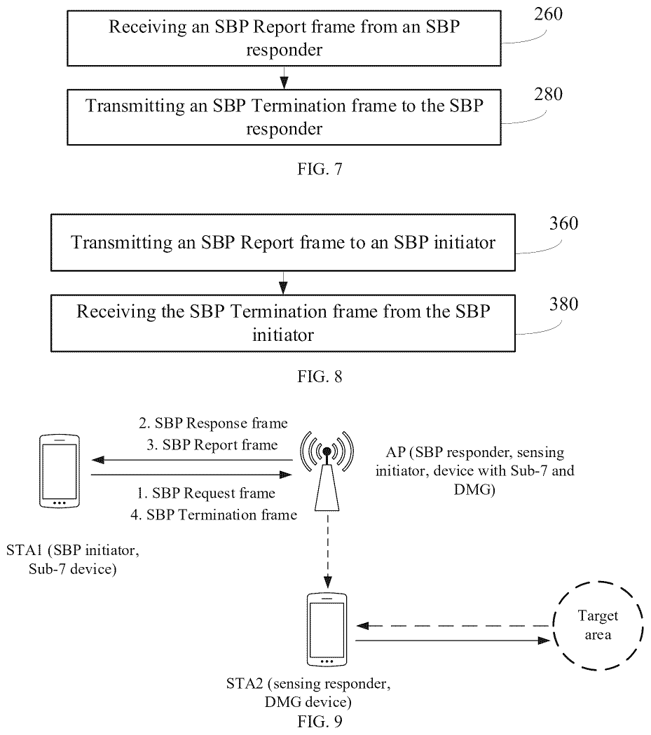

FIG. 7 is a flowchart of a method for SBP according to some embodiments of the present disclosure. The method which is applicable to the SBP initiator supporting the first frequency band is described as an example, and the SBP initiator may be the STA or the AP illustrated in FIG. 4. Based on process 220 and process 240 described above, the method further includes at least part of the following processes.

In process 260, the SBP initiator receives an SBP Report frame from the SBP responder.

In process 280, the SBP initiator transmits an SBP Termination frame to the SBP responder. SBP responder:

FIG. 8 is a flowchart of a method for SBP according to some embodiments of the present disclosure. The method which is applicable to an SBP responder supporting both a first frequency band and a second frequency band is described as an example, and the SBP responder may be the AP or the STA illustrated in FIG. 4. Based on process 320 and process 340 described above, the method further includes at least part of the following processes.

In process 360, the SBP responder transmits an SBP Report frame to the SBP initiator.

In process 380, the SBP responder receives an SBP Termination frame from the SBP initiator.

### 3. Design of a Frame Format of the SBP Report Frame:

In some embodiments, the SBP Report frame carries a sensing measurement result of the SBP process requested by the SBP initiator. Corresponding to the SBP Request frame, the SBP Report frame carries a sensing measurement result of a frequency band corresponding to an SBP task indicated by the SBP initiator.

In some embodiments, based on FIGS. 7 and 8, the SBP Report frame carries at least one of the following elements or fields.
Information related to an SBP type, indicating a frequency band of sensing measurement requested to be performed by the SBP responder in a proxy mode.

The information related to the SBP type may be explicitly indicated by adopting a mode of increasing values to existing information fields in the SBP Report frame; or explicitly indicated by adopting a method of newly added information fields in the SBP Report frame; or cooperatively indicated by existing information fields and newly added information fields in the SBP Report frame.

For example, a field related to the SBP type includes an SBP Type field.
Information related to sensing measurement results, indicating the sensing measurement results of the frequency band of sensing measurement.

The information related to the sensing measurement results may be explicitly indicated by adopting a mode of increasing values to existing information fields in the SBP Report frame; or explicitly indicated by adopting a method of newly added information fields in the SBP Report frame; or cooperatively indicated by existing information fields and newly added information fields in the SBP Report frame.

For example, the information related to the sensing measurement results includes at least one of a Sensing Measurement Report Container, a Sensing Report Control element, or a Sensing Report element.

In some embodiments, the SBP Report frame carries at least one of the following elements or fields: the SBP Type field; a Sensing Measurement Report Container corresponding to the first frequency band; a Sensing Report Control element corresponding to the second frequency band; or a Sensing Report element corresponding to the second frequency band.

In some embodiments, in a case where the SBP Request frame is used to request the SBP responder to perform sensing measurement of the second frequency band in a proxy mode, the SBP Report frame carries at least one of the following elements or fields: the SBP Type field; the Sensing Report Control element corresponding to the second frequency band; or the Sensing Report element corresponding to the second frequency band.

In some embodiments, in a case where the SBP Request frame is used to request the SBP responder to perform sensing measurement of the first frequency band and the second frequency band in a proxy mode, the SBP Report frame carries at least one of the following elements or fields: the SBP Type field; the Sensing Measurement Report Container corresponding to the first frequency band; the Sensing Report Control element corresponding to the second frequency band; or the Sensing Report element corresponding to the second frequency band.

In the case where the first frequency band is the Sub-7 frequency band, the SBP Report frame carries at least one of the following elements or fields: the SBP Type field; a Sensing Measurement Report Container corresponding to the Sub-7 frequency band; a DMG Sensing Report Control element; or a DMG Sensing Report element.

In some embodiments, in a case where the first frequency band is the Sub-7 frequency band, and the SBP Request frame is used to request the SBP responder to perform sensing measurement of the second frequency band in a proxy mode, the SBP Report frame carries at least one of the following elements or fields: the SBP Type field; the DMG Sensing Report Control element; or the DMG Sensing Report element.

In some embodiments, in a case where the first frequency band is the Sub-7 frequency band, and the SBP Request frame is used to request the SBP responder to perform sensing measurement of the first frequency band and the second frequency band in a proxy mode, the SBP Report frame carries at least one of the following elements or fields: the SBP Type field; the Sensing Measurement Report Container corresponding to the Sub-7 frequency band; the DMG Sensing Report Control element; or the DMG Sensing Report element.

In some embodiments, in the case where the first frequency band is the DMG frequency band, the SBP Report frame carries at least one of the following elements or fields: the SBP Type field; a Sensing Measurement Report Container corresponding to the Sub-7 frequency band; a DMG Sensing Report Control element; or a DMG Sensing Report element.

In some embodiments, in a case where the first frequency band is the DMG frequency band, and the SBP Request frame is used to request the SBP responder to perform sensing measurement of the second frequency band in a proxy mode, the SBP Report frame carries at least one of the following elements or fields: the SBP Type field; or the Sensing Measurement Report Container corresponding to the Sub-7 frequency band.

In some embodiments, in a case where the first frequency band is the DMG frequency band, and the SBP Request frame is used to request the SBP responder to perform sensing measurement of the first frequency band and the second frequency band in a proxy mode, the SBP Report frame carries at least one of the following elements or fields: the SBP Type field; the Sensing Measurement Report Container corresponding to the Sub-7 frequency band; the DMG Sensing Report Control element; or the DMG Sensing Report element.

### 4. Design of a Frame Format of the SBP Termination Frame:

In some embodiments, the SBP Termination frame carries relevant information of the SBP initiator requesting to terminate the SBP process. The information carried by the SBP Termination frame corresponds to the frequency band.

In some embodiments, based on FIGS. 7 and 8, the SBP Termination frame carries at least one of the following elements or fields.
Information related to an SBP type, indicating a frequency band of sensing measurement requested to be terminated that is performed by the SBP responder in a proxy mode.

The information related to the SBP type may be explicitly indicated by adopting a mode of increasing values to existing information fields in the SBP Termination frame; or explicitly indicated by adopting a method of newly added information fields in the SBP Termination frame; or cooperatively indicated by existing information fields and newly added information fields in the SBP Termination frame.

For example, an element or field related to the SBP type includes an SBP Type field.
Information related to terminating a sensing measurement process, indicating that the SBP responder terminates sensing measurement.

The information related to terminating the sensing measurement process may be explicitly indicated by adopting a mode of increasing values to existing information fields in the SBP Termination frame; or explicitly indicated by adopting a method of newly added information fields in the SBP Termination frame; or cooperatively indicated by existing information fields and newly added information fields in the SBP Termination frame.

For example, an element or field related to terminating the sensing measurement process includes at least one of the Measurement Setup ID, an SBP Termination Control field, or the SBP Parameters element.

In some embodiments, the SBP Termination frame carries at least one of the following elements or fields: the SBP Type field; the Measurement Setup ID corresponding to the first frequency band; the Measurement Setup ID corresponding to the second frequency band; an SBP Termination Control corresponding to the second frequency band; or the SBP Parameters element corresponding to the second frequency band.

In the case where the SBP Termination frame is used to request the SBP responder to terminate the sensing measurement of the second frequency band in a proxy mode, the SBP Termination frame carries relevant information of the second frequency band. The SBP Termination frame carries at least one of the following elements or fields: the SBP Type field; the Measurement Setup ID corresponding to the second frequency band; the SBP Termination Control corresponding to the second frequency band; or the SBP Parameters element corresponding to the second frequency band.

In some embodiments, in the case where the SBP Termination frame is used to request the SBP responder to terminate the sensing measurement of the first frequency band and the second frequency band in a proxy mode, the SBP Termination frame carries relevant information of the first frequency band and the second frequency band. The SBP Termination frame carries at least one of the following elements or fields: the SBP Type field; the Measurement Setup ID corresponding to the first frequency band; the Measurement Setup ID corresponding to the second frequency band; the SBP Termination Control corresponding to the second frequency band; or the SBP Parameters element corresponding to the second frequency band.

In some embodiments, in the case where the first frequency band is the Sub-7 frequency band, the SBP Termination frame carries at least one of the following elements or fields: the SBP Type field; the Sub-7 Frequency Band Measurement Setup ID; the DMG Measurement Setup ID; a DMG SBP Termination Control; or the DMG SBP Parameters element.

In some embodiments, in a case where the first frequency band is the Sub-7 frequency band, and the SBP Termination frame is used to request the SBP responder to terminate the sensing measurement of the second frequency band in a proxy mode, the SBP Termination frame carries at least one of the following elements or fields: the SBP Type field; the DMG Measurement Setup ID; the DMG SBP Termination Control; or the DMG SBP Parameters element.

In some embodiments, in a case where the first frequency band is the Sub-7 frequency band, and the SBP Termination frame is used to request the SBP responder to terminate the sensing measurement of the first frequency band and the second frequency band in a proxy mode, the SBP Termination frame carries at least one of the following elements or fields: the SBP Type field; the Sub-7 Frequency Band Measurement Setup ID; the DMG Measurement Setup ID; the DMG SBP Termination Control; or the DMG SBP Parameters element.

In some embodiments, in the case where the first frequency band is the DMG frequency band, the SBP Termination frame carries at least one of the following elements or fields: the SBP Type field; the Sub-7 Frequency Band Measurement Setup ID; the DMG Measurement Setup ID; a DMG SBP Termination Control; or the DMG SBP Parameters element.

In some embodiments, in a case where the first frequency band is the DMG frequency band, and the SBP Termination frame is used to request the SBP responder to terminate the sensing measurement of the second frequency band in a proxy mode, the SBP Termination frame carries at least one of the following elements or fields: the SBP Type field; or the Sub-7 Frequency Band Measurement Setup ID.

In some embodiments, in a case where the first frequency band is the DMG frequency band, and the SBP Termination frame is used to request the SBP responder to terminate the sensing measurement of the first frequency band and the second frequency band in a proxy mode, the SBP Termination frame carries at least one of the following elements or fields: the SBP Type field; the Sub-7 Frequency Band Measurement Setup ID; the DMG Measurement Setup ID; the DMG SBP Termination Control; or the DMG SBP Parameters element.

It should be noted that each frame and the frame format thereof in the above embodiments may be designed or adjusted based on actual technical requirements, and the above embodiments may also be arbitrarily combined, which is not limited in the embodiments of the present disclosure.

In the above embodiments, based on the frame formats of the SBP Request frame and the SBP Response frame, the corresponding frame formats of the SBP Report frame and the SBP Termination frame are set, such that a low-frequency band device is capable of requesting SBP in a high-frequency band, a low-frequency band device is capable of simultaneously requesting SBP in different frequency bands, a high-frequency band device is capable of requesting SBP in a low-frequency band, a high-frequency band device is capable of simultaneously requesting SBP in different frequency bands, the corresponding sensing reports can be acquired, and the corresponding SBP process is terminated, thereby implementing the cross-frequency band SBP and extending the application scope of SBP.

As an example, several sensing processes involved in the embodiments of the present disclosure are described in detail hereinafter.

### 1. Low-Frequency Band Device

### 1.1 A Low-Frequency Band Device Requests to Perform SBP in a High-Frequency Band.

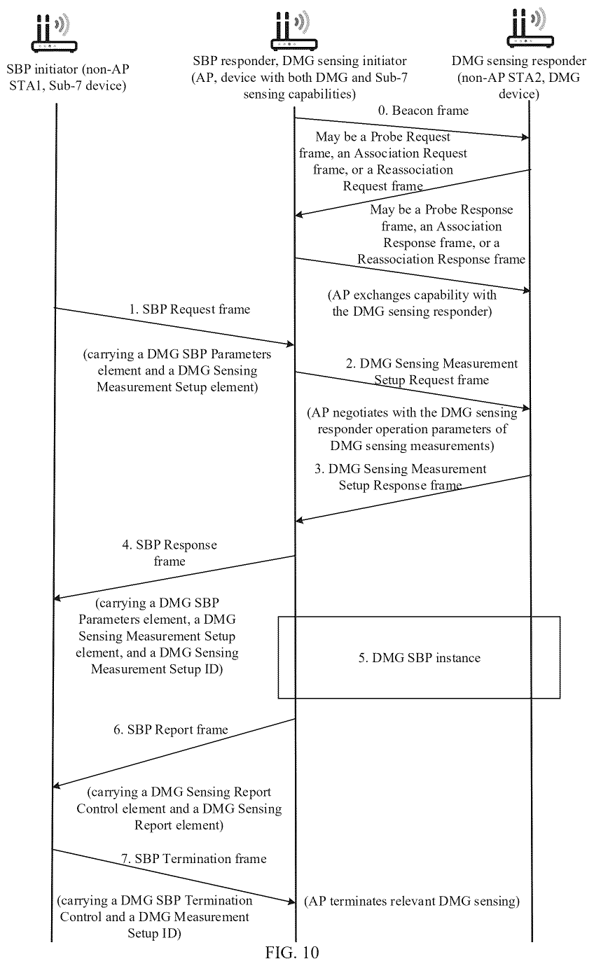

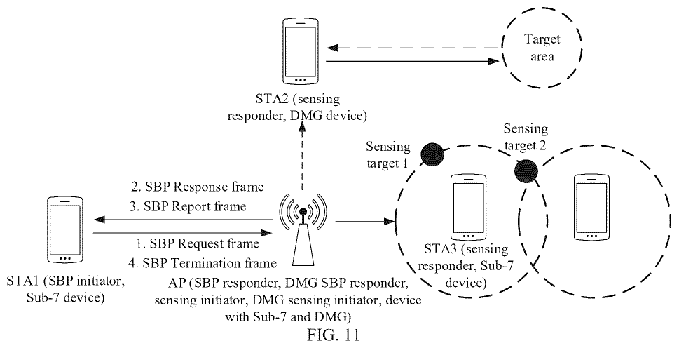

FIG. 9 is a diagram of a scenario in which a low-frequency band device requests to perform SBP in a high-frequency band according to some embodiments of the present disclosure. FIG. 10 is a flowchart in which a low-frequency band device requests to perform SBP in a high-frequency band according to some embodiments of the present disclosure.

FIGS. 9 and 10 relate to an SBP initiator (STA1, a Sub-7 device), an SBP responder (AP, a device with both DMG and Sub-7 sensing capabilities), a DMG sensing initiator (AP), and a DMG sensing responder (STA2, a DMG device). The SBP responder is used to respond to an SBP request of the SBP initiator, and meanwhile acts as the DMG sensing initiator for initiating sensing.

Please refer to FIGS. 9 and 10. The process in which the low-frequency band device requests to perform SBP in the high-frequency band is briefly described hereinafter.

In process 0, the DMG sensing initiator broadcasts a Beacon frame, and the sensing responder actively transmits a Probe Request frame, an Association Request frame, or a Reassociation Request frame to the DMG sensing initiator and receives the Probe Request frame, the Association Request frame, or the Reassociation Request frame returned by the DMG sensing initiator for exchanging sensing capability information of the DMG sensing initiator and the DMG sensing responder.

In process 1, the SBP initiator (STA1, the Sub-7 device) initiates a DMG SBP process by transmitting an SBP Request frame to the SBP responder (AP).

In some embodiments, the SBP Request frame carries at least one of a DMG SBP Parameters element, or a DMG Sensing Measurement Setup element.

In process 2, the SBP responder (AP) negotiates with the DMG sensing responder (STA2, the DMG device) operation parameters in the DMG sensing measurement process by transmitting a DMG Sensing Measurement Setup Request frame to the DMG sensing responder.

In process 3, the DMG sensing responder (STA2, the DMG device) indicates confirmation of establishing the DMG sensing measurement by transmitting a DMG Sensing Measurement Setup Response frame to the SBP responder (AP).

In process 4, the SBP responder (AP) indicates acceptance of the SBP task by transmitting an SBP Response frame to the SBP initiator (STA1, the Sub-7 device).

In some embodiments, the SBP Response frame carries at least one of the DMG SBP Parameters element, the DMG Sensing Measurement Setup element, or a DMG Measurement Setup ID.

In process 5, the SBP responder (AP) and the DMG sensing responder (STA2, the DMG device) complete the DMG sensing measurement process based on the setting in the SBP Request frame.

In process 6, the SBP responder (AP) notifies the DMG sensing measurement result by transmitting an SBP Report frame to the SBP initiator (STA1, the Sub-7 device).

In some embodiments, the SBP Report frame carries at least one of a DMG Sensing Report Control element, or a DMG Sensing Report element.

In process 7, the SBP initiator (STA1, the Sub-7 device) indicates termination of the relevant DMG sensing by transmitting an SBP Termination frame to the SBP responder (AP).

In some embodiments, the SBP Termination frame carries at least one of a DMG Measurement Setup ID, or a DMG SBP Termination Control field.

### 1.2 A Low-Frequency Band Device Simultaneously Requests to Perform SBP in a Low-Frequency Band and a High-Frequency Band.

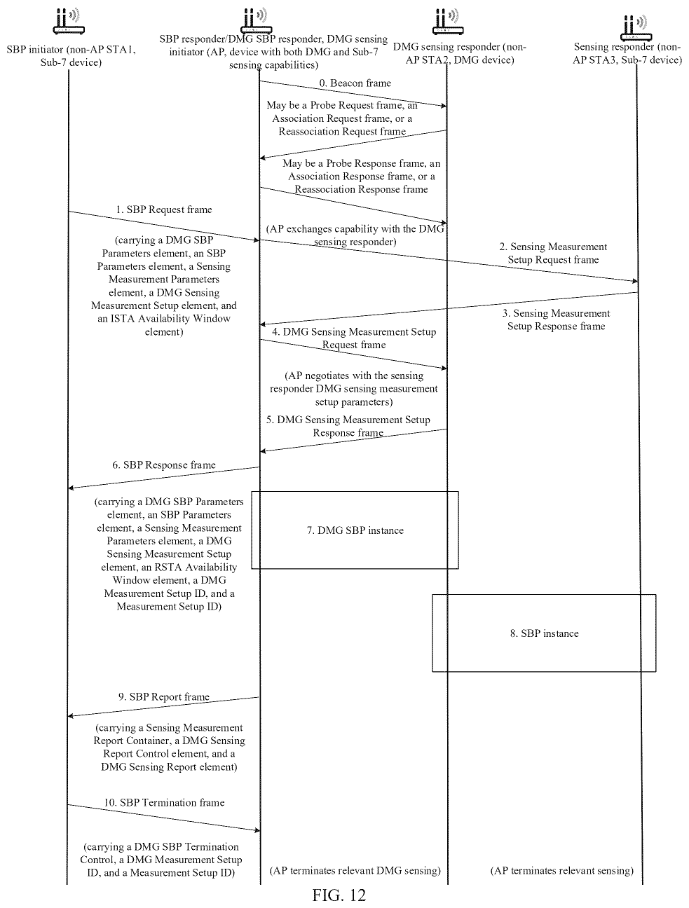

FIG. 11 is a diagram of a scenario in which a low-frequency band device simultaneously requests to perform SBP in a low-frequency band and a high-frequency band according to some embodiments of the present disclosure. FIG. 12 is a flowchart in which a low-frequency band device simultaneously requests to perform SBP in a low-frequency band and a high-frequency band according to some embodiments of the present disclosure.

FIGS. 11 and 12 relate to an SBP initiator (STA1, a Sub-7 device), an SBP responder (AP, a device with both DMG and Sub-7 sensing capabilities), a DMG SBP responder (AP), a DMG sensing initiator (AP), a DMG sensing responder (STA2, a DMG device), and a sensing responder (STA3, a Sub-7 device). The SBP responder is used to respond to an SBP request of the SBP initiator, and meanwhile acts as the DMG sensing initiator for initiating sensing, and also acts as the DMG SBP responder to respond to a request of the DMG sensing responder.

Please refer to FIGS. 11 and 12. The process in which the low-frequency band device simultaneously requests to perform SBP in the low-frequency band and the high-frequency band is briefly described hereinafter.

In process 0, the DMG sensing initiator (AP) broadcasts a Beacon frame, and the DMG sensing responder (STA2, the DMG device) and the sensing responder (STA3, the Sub-7 device) actively transmit a Probe Request frame, an Association Request frame, or a Reassociation Request frame to the DMG sensing initiator (AP) and receives the Probe Request frame, the Association Request frame, or the Reassociation Request frame returned by the DMG sensing initiator (AP) for exchanging sensing capability information of the DMG sensing initiator (AP), the DMG sensing responder (STA2, the DMG device) and the sensing responder (STA3, the Sub-7 device).

In process 1, the SBP initiator (STA1, the Sub-7 device) initiates a Sub-7 SBP process and a DMG SBP process by transmitting an SBP Request frame to the SBP responder (AP).

In some embodiments, the SBP Request frame carries at least one of a DMG SBP Parameters element, an SBP Parameters element, a Sensing Measurement Parameters element, a DMG Sensing Measurement Setup element, or an ISTA Availability Window element.

In process 2, the SBP responder (AP) negotiates with the sensing responder (STA3, the Sub-7 device) operation parameters in a sensing measurement process by transmitting a Sensing Measurement Setup Request frame to the sensing responder (STA3, the Sub-7 device).

In process 3, the sensing responder (STA3, the Sub-7 device) indicates confirmation of establishing the sensing measurement by transmitting a Sensing Measurement Setup Response frame to the SBP responder (AP).

In process 4, the SBP responder (AP) negotiates with the DMG sensing responder (STA2, the DMG device) operation parameters in a DMG sensing measurement process by transmitting a DMG Sensing Measurement Setup Request frame to the DMG sensing responder (STA2, the DMG device).

In process 5, the DMG sensing responder (STA2, the DMG device) indicates confirmation of establishing the DMG sensing measurement by transmitting a DMG Sensing Measurement Setup Response frame to the SBP responder (AP).

### Processes 2 and 3, and Processes 3 and 4 may be Performed Sequentially or Synchronously.

In process 6, the SBP responder (AP) indicates acceptance of the SBP task by transmitting an SBP Response frame to the SBP initiator (STA1, the Sub-7 device).

In some embodiments, the SBP Response frame carries at least one of the DMG SBP Parameters element, the SBP Parameters element, the Sensing Measurement Parameters element, the DMG Sensing Measurement Setup element, an RSTA Availability Window element, a DMG Measurement Setup ID, or a Measurement Setup ID.

In process 7, the SBP responder (AP) and the DMG sensing responder (STA2, the DMG device) complete the DMG sensing measurement process based on the setting in the SBP Request frame. The DMG sensing responder (STA2, the DMG device) feeds back a DMG sensing measurement result to the SBP responder (AP).

In process 8, the DMG SBP responder (STA2, the DMG device) and the sensing responder (STA3, the Sub-7 device) complete the Sub-7 frequency band sensing measurement process based on the setting in the SBP Request frame. The sensing responder (STA3, the Sub-7 device) feeds back a sensing measurement result to the SBP responder (AP).

In process 9, the SBP responder (AP) notifies the DMG sensing measurement result and the Sub-7 frequency band sensing measurement result by transmitting an SBP Report frame to the SBP initiator (STA1, the Sub-7 device).

In some embodiments, the SBP Report frame carries at least one of a Sensing Measurement

Report Container, a DMG Sensing Report Control element, or a DMG Sensing Report element.

In process 10, the SBP initiator (STA1, the Sub-7 device) indicates termination of the related DMG sensing and Sub-7 frequency band sensing by transmitting an SBP Termination frame to the SBP responder (AP).

In some embodiments, the SBP Termination frame carries at least one of the Measurement Setup ID, the DMG Measurement Setup ID, or a DMG SBP Termination Control field.

### 1.3 Frame Format of a Low-Frequency Band Device

### 1.3.1 SBP Request Frame

### 1.3.1.1 An SBP Type Requested by the Low-Frequency Band Device is Indicated by an SBP Type Field.

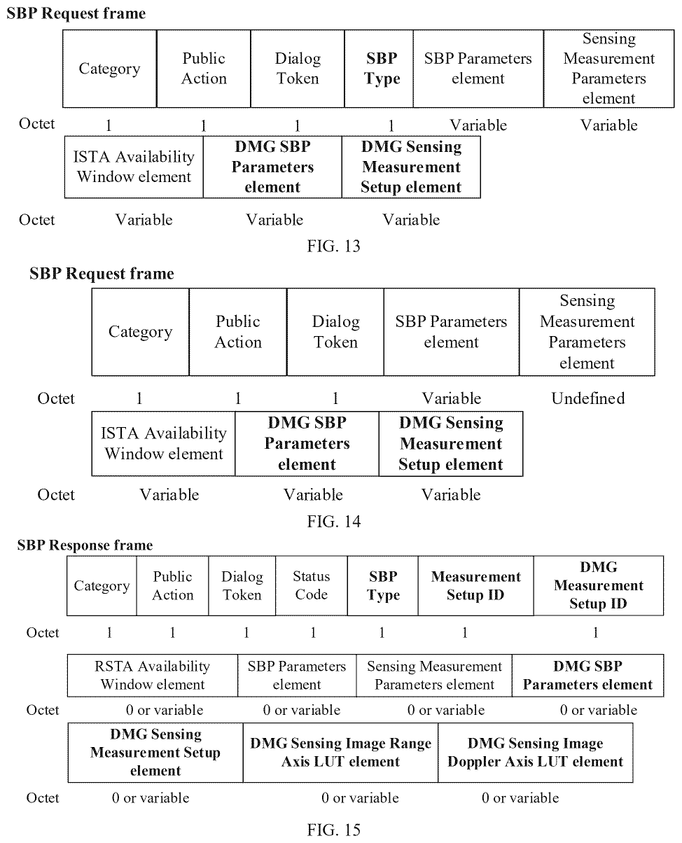

In some embodiments, the frame structure of the SBP Request frame is as illustrated in FIG. 13, and includes: a Category field, a Public Action field, a Dialog Token field, an SBP Type field, an SBP Parameters element, a Sensing Measurement Parameters element, an ISTA Availability Window element, a DMG SBP Parameters element, and a DMG Sensing Measurement Setup element which are sequentially arranged.

The Category field occupies 1 octet, the Public Action field occupies 1 octet, the Dialog Token field occupies 1 octet, the SBP Type field occupies 1 octet, the SBP Parameters element has a variable number of octets, the Sensing Measurement Parameters element has a variable number of octets, the ISTA Availability Window element has a variable number of octets, the DMG SBP Parameters element has a variable number of octets, and the DMG Sensing Measurement Setup element has a variable number of octets.

In some embodiments, the SBP type requested by the low-frequency band device is indicated by a value of the SBP Type field in the SBP Request frame.

The SBP Type field taking a first value indicates that the Sub-7 device requests to perform Sub-7 SBP. The SBP Type field taking a second value indicates that the Sub-7 device requests to perform DMG SBP. The SBP Type field taking a third value indicates that the Sub-7 device simultaneously requests to perform Sub-7 SBP and DMG SBP.

For example, the first value is set to be 0, the second value is set to be 1, and the third value is set to be 2.

In the case where the SBP Type field takes the first value, the SBP Parameters element, the Sensing Measurement Parameters element, and the ISTA Availability Window element in the SBP Request frame are present, and the DMG SBP Parameters element and the DMG Sensing Measurement Setup element are not present.

In the case where the SBP Type field takes the second value, the DMG SBP Parameters element and the DMG Sensing Measurement Setup element in the SBP Request frame are present, and the SBP Parameters element, the Sensing Measurement Parameters element, and the ISTA Availability Window element are not present.

In the case where the SBP Type field takes the third value, the DMG SBP Parameters element, the DMG Sensing Measurement Setup element, the SBP Parameters element, the Sensing Measurement Parameters element, and the ISTA Availability Window element in the SBP Request frame are present.

1.3.1.2 An SBP Type Requested by the Low-Frequency Band Device is Indicated by an element.

In some embodiments, the frame structure of the SBP Request frame is as illustrated in FIG. 14, and includes at least one of: the Category field, the Public Action field, the Dialog Token field, the SBP Parameters element, the Sensing Measurement Parameters element, the ISTA Availability Window element, the DMG SBP Parameters element, or the DMG Sensing Measurement Setup element which are sequentially arranged.

The Category field occupies 1 octet, the Public Action field occupies 1 octet, the Dialog Token field occupies 1 octet, the SBP Parameters element has a variable number of octets, the number of octets occupied by the Sensing Measurement Parameters element is not defined, the ISTA Availability Window element has a variable number of octets, the DMG SBP Parameters element has a variable number of octets, and the DMG Sensing Measurement Setup element has a variable number of octets.

In some embodiments, the SBP type requested by the low-frequency band device is indicated by whether the element in the SBP Request frame being present.

In the case where the SBP Parameters element, the Sensing Measurement Parameters element, and the ISTA Availability Window element in the SBP Request frame are present, and the DMG SBP Parameters element and the DMG Sensing Measurement Setup element are not present, this case indicates that the Sub-7 device requests to perform Sub-7 SBP.

In the case where the DMG SBP Parameters element and the DMG Sensing Measurement Setup element in the SBP Request frame are present, and the SBP Parameters element, the Sensing Measurement Parameters element, and the ISTA Availability Window element are not present, this case indicates that the Sub-7 device requests to perform DMG SBP.

In the case where the DMG SBP Parameters element, the DMG Sensing Measurement Setup element, the SBP Parameters element, the Sensing Measurement Parameters element, and the ISTA Availability Window element in the SBP Request frame are present, this case indicates that the Sub-7 device simultaneously requests to perform DMG SBP and Sub-7 SBP.

### 1.3.2 SBP Response Frame

In some embodiments, the frame structure of the SBP Response frame is as illustrated in FIG. 15, and includes: a Category field, a Public Action field, a Dialog Token field, a Status Code field, an SBP Type field, a Measurement Setup ID field, a DMG Measurement Setup ID field, an RSTA Availability Window element, an SBP Parameters element, a Sensing Measurement Parameters element, a DMG SBP Parameters element, a DMG Sensing Measurement Setup element, a DMG Sensing Image Range Axis LUT element, and a DMG Sensing Image Doppler Axis LUT element which are sequentially arranged.

The Category field occupies 1 octet, the Public Action field occupies 1 octet, the Dialog Token field occupies 1 octet, the Status Code field occupies 1 octet, the SBP Type field occupies 1 octet, the Measurement Setup ID occupies 1 octet, the DMG Measurement Setup ID field occupies 1 octet, the RSTA Availability Window element occupies 0 octet or has a variable number of octets, the SBP Parameters element occupies 0 octet or has a variable number of octets, the Sensing Measurement Parameters element occupies 0 octet or has a variable number of octets, the DMG SBP Parameters element occupies 0 octet or has a variable number of octets, the DMG Sensing Measurement Setup element occupies 0 octet or has a variable number of octets, the DMG Sensing Image Range Axis LUT element occupies 0 octet or has a variable number of octets, and the DMG Sensing Image Doppler Axis LUT element occupies 0 octet or has a variable number of octets.

In some embodiments, the SBP type requested by the low-frequency band device is indicated by a value of the SBP Type field.

The SBP Type field taking a first value indicates that the Sub-7 device requests to perform Sub-7 SBP. The SBP Type field taking a second value indicates that the Sub-7 device requests to perform DMG SBP. The SBP Type field taking a third value indicates that the Sub-7 device simultaneously requests to perform Sub-7 SBP and DMG SBP.

For example, the first value is set to be 0, the second value is set to be 1, and the third value is set to be 2.

In a case where the SBP Request frame is used to request to perform Sub-7 SBP, the Measurement Setup ID field, the SBP Parameters element, the Sensing Measurement Parameters element, and the RSTA Availability Window element in the SBP Response frame are present; and the DMG Measurement Setup ID field, the DMG SBP Parameters element, the DMG Sensing Measurement Setup element, the DMG Sensing Image Range Axis LUT element, and the DMG Sensing Image Doppler Axis LUT element are not present.

In a case where the SBP Request frame is used to request to perform DMG SBP, the DMG Measurement Setup ID field, the DMG SBP Parameters element, and the DMG Sensing Measurement Setup element in the SBP Response frame are present; the DMG Sensing Image Range Axis LUT element and the DMG Sensing Image Doppler Axis LUT element are present or not present; and the Measurement Setup ID field, the SBP Parameters element, the Sensing Measurement Parameters element, and the RSTA Availability Window element are not present.

In a case where the SBP Request frame is used to simultaneously request to perform DMG SBP and Sub-7 SBP, the Measurement Setup ID field, the DMG Measurement Setup ID field, the SBP Parameters element, the Sensing Measurement Parameters element, the RSTA Availability Window element, the DMG SBP Parameters element, and the DMG Sensing Measurement Setup element in the SBP Response frame are present; and the DMG Sensing Image Range Axis LUT element, and the DMG Sensing Image Doppler Axis LUT element are present or not present.

The Measurement Setup ID field corresponds to relevant setting of sensing measurement of Sub-7 SBP, and the relevant setting of sensing measurement of Sub-7 SBP includes at least one of the SBP Parameters element, the Sensing Measurement Parameters element, or the RSTA Availability Window element. The DMG Measurement Setup ID field corresponds to relevant setting of DMG sensing measurement of DMG SBP, and the relevant setting of DMG sensing measurement of DMG SBP includes at least one of the DMG SBP Parameters element, the DMG Sensing Measurement Setup element, the DMG Sensing Image Range Axis LUT element, or the DMG Sensing Image Doppler Axis LUT element.

### 1.3.3 SBP Report Frame

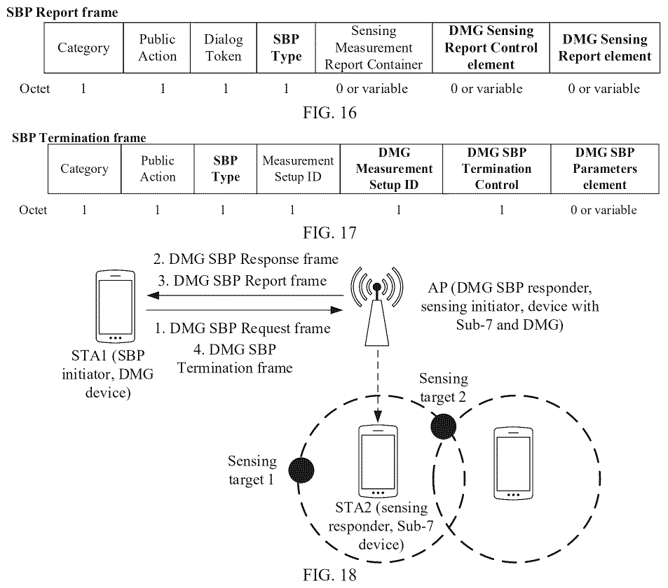

In some embodiments, the frame structure of the SBP Report frame is as illustrated in FIG. 16, and includes: a Category field, a Public Action field, a Dialog Token field, an SBP Type field, a Sensing Measurement Report Container(s) field, a DMG Sensing Report Control element, and a DMG Sensing Report element(s) which are sequentially arranged.

The Category field occupies 1 octet, the Public Action field occupies 1 octet, the Dialog Token field occupies 1 octet, the SBP Type field occupies 1 octet, the Sensing Measurement Report Container(s) occupies 0 octet or has a variable number of octets, the DMG Sensing Report Control element occupies 0 octet or has a variable number of octets, and the DMG Sensing Report element(s) occupies 0 octet or has a variable number of octets.

In some embodiments, the SBP type requested by the low-frequency band device is indicated by a value of the SBP Type field in the SBP Request frame.

The SBP Type field taking a first value indicates that the Sub-7 device requests to perform Sub-7 SBP. The SBP Type field taking a second value indicates that the Sub-7 device requests to perform DMG SBP. The SBP Type field taking a third value indicates that the Sub-7 device simultaneously requests to perform Sub-7 SBP and DMG SBP.

For example, the first value is set to be 0, the second value is set to be 1, and the third value is set to be 2.

In a case where the SBP Type field in the SBP Request frame indicates Sub-7 SBP, the SBP Report frame is used to feed back a Sub-7 sensing measurement result. The Sensing Measurement Report Container(s) field in the SBP Report frame is present; and the DMG Sensing Report Control element and the DMG Sensing Report element(s) are not present.

In a case where the SBP Type field in the SBP Request frame indicates DMG SBP, the SBP Report frame is used to feed back a DMG sensing measurement result. The DMG Sensing Report Control element and the DMG Sensing Report element(s) in the SBP Report frame are present; and the Sensing Measurement Report Container(s) field is not present.

In a case where the SBP Type field in the SBP Request frame indicates to simultaneously request to perform Sub-7 SBP and DMG SBP, the SBP Report frame is used to feed back the Sub-7 sensing measurement result and the DMG sensing measurement result. The Sensing Measurement Report Container(s) field, the DMG Sensing Report Control element and the DMG Sensing Report element(s) in the SBP Report frame are present.

### 1.3.4 SBP Termination Frame

In some embodiments, the frame structure of the SBP Termination frame is as illustrated in FIG. 17, and includes: a Category field, a Public Action field, an SBP Type field, a Measurement Setup ID field, a DMG Measurement Setup ID field, a DMG SBP Termination Control field, and a DMG SBP Parameters element which are sequentially arranged.

The Category field occupies 1 octet, the Public Action field occupies 1 octet, the SBP Type field occupies 1 octet, the Measurement Setup ID field occupies 1 octet, the DMG Measurement Setup ID field occupies 1 octet, the DMG SBP Termination Control field occupies 1 octet, and the DMG SBP Parameters element occupies 0 octet or has a variable number of octets.

In some embodiments, the SBP type requested by the low-frequency band device is indicated by a value of the SBP Type field in the SBP Request frame. The SBP type requested to be terminated by the low-frequency band device is indicated by a value of the SBP Type field in the SBP Termination frame.

The SBP Type field taking a first value indicates that the Sub-7 device requests to perform Sub-7 SBP. The SBP Type field taking a second value indicates that the Sub-7 device requests to perform DMG SBP. The SBP Type field taking a third value indicates that the Sub-7 device simultaneously requests to perform Sub-7 SBP and DMG SBP.

In a case where the SBP Type field in the SBP Request frame indicates Sub-7 SBP, the SBP Termination frame is used to request to terminate a Sub-7 SBP process. The Measurement Setup ID field in the SBP Termination frame is present, and the DMG Measurement Setup ID field, the DMG SBP Termination Control field, and the DMG SBP Parameters element are not present.

In a case where the SBP Type field in the SBP Request frame indicates DMG SBP, the SBP Termination frame is used to request to terminate a DMG SBP process. The DMG Measurement Setup ID field, the DMG SBP Termination Control field, and the DMG SBP Parameters element in the SBP Termination frame are present, and the Measurement Setup ID field is not present.

In a case where the SBP Type field in the SBP Request frame indicates Sub-7 SBP and DMG SBP, the SBP Termination frame is used to request to terminate the Sub-7 SBP process and the DMG SBP process. The Measurement Setup ID field, the DMG Measurement Setup ID field, the DMG SBP Termination Control field, and the DMG SBP Parameters element in the SBP Termination frame are present.

1.3.5 Processes in which a Low-Frequency Band Device Requests to Perform SBP in a High-Frequency Band

Please refer to FIGS. 9 and 10, and the detailed processes in which a low-frequency band device requests to perform SBP in a high-frequency band are as follows.

In process 0, the DMG sensing initiator broadcasts the Beacon frame, and the sensing responder actively transmits the Probe Request frame, the Association Request frame, or the Reassociation Request frame to the DMG sensing initiator and receives the Probe Request frame, the Association Request frame, or the Reassociation Request frame returned by the DMG sensing initiator for exchanging sensing capability information of the DMG sensing initiator and the DMG sensing responder.

In process 1, the SBP initiator (STA1, the Sub-7 device) initiates the DMG SBP process by transmitting the SBP Request frame to the SBP responder (AP).

In some embodiments, taking the SBP Request frame in FIG. 13 as an example, the SBP Request frame carries the SBP Type field, the DMG SBP Parameters element, and the DMG Sensing Measurement Setup element. The SBP Type field takes a second value. For example, the second value is set to be 1.

In process 2, the SBP responder (AP) negotiates with the DMG sensing responder (STA2, the DMG device) the operation parameters in the DMG sensing measurement process by transmitting the DMG Sensing Measurement Setup Request frame to the DMG sensing responder (STA2, the DMG device).

In process 3, the DMG sensing responder (STA2, the DMG device) indicates confirmation of establishing the DMG sensing measurement by transmitting the DMG Sensing Measurement Setup Response frame to the SBP responder (AP).

In process 4, the SBP responder (AP) indicates acceptance of the SBP task by transmitting the SBP Response frame to the SBP initiator (STA1, the Sub-7 device).

In some embodiments, the SBP Response frame carries the DMG SBP Parameters element, the DMG Sensing Measurement Setup element, and the DMG Measurement Setup ID field. In the case where the Status Code field is SUCCESS, the SBP Response frame further carries a DMG Sensing Image Range Axis LUT element, a DMG Sensing Image Doppler Axis LUT element, and a Beam Descriptor field, which are used to assist the SBP initiator (STA1, the Sub-7 device) in parsing the DMG sensing measurement result. In the case where the Status Code field is REQUEST_DECLINED, DMG sensing is terminated.

In process 5, the SBP responder (AP) and the DMG sensing responder (STA2, the DMG device) complete the DMG sensing measurement process based on the setting in the SBP Request frame.

In process 6, the SBP responder (AP) notifies the DMG sensing measurement result by transmitting the SBP Report frame to the SBP initiator (STA1, the Sub-7 device).

In some embodiments, taking the SBP Report frame in FIG. 16 as an example, the SBP Report frame carries the DMG Sensing Report Control element and the DMG Sensing Report element(s), but does not carry the Sensing Measurement Report Container(s) field.

In process 7, the SBP initiator (STA1, the Sub-7 device) indicates termination of the related DMG sensing by transmitting the SBP Termination frame to the SBP responder (AP).

In some embodiments, the SBP Termination frame carries the DMG Measurement Setup ID field and the DMG SBP Termination Control field, but does not carry the Measurement Setup ID field.

1.3.6 Processes in which a Low-Frequency Band Device Simultaneously Requests to Perform SBP in a Low-Frequency Band and a High-Frequency Band

Please refer to FIGS. 11 and 12. The detailed processes in which a low-frequency band device simultaneously requests to perform SBP in a low-frequency band and a high-frequency band are as follows.

In process 0, the DMG sensing initiator (AP) broadcasts the Beacon frame, and the DMG sensing responder (STA2, the DMG device) and the sensing responder (STA3, the Sub-7 device) actively transmit the Probe Request frame, the Association Request frame, or the Reassociation Request frame to the DMG sensing initiator (AP) and receives the Probe Request frame, the Association Request frame, or the Reassociation Request frame returned by the DMG sensing initiator (AP) for exchanging sensing capability information of the DMG sensing initiator (AP), the DMG sensing responder (STA2, the DMG device) and the sensing responder (STA3, the Sub-7 device).

In process 1, the SBP initiator (STA1, the Sub-7 device) initiates the Sub-7 SBP process and the DMG SBP process by transmitting the SBP Request frame to the SBP responder (AP).

In some embodiments, taking the SBP Request frame in FIG. 13 as an example, the SBP Request frame carries the SBP Type field, the DMG SBP Parameters element, the SBP Parameters element, the Sensing Measurement Parameters element, the DMG Sensing Measurement Setup element, and the ISTA Availability Window element. The SBP Type field takes a third value. For example, the third value is set to be 2.

In process 2, the SBP responder (AP) negotiates with the sensing responder (STA3, the Sub-7 device) the operation parameters in the sensing measurement process by transmitting the Sensing Measurement Setup Request frame to the sensing responder (STA3, the Sub-7 device).

In process 3, the sensing responder (STA3, the Sub-7 device) indicates confirmation of establishing the sensing measurement by transmitting the Sensing Measurement Setup Response frame to the SBP responder (AP).

In process 4, the SBP responder (AP) negotiates with the DMG sensing responder (STA2, the DMG device) the operation parameters in the DMG sensing measurement process by transmitting the DMG Sensing Measurement Setup Request frame to the DMG sensing responder (STA2, the DMG device).

In process 5, the DMG sensing responder (STA2, the DMG device) indicates confirmation of establishing the DMG sensing measurement by transmitting the DMG Sensing Measurement Setup Response frame to the SBP responder (AP).

Processes 2 and 3, and processes 3 and 4 may be performed sequentially or synchronously.

In process 6, the SBP responder (AP) indicates acceptance of the SBP task by transmitting the SBP Response frame to the SBP initiator (STA1, the Sub-7 device).

In some embodiments, the SBP Response frame carries the SBP Type field, the DMG SBP Parameters element, the SBP Parameters element, the Sensing Measurement Parameters element, the DMG Sensing Measurement Setup element, the RSTA Availability Window element, the DMG Measurement Setup ID field, and the Measurement Setup ID field, which are used to assist the SBP initiator (STA1, the Sub-7 device) in parsing sensing measurement reports of different frequency bands. The SBP Type field takes the third value. For example, the third value is set to be 2. In the case where the Status Code field is SUCCESS, the SBP Response frame further carries the DMG Sensing Image Range Axis LUT element, the DMG Sensing Image Doppler Axis LUT element, and the Beam Descriptor field, which are used to assist the SBP initiator (STA1, the Sub-7 device) in parsing the DMG sensing measurement report. In the case where the Status Code field is REQUEST_DECLINED, the SBP process is terminated.

In process 7, the SBP responder (AP) and the DMG sensing responder (STA2, the DMG device) complete the DMG sensing measurement process based on the setting in the SBP Request frame. The DMG sensing responder (STA2, the DMG device) feeds back a DMG sensing measurement result to the SBP responder (AP).

In process 8, the DMG SBP responder (STA2, the DMG device) and the sensing responder (STA3, the Sub-7 device) complete the Sub-7 frequency band sensing measurement process based on the setting in the SBP Request frame. The sensing responder (STA3, the Sub-7 device) feeds back the sensing measurement result to the SBP responder (AP).

In process 9, the SBP responder (AP) notifies the DMG sensing measurement result and the Sub-7 frequency band sensing measurement result by transmitting the SBP Report frame to the SBP initiator (STA1, the Sub-7 device).

In some embodiments, taking the SBP Report frame in FIG. 16 as an example, the SBP Report frame carries the Sensing Measurement Report Container(s), the DMG Sensing Report Control element, and the DMG Sensing Report element(s).

In process 10, the SBP initiator (STA1, the Sub-7 device) indicates termination of the related DMG sensing and Sub-7 frequency band sensing by transmitting the SBP Termination frame to the SBP responder (AP).

In some embodiments, the SBP Termination frame carries at least one of the DMG SBP Parameters element, the DMG SBP Termination Control field, the Measurement Setup ID field, or the DMG Measurement Setup ID field, which is used to specify the DMG SBP process and the Sub-7 frequency band SBP process requested to be terminated.

In some embodiments, in a case where only the Sub-7 frequency band SBP process needs to be terminated, the SBP Termination frame carries the Measurement Setup ID field. In a case where only the DMG SBP process needs to be terminated, the SBP Termination frame carries the DMG SBP Parameters element, the DMG SBP Termination Control field, and the DMG Measurement Setup ID field.

### 2. High-Frequency Band Device

### 2.1. A High-Frequency Band Device Requests to Perform SBP in a Low-Frequency Band.

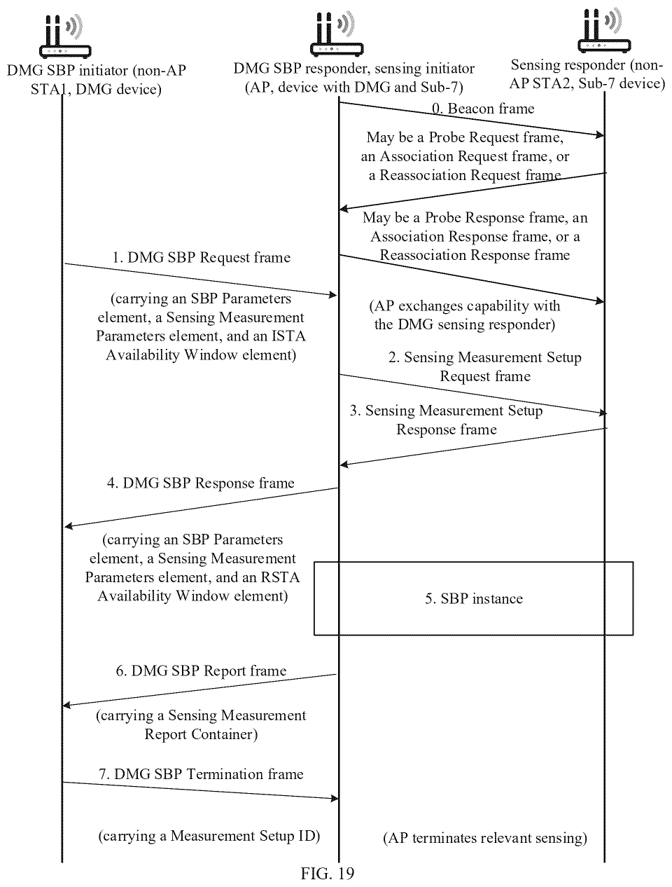

FIG. 18 is a diagram of a scenario in which a high-frequency band device requests to perform SBP in a low-frequency band according to some embodiments of the present disclosure. FIG. 19 is a flowchart in which a high-frequency band device requests to perform SBP in a low-frequency band according to some embodiments of the present disclosure.

FIGS. 18 and 19 relate to a DMG SBP initiator (STA1, a DMG device), a DMG SBP responder (AP, a device with both DMG and Sub-7 sensing capabilities), a sensing initiator (AP), and a sensing responder (STA2, a Sub-7 device). The DMG SBP responder is used to respond to an SBP request of the DMG SBP initiator, and meanwhile acts as the sensing initiator for initiating sensing.

Please refer to FIGS. 18 and 19. The process in which the high-frequency band device requests to perform SBP in the low-frequency band is briefly described hereinafter.

In process 0, the sensing initiator broadcasts a Beacon frame, and the sensing responder actively transmits a Probe Request frame, an Association Request frame, or a Reassociation Request frame to the sensing initiator and receives the Probe Request frame, the Association Request frame, or the Reassociation Request frame returned by the sensing initiator for exchanging sensing capability information of the sensing initiator and the sensing responder.

In process 1, the DMG SBP initiator (STA1, the DMG device) initiates a Sub-7 SBP process by transmitting a DMG SBP Request frame to the DMG SBP responder (AP).

In some embodiments, the DMG SBP Request frame carries at least one of an SBP Parameters element, a Sensing Measurement Parameters element, or an ISTA Availability Window element.

In process 2, the DMG SBP responder (AP) negotiates with the sensing responder (STA2, the Sub-7 device) operation parameters in a Sub-7 sensing measurement process by transmitting a Sensing Measurement Setup Request frame to the sensing responder (STA2, the Sub-7 device).

In process 3, the sensing responder (STA2, the Sub-7 device) indicates confirmation of establishing the Sub-7 sensing measurement by transmitting a Sensing Measurement Setup Response frame to the DMG SBP responder (AP).

In process 4, the DMG SBP responder (AP) indicates acceptance of an SBP task by transmitting a DMG SBP Response frame to the DMG SBP initiator (STA1, the DMG device).

In some embodiments, the DMG SBP Response frame carries at least one of the SBP Parameters element, the Sensing Measurement Parameters element, or an RSTA Availability Window element field.

In process 5, the DMG SBP responder (AP) and the sensing responder (STA2, the Sub-7 device) complete the Sub-7 sensing measurement process based on the setting in the DMG SBP Request frame.

In process 6, the DMG SBP responder (AP) notifies a Sub-7 sensing measurement result by transmitting a DMG SBP Report frame to the DMG SBP initiator (STA1, the DMG device).

In some embodiments, the DMG SBP Report frame carries a Sensing Measurement Report Container field.

In process 7, the DMG SBP initiator (STA1, the DMG device) indicates termination of the related Sub-7 sensing by transmitting a DMG SBP Termination frame to the DMG SBP responder (AP).

In some embodiments, the DMG SBP Termination frame carries a Measurement Setup ID field.

### 2.2 A High-Frequency Band Device Simultaneously Requests to Perform SBP in a Low-Frequency Band and a High-Frequency Band.

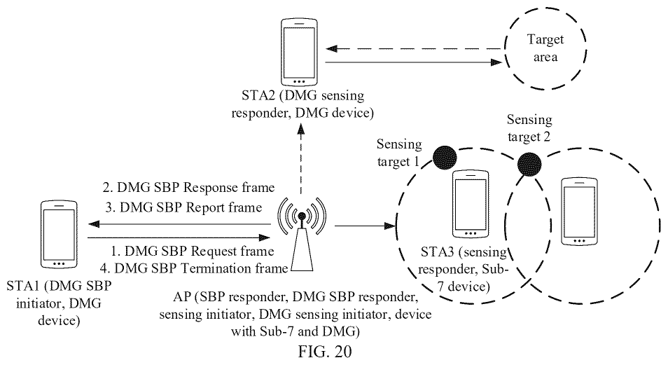

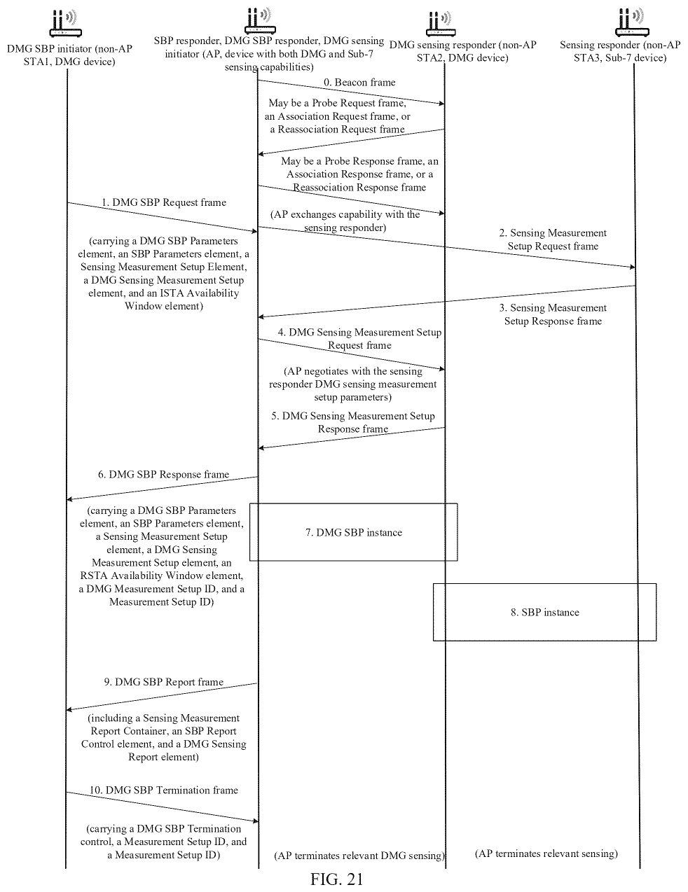

FIG. 20 is a diagram of a scenario in which a high-frequency band device simultaneously requests to perform SBP in a low-frequency band and a high-frequency band according to some embodiments of the present disclosure. FIG. 21 is a flowchart in which a high-frequency band device simultaneously requests to perform SBP in a low-frequency band and a high-frequency band according to some embodiments of the present disclosure.

FIGS. 20 and 21 relate to a DMG SBP initiator (STA1, a DMG device), an SBP responder (AP, a device with both DMG and Sub-7 sensing capabilities), a DMG SBP responder (AP), a DMG sensing initiator (AP), a sensing initiator (AP), a DMG sensing responder (STA2, a DMG device), and a sensing responder (STA3, a Sub-7 device).

The DMG SBP responder is used to respond to an SBP request of the DMG SBP initiator, and meanwhile acts as the DMG sensing initiator for initiating sensing, also acts as the sensing initiator for initiating sensing, and further acts as the SBP responder to respond to a request of the sensing responder.

Please refer to FIGS. 20 and 21. The process in which the high-frequency band device simultaneously requests to perform SBP in the low-frequency band and the high-frequency band is briefly described hereinafter.

In process 0, the DMG sensing initiator (AP) broadcasts a Beacon frame, and the DMG sensing responder (STA2, the DMG device) and the sensing responder (STA3, the Sub-7 device) actively transmit a Probe Request frame, an Association Request frame, or a Reassociation Request frame to the DMG sensing initiator (AP) and receives the Probe Request frame, the Association Request frame, or the Reassociation Request frame returned by the DMG sensing initiator (AP) for exchanging sensing capability information of the DMG sensing initiator (AP), the DMG sensing responder (STA2, the DMG device) and the sensing responder (STA3, the Sub-7 device).

In process 1, the DMG SBP initiator (STA1, the DMG device) initiates a Sub-7 SBP process and a DMG SBP process by transmitting a DMG SBP Request frame to the DMG SBP responder (AP).

In some embodiments, the SBP Request frame carries at least one of a DMG SBP Parameters element, an SBP Parameters element, a Sensing Measurement Parameters element, a DMG Sensing Measurement Setup element, or an ISTA Availability Window element.

In process 2, the DMG SBP responder (AP) negotiates with the sensing responder (STA3, the Sub-7 device) operation parameters in a Sub-7 sensing measurement process by transmitting a Sensing Measurement Setup Request frame to the sensing responder (STA3, the Sub-7 device).

In process 3, the sensing responder (STA3, the Sub-7 device) indicates confirmation of establishing the sensing measurement by transmitting a Sensing Measurement Setup Response frame to the DMG SBP responder (AP).

In process 4, the DMG SBP responder (AP) negotiates with the DMG sensing responder (STA2, the DMG device) operation parameters in a DMG sensing measurement process by transmitting a DMG Sensing Measurement Setup Request frame to the DMG sensing responder (STA2, the DMG device).

In process 5, the DMG sensing responder (STA2, the DMG device) indicates confirmation of establishing the DMG sensing measurement by transmitting the DMG Sensing Measurement Setup Response frame to the DMG SBP responder (AP).

Processes 2 and 3, and processes 3 and 4 may be performed sequentially or synchronously.

In process 6, the DMG SBP responder (AP) indicates acceptance of an SBP task by transmitting a DMG SBP Response frame to the DMG SBP initiator (STA1, the DMG device).

In some embodiments, the SBP Response frame carries at least one of the DMG SBP Parameters element, the SBP Parameters element, the Sensing Measurement Parameters element, the DMG Sensing Measurement Setup element, an RSTA Availability Window element, a DMG Measurement Setup ID field, or a Measurement Setup ID field.

In process 7, the DMG SBP responder (AP) and the DMG sensing responder (STA2, the DMG device) complete the DMG sensing measurement process based on the setting in the SBP Request frame. The DMG sensing responder (STA2, the DMG device) feeds back a DMG sensing measurement result to the DMG SBP responder (AP).

In process 8, the DMG SBP responder (STA2, the DMG device) and the sensing responder (STA3, the Sub-7 device) complete the Sub-7 frequency band sensing measurement process based on the setting in the SBP Request frame. The sensing responder (STA3, the Sub-7 device) feeds back the sensing measurement result to the DMG SBP responder (AP).

In process 9, the DMG SBP responder (AP) notifies the DMG sensing measurement result and a Sub-7 frequency band sensing measurement result by transmitting a DMG SBP Report frame to the DMG SBP initiator (STA1, the DMG device).

In some embodiments, the SBP Report frame carries at least one of a Sensing Measurement Report Container, a DMG Sensing Report Control element, or a DMG Sensing Report element.

In process 10, the DMG SBP initiator (STA1, the DMG device) indicates termination of the related DMG sensing and Sub-7 frequency band sensing by transmitting a DMG SBP Termination frame to the DMG SBP responder (AP).

In some embodiments, the SBP Termination frame carries at least one of the Measurement Setup ID field, the DMG Measurement Setup ID field, or a DMG SBP Termination Control field.

### 2.3 Frame Format of a High-Frequency Band Device

### 2.3.1 DMG SBP Request Frame

### 2.3.1.1 An SBP Type Requested by the High-Frequency Band Device is Indicated by an SBP Type Field.

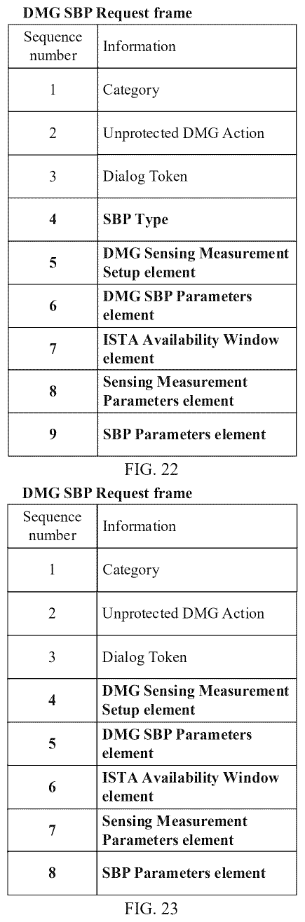

In some embodiments, the frame structure of the DMG SBP Request frame is as illustrated in FIG. 22, and includes: a Category field, an Unprotected DMG Action field, a Dialog Token field, an SBP Type field, a DMG Sensing Measurement Setup element, a DMG SBP Parameters element, an ISTA Availability Window element, a Sensing Measurement Parameters element, and an SBP Parameters element which are sequentially arranged.

The Category field corresponds to sequence number 1, the Unprotected DMG Action field corresponds to sequence number 2, the Dialog Token field corresponds to sequence number 3, the SBP Type field corresponds to sequence number 4, the DMG Sensing Measurement Setup element corresponds to sequence number 5, the DMG SBP Parameters element corresponds to sequence number 6, the ISTA Availability Window element corresponds to sequence number 7, the Sensing Measurement Parameters element corresponds to sequence number 8, and the SBP Parameters element corresponds to sequence number 9.

In some embodiments, the SBP type requested by the high-frequency band device is indicated by a value of the SBP Type field in the SBP Request frame.

The SBP Type field taking a first value indicates that the DMG device requests to perform Sub-7 SBP. The SBP Type field taking a second value indicates that the DMG device requests to perform DMG SBP. The SBP Type field taking a third value indicates that the DMG device simultaneously requests to perform Sub-7 SBP and DMG SBP.

For example, the first value is set to be 0, the second value is set to be 1, and the third value is set to be 2.

In a case where the SBP Type field is the first value, the SBP Parameters element, the Sensing Measurement Parameters element, and the ISTA Availability Window element in the DMG SBP Request frame are present, and the DMG SBP Parameters element and the DMG Sensing Measurement Setup element are not present.

In a case where the SBP Type field is the second value, the DMG SBP Parameters element and the DMG Sensing Measurement Setup element in the DMG SBP Request frame are present, and the SBP Parameters element, the Sensing Measurement Parameters element, and the ISTA Availability Window element are not present.

In a case where the SBP Type field is the third value, the DMG SBP Parameters element, the DMG Sensing Measurement Setup element, the SBP Parameters element, the Sensing Measurement Parameters element, and the ISTA Availability Window element in the DMG SBP Request frame are present.

### 2.3.1.2 An SBP Type Requested by the High-Frequency Band Device is Indicated by an Element.

In some embodiments, the frame structure of the DMG SBP Request frame is as illustrated in FIG. 23, and includes: a Category field, an Unprotected DMG Action field, a Dialog Token field, a DMG Sensing Measurement Setup element, a DMG SBP Parameters element, an ISTA Availability Window element, a Sensing Measurement Parameters element, and an SBP Parameters element which are sequentially arranged.

The Category field corresponds to sequence number 1, the Unprotected DMG Action field corresponds to sequence number 2, the Dialog Token field corresponds to sequence number 3, the DMG Sensing Measurement Setup element corresponds to sequence number 4, the DMG SBP Parameters element corresponds to sequence number 5, the ISTA Availability Window element corresponds to sequence number 6, the Sensing Measurement Parameters element corresponds to sequence number 7, and the SBP Parameters element corresponds to sequence number 8.

In some embodiments, the SBP type requested by the high-frequency band device is indicated by whether the element in the SBP Request frame being present.

In a case where the SBP Parameters element, the Sensing Measurement Parameters element, and the ISTA Availability Window element in the SBP Request frame are present, and the DMG SBP Parameters element and the DMG Sensing Measurement Setup element are not present, this case indicates that the DMG device requests to perform Sub-7 SBP.

In a case where the DMG SBP Parameters element and the DMG Sensing Measurement Setup element in the SBP Request frame are present, and the SBP Parameters element, the Sensing Measurement Parameters element, and the ISTA Availability Window element are not present, this case indicates that the DMG device requests to perform DMG SBP.

In a case where the DMG SBP Parameters element, the DMG Sensing Measurement Setup element, the SBP Parameters element, the Sensing Measurement Parameters element, and the ISTA Availability Window element in the SBP Request frame are present, this case indicates that the DMG device simultaneously requests to perform DMG SBP and Sub-7 SBP.

### 2.3.2 DMG SBP Response Frame

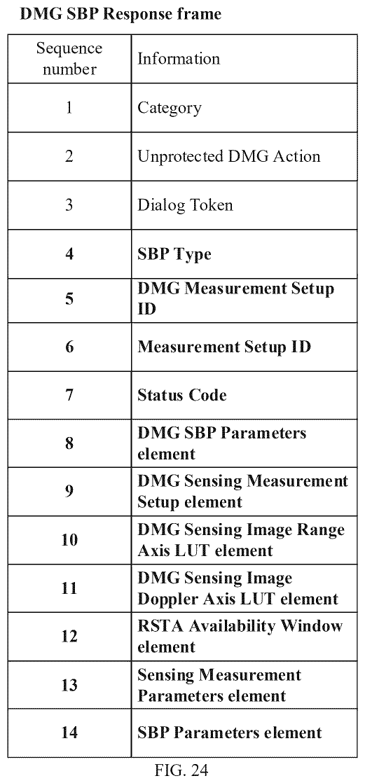

In some embodiments, the frame structure of the DMG SBP Response frame is as illustrated in FIG. 24, and includes: a Category field, an Unprotected DMG Action field, a Dialog Token field, an SBP Type field, a DMG Measurement Setup ID field, a Measurement Setup ID field, a Status Code, a DMG SBP Parameters element, a DMG Sensing Measurement Setup element, a DMG Sensing Image Range Axis LUT element, a DMG Sensing Image Doppler Axis LUT element, an RSTA Availability Window element, a Sensing Measurement Parameters element, and an SBP Parameters element which are sequentially arranged.

The Category field corresponds to sequence number 1, the Unprotected DMG Action field corresponds to sequence number 2, the Dialog Token field corresponds to sequence number 3, the SBP Type field corresponds to sequence number 4, the DMG Measurement Setup ID field corresponds to sequence number 5, the Measurement Setup ID field corresponds to sequence number 6, the Status Code corresponds to sequence number 7, the DMG SBP Parameters element corresponds to sequence number 8, the DMG Sensing Measurement Setup element corresponds to sequence number 9, the DMG Sensing Image Range Axis LUT element corresponds to sequence number 10, the DMG Sensing Image Doppler Axis LUT element corresponds to sequence number 11, the RSTA Availability Window element corresponds to sequence number 12, the Sensing Measurement Parameters element corresponds to sequence number 13, and the SBP Parameters element corresponds to sequence number 14.

In some embodiments, the SBP type requested by the high-frequency band device is indicated by a value of the SBP Type field in the SBP Request frame.

The SBP Type field taking a first value indicates that the DMG device requests to perform Sub-7 SBP. The SBP Type field taking a second value indicates that the DMG device requests to perform DMG SBP. The SBP Type field taking a third value indicates that the DMG device simultaneously requests to perform Sub-7 SBP and DMG SBP.

For example, the first value is set to be 0, the second value is set to be 1, and the third value is set to be 2.

In a case where the DMG SBP Request frame is used to request to perform Sub-7 SBP, the Measurement Setup ID field, the RSTA Availability Window element, the SBP Parameters element, and the Sensing Measurement Parameters element in the DMG SBP Request frame are present; and the DMG Measurement Setup ID field, the DMG SBP Parameters element, the DMG Sensing Measurement Setup element, the DMG Sensing Image Range Axis LUT element, and the DMG Sensing Image Doppler Axis LUT element are not present.

In a case where the DMG SBP Request frame is used to request to perform DMG SBP, the Measurement Setup ID field, the RSTA Availability Window element, the SBP Parameters element, and the Sensing Measurement Parameters element in the DMG SBP Request frame are not present; the DMG Measurement Setup ID field, the DMG SBP Parameters element, and the DMG Sensing Measurement Setup element are present; and the DMG Sensing Image Range Axis LUT element, and the DMG Sensing Image Doppler Axis LUT element are present or not present.

In a case where the DMG SBP Request frame is used to request to perform DMG SBP and Sub-7 SBP, the Measurement Setup ID field, the DMG Measurement Setup ID field, the RSTA Availability Window element, the SBP Parameters element, the Sensing Measurement Parameters element, the DMG SBP Parameters element, and the DMG Sensing Measurement Setup element in the DMG SBP Request frame are present; and the DMG Sensing Image Range Axis LUT element, and the DMG Sensing Image Doppler Axis LUT element are present or not present.

### 2.3.3 DMG SBP Report Frame

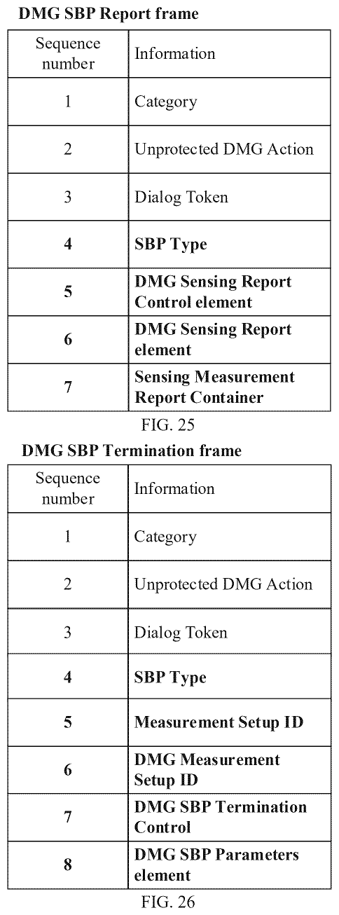

In some embodiments, the frame structure of the DMG SBP Report frame is as illustrated in FIG. 25, and includes: a Category field, an Unprotected DMG Action field, a Dialog Token field, an SBP Type field, a DMG Sensing Report Control element, a DMG Sensing Report element(s), and a Sensing Measurement Report Container(s) field which are sequentially arranged.

The Category field corresponds to sequence number 1, the Unprotected DMG Action field corresponds to sequence number 2, the Dialog Token field corresponds to sequence number 3, the SBP Type field corresponds to sequence number 4, the DMG Sensing Report Control element corresponds to sequence number 5, the DMG Sensing Report element(s) corresponds to sequence number 6, and the Sensing Measurement Report Container(s) field corresponds to sequence number 7.

In some embodiments, the SBP type requested by the high-frequency band device is indicated by a value of the SBP Type field in the DMG SBP Request frame.

The SBP Type field taking the first value indicates that the DMG device requests to perform Sub-7 SBP. The SBP Type field taking the second value indicates that the DMG device requests to perform DMG SBP. The SBP Type field taking the third value indicates that the DMG device simultaneously requests to perform Sub-7 SBP and DMG SBP.

For example, the first value is set to be 0, the second value is set to be 1, and the third value is set to be 2.

In a case where the SBP Type field in the DMG SBP Request frame indicates Sub-7 SBP, the DMG SBP Report frame is used to feed back a Sub-7 sensing measurement result. The Sensing Measurement Report Container(s) field in the DMG SBP Report frame is present; and the DMG Sensing Report Control element and the DMG Sensing Report element(s) are not present.

In a case where the SBP Type field in the DMG SBP Request frame indicates DMG SBP, the DMG SBP Report frame is used to feed back a DMG sensing measurement result. The DMG Sensing Report Control element and the DMG Sensing Report element(s) in the DMG SBP Report frame are present; and the Sensing Measurement Report Container(s) field is not present.

In a case where the SBP Type field in the DMG SBP Request frame indicates Sub-7 SBP and DMG SBP, the DMG SBP Report frame is used to feed back the Sub-7 sensing measurement result and the DMG sensing measurement result. The Sensing Measurement Report Container(s) field, the DMG Sensing Report Control element, and the DMG Sensing Report element(s) in the DMG SBP Report frame are present.

### 2.3.4 DMG SBP Termination Frame

In some embodiments, the frame structure of the DMG SBP Termination frame is as illustrated in FIG. 26, and includes: a Category field, an Unprotected DMG Action field, a Dialog Token field, an SBP Type field, a Measurement Setup ID field, a DMG Measurement Setup ID field, a DMG SBP Termination Control field, and a DMG SBP Parameters element which are sequentially arranged.

The Category field corresponds to sequence number 1, the Unprotected DMG Action field corresponds to sequence number 2, the Dialog Token field corresponds to sequence number 3, the SBP Type field corresponds to sequence number 4, the Measurement Setup ID field corresponds to sequence number 5, the DMG Measurement Setup ID field corresponds to sequence number 6, the DMG SBP Termination Control field corresponds to sequence number 7, and the DMG SBP Parameters element corresponds to sequence number 8.

In some embodiments, the SBP type requested by the high-frequency band device is indicated by a value of the SBP Type field in the DMG SBP Request frame. The SBP type requested to be terminated by the high-frequency band device is indicated by a value of the SBP Type field in the DMG SBP Termination frame.

The SBP Type field taking the first value indicates that the DMG device requests to perform Sub-7 SBP. The SBP Type field taking the second value indicates that the DMG device requests to perform DMG SBP. The SBP Type field taking the third value indicates that the DMG device simultaneously requests to perform Sub-7 SBP and DMG SBP.

For example, the first value is set to be 0, the second value is set to be 1, and the third value is set to be 2.

In a case where the SBP Type field in the DMG SBP Request frame indicates Sub-7 SBP, the DMG SBP Termination frame is used to request to terminate a Sub-7 SBP process. The Measurement Setup ID field in the DMG SBP Termination frame is present, and the DMG Measurement Setup ID field, the DMG SBP Termination Control field, and the DMG SBP Parameters element are not present.

In a case where the SBP Type field in the DMG SBP Request frame indicates DMG SBP, the DMG SBP Termination frame is used to request to terminate a DMG SBP process. The DMG Measurement Setup ID field, the DMG SBP Termination Control field, and the DMG SBP Parameters element in the DMG SBP Termination frame are present, and the Measurement Setup ID field is not present.

In a case where the SBP Type field in the DMG SBP Request frame indicates Sub-7 SBP and DMG SBP, the DMG SBP Termination frame is used to request to terminate the Sub-7 SBP process and the DMG SBP process. The Measurement Setup ID field, the DMG Measurement Setup ID field, the DMG SBP Termination Control field, and the DMG SBP Parameters element in the DMG SBP Termination frame are present.

2.3.5 Processes in which a High-Frequency Band Device Requests to Perform SBP in a Low-Frequency Band

Please refer to FIGS. 18 and 19, and the detailed processes in which a high-frequency band device requests to perform SBP in a low-frequency band are as follows.

In process 0, the sensing initiator broadcasts the Beacon frame, and the sensing responder actively transmits the Probe Request frame, the Association Request frame, or the Reassociation Request frame to the sensing initiator and receives the Probe Request frame, the Association Request frame, or the Reassociation Request frame returned by the sensing initiator for exchanging sensing capability information of the sensing initiator and the sensing responder.

In process 1, the DMG SBP initiator (STA1, the DMG device) initiates the Sub-7 SBP process by transmitting the DMG SBP Request frame to the DMG SBP responder (AP).

In some embodiments, taking the DMG SBP Request frame in FIG. 22 as an example, the DMG SBP Request frame carries the SBP Type field, the SBP Parameters element, the Sensing Measurement Parameters element, and the ISTA Availability Window element, but does not carry the DMG SBP Parameters element or the DMG Sensing Measurement Setup element. The SBP Type takes the first value. For example, the first value is set to be 0.

In process 2, the DMG SBP responder (AP) negotiates with the sensing responder (STA2, the Sub-7 device) the operation parameters in the Sub-7 sensing measurement process by transmitting a Sensing Measurement Setup Request frame to the sensing responder (STA2, the Sub-7 device).

In process 3, the sensing responder (STA2, the Sub-7 device) indicates confirmation of establishing the Sub-7 sensing measurement by transmitting the Sensing Measurement Setup Response frame to the DMG SBP responder (AP).

In process 4, the DMG SBP responder (AP) indicates acceptance of the SBP task by transmitting the DMG SBP Response frame to the DMG SBP initiator (STA1, the DMG device).

In some embodiments, taking the DMG SBP Response frame in FIG. 24 as an example, the DMG SBP Response frame carries the SBP Type field, the SBP Parameters element, the Sensing Measurement Parameters element, the RSTA Availability Window element, and the Measurement Setup ID field, which are used to assist the DMG SBP initiator (STA1, the DMG device) in parsing the sensing measurement reports. The SBP Type field takes the first value. For example, the first value is set to be 0. The DMG SBP Response frame does not carry the DMG SBP Parameters element, the DMG Sensing Measurement Setup element, the DMG Sensing Image Range Axis LUT element, the DMG Sensing Image Doppler Axis LUT element, the Beam Descriptor, or the DMG Measurement Setup ID field. In the case where the Status Code is REQUEST_DECLINED, the SBP process is terminated.

In process 5, the DMG SBP responder (AP) and the sensing responder (STA2, the Sub-7 device) complete the Sub-7 sensing measurement process based on the setting in the DMG SBP Request frame.

In process 6, the DMG SBP responder (AP) notifies the Sub-7 sensing measurement result by transmitting the DMG SBP Report frame to the DMG SBP initiator (STA1, the DMG device).

In some embodiments, taking the DMG SBP Report frame in FIG. 25 as an example, the DMG SBP Report frame carries the Sensing Measurement Report Container field, but does not carry the DMG Sensing Report Control element or the DMG Sensing Report element.

In process 7, the DMG SBP initiator (STA1, the DMG device) indicates termination of the related Sub-7 sensing by transmitting the DMG SBP Termination frame to the DMG SBP responder (AP).

In some embodiments, taking the DMG SBP Termination frame in FIG. 26 as an example, the DMG SBP Termination frame carries the Measurement Setup ID field, which is used to specify the termination of the Sub-7 sensing measurement, and the DMG SBP Termination frame does not carry the DMG SBP Termination Control field or the DMG Measurement Setup ID field.

2.3.6 Processes in which a High-Frequency Band Device Simultaneously Requests to Perform SBP in a Low-Frequency Band and a High-Frequency Band

Please refer to FIGS. 20 and 21, and the detailed processes in which a high-frequency band device simultaneously requests to perform SBP in a low-frequency band and a high-frequency band are as follows.

In process 0, the DMG sensing initiator (AP) broadcasts the Beacon frame, and the DMG sensing responder (STA2, the DMG device) and the sensing responder (STA3, the Sub-7 device) actively transmit the Probe Request frame, the Association Request frame, or the Reassociation Request frame to the DMG sensing initiator (AP) and receive the Probe Request frame, the Association Request frame, or the Reassociation Request frame returned by the DMG sensing initiator (AP) for exchanging sensing capability information of the DMG sensing initiator (AP), the DMG sensing responder (STA2, the DMG device) and the sensing responder (STA3, the Sub-7 device).

In process 1, the DMG SBP initiator (STA1, the DMG device) initiates the Sub-7 SBP process and the DMG SBP process by transmitting the DMG SBP Request frame to the DMG SBP responder (AP).

In some embodiments, taking the DMG SBP Request frame in FIG. 22 as an example, the DMG SBP Request frame carries the SBP Type field, the DMG SBP Parameters element, the SBP Parameters element, the Sensing Measurement Parameters element, the DMG Sensing Measurement Setup element, and the ISTA Availability Window element. The SBP Type field takes the third value. For example, the third value is set to be 2.

In process 2, the DMG SBP responder (AP) negotiates with the sensing responder (STA3, the Sub-7 device) the operation parameters in the Sub-7 sensing measurement process by transmitting the Sensing Measurement Setup Request frame to the sensing responder (STA3, the Sub-7 device).

In process 3, the sensing responder (STA3, the Sub-7 device) indicates confirmation of establishing the sensing measurement by transmitting the Sensing Measurement Setup Response frame to the DMG SBP responder (AP).

In process 4, the DMG SBP responder (AP) negotiates with the DMG sensing responder (STA2, the DMG device) the operation parameters in a DMG sensing measurement process by transmitting a DMG Sensing Measurement Setup Request frame to the DMG sensing responder (STA2, the DMG device).

In process 5, the DMG sensing responder (STA2, the DMG device) indicates confirmation of establishing the DMG sensing measurement by transmitting the DMG Sensing Measurement Setup Response frame to the DMG SBP responder (AP).

Processes 2 and 3, and processes 3 and 4 may be performed sequentially or synchronously.

In process 6, the DMG SBP responder (AP) indicates acceptance of the SBP task by transmitting the DMG SBP Response frame to the DMG SBP initiator (STA1, the DMG device).

In some embodiments, taking the DMG SBP Response frame in FIG. 24 as an example, the DMG SBP Response frame carries the DMG SBP Parameters element, the SBP Parameters element, the Sensing Measurement Parameters element, the DMG Sensing Measurement Setup element, the RSTA Availability Window element, the DMG Measurement Setup ID field, and the Measurement Setup ID field, which are used to assist the DMG SBP initiator (STA1, the DMG device) in parsing the sensing measurement reports of different frequency bands. In the case where the Status Code field is SUCCESS, the DMG SBP Response frame further carries the DMG Sensing Image Range Axis LUT element, the DMG Sensing Image Doppler Axis LUT element, and the Beam Descriptor field, which are used to assist the DMG SBP initiator (STA1, the DMG device) in parsing the DMG sensing measurement report. In the case where the Status Code field is REQUEST_DECLINED, the DMG SBP process is terminated.

In process 7, the DMG SBP responder (AP) and the DMG sensing responder (STA2, the DMG device) complete the DMG sensing measurement process based on the setting in the SBP Request frame. The DMG sensing responder (STA2, the DMG device) feeds back the DMG sensing measurement result to the DMG SBP responder (AP).

In process 8, the DMG sensing responder (STA2, the DMG device) and the sensing responder (STA3, the Sub-7 device) complete the Sub-7 frequency band sensing measurement process based on the setting in the SBP Request frame. The sensing responder (STA3, the Sub-7 device) feeds back the sensing measurement result to the DMG SBP responder (AP).

In process 9, the DMG SBP responder (AP) notifies the DMG sensing measurement result and the Sub-7 frequency band sensing measurement result by transmitting the DMG SBP Report frame to the DMG SBP initiator (STA1, the DMG device).

In some embodiments, taking the DMG SBP Report frame in FIG. 25 as an example, the DMG SBP Report frame carries the SBP Type field, the Sensing Measurement Report Container field, the DMG Sensing Report Control element, and the DMG Sensing Report element.

In process 10, the DMG SBP initiator (STA1, the DMG device) indicates termination of the related DMG sensing and Sub-7 frequency band sensing by transmitting the DMG SBP Termination frame to the DMG SBP responder (AP).

In some embodiments, taking the DMG SBP Termination frame in FIG. 26 as an example, the DMG SBP Termination frame carries at least one of the DMG SBP Parameters element, the DMG SBP Termination Control field, the DMG Measurement Setup ID field, or the Measurement Setup ID field.

In a case where only the DMG SBP process needs to be terminated, the DMG SBP Termination frame carries the DMG SBP Parameters element, the DMG SBP Termination Control field, and the DMG Measurement Setup ID field. In a case where only the Sub-7 SBP process needs to be terminated, the DMG SBP Termination frame carries the Measurement Setup ID field.

### 3. Cross-Frequency Band SBP

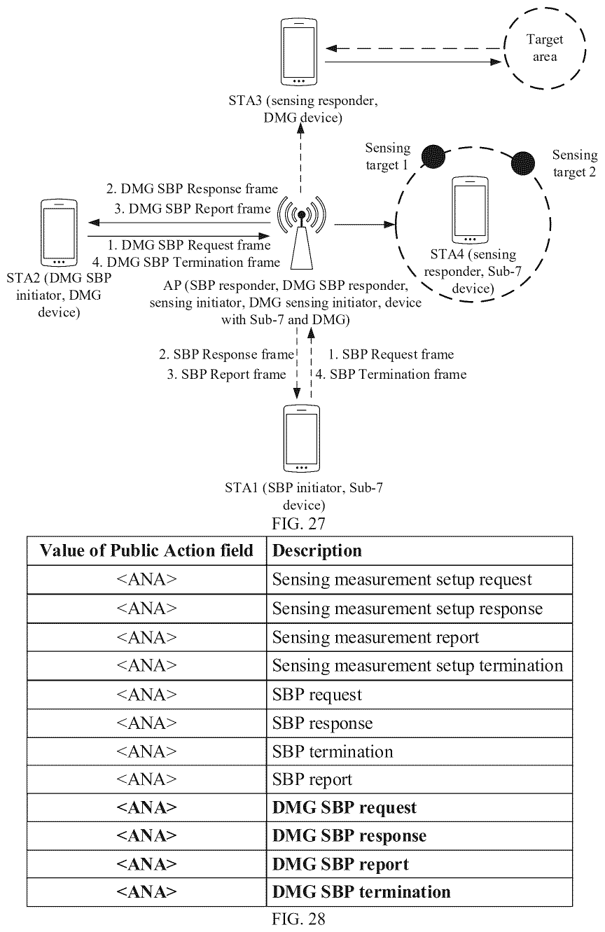

FIG. 27 is a diagram of a scenario of cross-frequency band SBP according to some embodiments of the present disclosure. A plurality of devices of different frequency bands are involved in FIG. 27. The diagram covers that a low-frequency band device requests to perform SBP in a high-frequency band, a high-frequency band device requests to perform SBP in a low-frequency band, and the high-frequency band device or the low-frequency band device simultaneously requests to perform SBP in different frequency bands.

FIG. 27 relates to an SBP initiator (STA1, Sub-7 device), an SBP responder (AP, device with both Sub-7 and DMG sensing capabilities), a DMG SBP responder (AP), a sensing initiator (AP), a DMG sensing initiator (AP), a DMG SBP initiator (STA2, DMG device), a DMG sensing responder (STA3, DMG device), and a sensing responder (STA4, Sub-7 device).

3.1. A Scenario in which a Low-Frequency Band Device Requests to Perform SBP in a High-Frequency Band

In process 0, the sensing initiator/DMG sensing initiator (AP) broadcasts a Beacon frame, and the DMG SBP initiator (STA2, the DMG device), the DMG sensing responder (STA3, the DMG device) and the sensing responder (STA4, the Sub-7 device) actively transmit a Probe Request frame, an Association Request frame, or a Reassociation Request frame to the sensing initiator/DMG sensing initiator (AP) and receive the Probe Request frame, the Association Request frame, or the Reassociation Request frame returned by the sensing initiator/DMG sensing initiator (AP) for exchanging sensing capability information of the sensing initiator/DMG sensing initiator (AP), the DMG SBP initiator (STA2, the DMG device), the DMG sensing responder (STA3, the DMG device), and the sensing responder (STA4, the Sub-7 device).

In process 1, the SBP initiator (STA1, the Sub-7 device) initiates Sub-7 SBP by transmitting an SBP Request frame to the SBP responder (AP). The SBP Type field in the SBP Request frame taking a first value indicates that the device requests to perform DMG SBP.

In some embodiments, the SBP Request frame carries the DMG SBP Parameters element, the DMG Sensing Measurement Setup element, but does not carry the SBP Parameters element, the Sensing Measurement Parameters element, or the ISTA Availability Window element.

In process 2, the DMG sensing initiator (AP) exchanges sensing capability information with the DMG sensing responder (STA3, the DMG device) and negotiates sensing parameters with the DMG sensing responder (STA3, the DMG device). The SBP responder (AP) transmits an SBP Response frame to the SBP initiator (STA1, the Sub-7 device).

In some embodiments, the SBP Response frame carries the DMG SBP Parameters element, the DMG Sensing Measurement Setup element, and the DMG Measurement Setup ID field. In the case where the Status Code field is SUCCESS, the SBP Response frame further carries the DMG Sensing Image Range Axis LUT element, the DMG Sensing Image Doppler Axis LUT element, and the Beam Descriptor field. The SBP Response frame does not carry the SBP Parameters element, the Sensing Measurement Parameters element, or the RSTA Availability Window element.

In process 3, the SBP responder (AP) and the DMG sensing responder (STA3, the DMG device) perform DMG sensing measurement based on parameters set in the SBP Request frame and the SBP Response frame, and the DMG sensing responder (STA3, the DMG device) feeds back a DMG sensing report to the SBP responder (AP). The SBP responder (AP) transmits an SBP Report frame to the SBP initiator (STA1, the Sub-7 device).

In some embodiments, the SBP Report frame carries the DMG Sensing Report Control element and the DMG Sensing Report element, but does not carry the Sensing Measurement Report Container field.

In process 4, upon receiving the SBP Report frame, the SBP initiator (STA1, the Sub-7 device) determines whether to terminate the DMG SBP process based on the condition of the DMG sensing report. The SBP initiator (STA1, the Sub-7 device) terminates the DMG SBP process by transmitting an SBP Termination frame to the SBP responder (AP).

In some embodiments, the SBP Termination frame carries the DMG Measurement Setup ID field, the DMG SBP Termination Control field and the DMG SBP Parameters element, but does not carry the Measurement Setup ID field.

3.2 A Scenario in which a High-Frequency Band Device Requests to Perform SBP in a Low-Frequency Band

In process 0, the sensing initiator/DMG sensing initiator (AP) broadcasts a Beacon frame, and the DMG SBP initiator (STA2, the DMG device), the DMG sensing responder (STA3, the DMG device) and the sensing responder (STA4, the Sub-7 device) actively transmit a Probe Request frame, an Association Request frame, or a Reassociation Request frame to the sensing initiator/DMG sensing initiator (AP) and receive the Probe Request frame, the Association Request frame, or the Reassociation Request frame returned by the sensing initiator/DMG sensing initiator (AP) for exchanging sensing capability information of the sensing initiator/DMG sensing initiator (AP), the DMG SBP initiator (STA2, the DMG device), the DMG sensing responder (STA3, the DMG device), and the sensing responder (STA4, the Sub-7 device).

In process 1, the DMG SBP initiator (STA2, the DMG device) initiates DMG SBP by transmitting a DMG SBP Request frame to the DMG SBP responder (AP). The SBP Type field in the DMG SBP Request frame taking a first value indicates that the device requests to perform Sub-7 SBP.

In some embodiments, the DMG SBP Request frame carries the SBP Parameters element, the Sensing Measurement Parameters element, and the ISTA Availability Window element, but does not carry the DMG SBP Parameters element or the DMG Sensing Measurement Setup element.

In process 2, the sensing initiator (AP) negotiates sensing parameters with the sensing responder (STA4, the Sub-7 device). The DMG SBP responder (AP) transmits a DMG SBP Response frame to the DMG SBP initiator (STA2, the DMG device).

In some embodiments, the DMG SBP Response frame carries the SBP Parameters element, the Sensing Measurement Parameters element, the Measurement Setup ID field and the RSTA Availability Window element, but does not carry the DMG SBP Parameters element, the DMG Sensing Measurement Setup element, the DMG Sensing Image Range Axis LUT element, the DMG Sensing Image Doppler Axis LUT element, or the Beam Descriptor field.

In process 3, the DMG SBP responder (AP) and the sensing responder (STA4, the Sub-7 device) perform Sub-7 sensing measurement based on parameters set in the DMG SBP Request frame and the DMG SBP Response frame, and the sensing responder (STA4, the Sub-7 device) feeds back a Sub-7 sensing report to the DMG SBP responder (AP). The DMG SBP responder (AP) transmits a DMG SBP Report frame to the DMG SBP initiator (STA2, the DMG device).

In some embodiments, the DMG SBP Report frame carries the Sensing Measurement Report Container field, but does not carry the DMG Sensing Report Control element and the DMG Sensing Report element.

In process 4, upon receiving the DMG SBP Report frame, the DMG SBP initiator (STA2, the DMG device) determines whether to terminate the Sub-7 SBP process based on the condition of the sensing report. The DMG SBP initiator (STA2, the DMG device) terminates the Sub-7 SBP process by transmitting a DMG SBP Termination frame to the DMG SBP responder (AP).

In some embodiments, the DMG SBP Termination frame carries the Measurement Setup ID field, but does not carry the DMG Measurement Setup ID field, the DMG SBP Termination Control field, or the DMG SBP Parameters element.

3.3 A Scenario in which a High-Frequency Band Device Simultaneously Requests to Perform SBP in Different Frequency Bands

In process 0, the sensing initiator/DMG sensing initiator (AP) broadcasts a Beacon frame, and the DMG SBP initiator (STA2, the DMG device), the DMG sensing responder (STA3, the DMG device) and the sensing responder (STA4, the Sub-7 device) actively transmit a Probe Request frame, an Association Request frame, or a Reassociation Request frame to the sensing initiator/DMG sensing initiator (AP) and receive the Probe Request frame, the Association Request frame, or the Reassociation Request frame returned by the sensing initiator/DMG sensing initiator (AP) for exchanging sensing capability information of the sensing initiator/DMG sensing initiator (AP), the DMG SBP initiator (STA2, the DMG device), the DMG sensing responder (STA3, the DMG device), and the sensing responder (STA4, the Sub-7 device).

In process 1, the DMG SBP initiator (STA2, the DMG device) initiates a DMG SBP process by transmitting a DMG SBP Request frame to the DMG SBP responder (AP). The SBP Type field in the DMG SBP Request frame taking a third value indicates that the device simultaneously requests to perform SBP in different frequency bands.

In some embodiments, the DMG SBP Request frame carries the SBP Parameters element, the Sensing Measurement Parameters element, the ISTA Availability Window element, the DMG SBP Parameters element, and the DMG Sensing Measurement Setup element.

In process 2, the DMG SBP responder (AP) negotiates sensing related parameters with the DMG sensing responder (STA3, the DMG device) and the sensing responder (STA4, the Sub-7 device), and the DMG SBP responder (AP) transmits a DMG SBP Response frame to the SBP initiator (STA1, the Sub-7 device) or the DMG SBP initiator (STA2, the DMG device).

In some embodiments, the DMG SBP Response frame carries the SBP Parameters element, the Sensing Measurement Parameters element, the Measurement Setup ID field, the RSTA Availability Window element, the DMG SBP Parameters element, and the DMG Sensing Measurement Setup element. In the case where the Status Code is set to be SUCCESS, the DMG SBP Response frame further carries the DMG Sensing Image Range Axis LUT element, the DMG Sensing Image Doppler Axis LUT element, and the Beam Descriptor field.

In process 3, the DMG SBP responder (AP) performs sensing measurement of different frequency bands with the DMG sensing responder (STA3, the DMG device) and the sensing responder (STA4, the Sub-7 device) based on parameters set in the DMG SBP Request frame and the DMG SBP Response frame, and the DMG SBP responder (AP) acquires sensing reports of different frequency bands. The DMG SBP responder (AP) transmits a DMG SBP Report frame to the SBP initiator (STA1, the Sub-7 device) or the DMG SBP initiator (STA2, the DMG device).

In some embodiments, the DMG SBP Report frame carries the Sensing Measurement Report Container field, the DMG Sensing Report Control element, and the DMG Sensing Report element.

In process 4, upon receiving the DMG SBP Report frame, the SBP initiator (STA1, the Sub-7 device) or the DMG SBP initiator (STA2, the DMG device) determines whether to terminate the sensing based on the condition of the sensing report. The SBP initiator (STA1, the Sub-7 device) or the DMG SBP initiator (STA2, the DMG device) terminates the SBP process by transmitting a DMG SBP Termination frame to a DMG SBP device (AP).

In some embodiments, the DMG SBP Termination frame carries the Measurement Setup ID field, the DMG Measurement Setup ID field, the DMG SBP Termination Control field, and the DMG SBP Parameters element.

3.4 A Scenario in which a Low-Frequency Band Device Simultaneously Requests to Perform SBP in Different Frequency Bands

In process 0, the sensing initiator/DMG sensing initiator (AP) broadcasts a Beacon frame, and the DMG SBP initiator (STA2, the DMG device), the DMG sensing responder (STA3, the DMG device) and the sensing responder (STA4, the Sub-7 device) actively transmit a Probe Request frame, an Association Request frame, or a Reassociation Request frame to the sensing initiator/DMG sensing initiator (AP) and receive the Probe Request frame, the Association Request frame, or the Reassociation Request frame returned by the sensing initiator/DMG sensing initiator (AP) for exchanging sensing capability information of the sensing initiator/DMG sensing initiator (AP), the DMG SBP initiator (STA2, the DMG device), the DMG sensing responder (STA3, the DMG device), and the sensing responder (STA4, the Sub-7 device).

In process 1, the SBP initiator (STA1, the Sub-7 device) initiates Sub-7 SBP and DMG SBP by transmitting an SBP Request frame to the SBP responder (AP). The SBP Type field in the SBP Request frame taking a third value indicates that the device simultaneously requests to perform SBP in different frequency bands.

In some embodiments, the SBP Request frame carries the SBP Parameters element, the Sensing Measurement Parameters element, the ISTA Availability Window element, the DMG SBP Parameters element, and the DMG Sensing Measurement Setup element.

In process 2, the sensing initiator (AP) exchanges sensing capability information with the DMG sensing responder (STA3, the DMG device) and negotiates sensing parameters with the DMG sensing responder (STA3, the DMG device), and the SBP responder (AP) transmits an SBP Response frame to the SBP initiator (STA1, the Sub-7 device) or the DMG SBP initiator (STA2, the DMG device).

In some embodiments, the SBP Response frame carries the SBP Parameters element, the Sensing Measurement Parameters element, the Measurement Setup ID field, the RSTA Availability Window element, the DMG SBP Parameters element, and the DMG Sensing Measurement Setup element. In the case where the Status Code is set to be SUCCESS, the SBP Response frame further carries the DMG Sensing Image Range Axis LUT element, the DMG Sensing Image Doppler Axis LUT element, and the Beam Descriptor field.

In process 3, the SBP responder (AP) performs sensing measurement of different frequency bands with the DMG sensing responder (STA3, the DMG device) and the sensing responder (STA4, the Sub-7 device) based on parameters set in the SBP Request frame and the SBP Response frame. The SBP responder (AP) acquires sensing reports of different frequency bands. The SBP responder (AP) transmits an SBP Report frame to the SBP initiator (STA1, the Sub-7 device) or the DMG SBP initiator (STA2, the DMG device).

In some embodiments, the SBP Report frame carries the Sensing Measurement Report Container field, the DMG Sensing Report Control element, and the DMG Sensing Report element.

In process 4, upon receiving the SBP Report frame, the SBP initiator (STA1, the Sub-7 device) or the DMG SBP initiator (STA2, the DMG device) determines whether to terminate the sensing based on the condition of the sensing report. The SBP initiator (STA1, the Sub-7 device) or the DMG SBP initiator (STA2, the DMG device) terminates the SBP process by transmitting an SBP Termination frame to the SBP responder (AP).

In some embodiments, the SBP Termination frame carries the Measurement Setup ID field, the DMG Measurement Setup ID field, the DMG SBP Termination Control field, and the DMG SBP Parameters element.

In summary, in a scenario in which the high-frequency band device requests the low-frequency band device to perform SBP, in a case where a sensing device of the same frequency band is lacking, the SBP service can be acquired as well. In a scenario in which the low-frequency band device requests the high-frequency band device to perform SBP, not only can the situation that the sensing device of the same frequency band is lacking be processed, but also a more refined sensing report can be acquired to meet the sensing requirement of high precision. In a scenario of simultaneously requesting SBP in devices of different frequency bands, the applicability of SBP can be further improved, and various frequency band devices in the environment can be fully utilized to acquire the sensing report.

### 4. Another Frame Format of a Low-Frequency Band Device and a High-Frequency Band Device

### 4.1 Low-Frequency Band Device

### 4.1.1 Another Frame Format of a Low-Frequency Band Device

In some other embodiments, in a case where the SBP Request frame is used to request the SBP responder to perform sensing measurement of the second frequency band in a proxy mode, the SBP Request frame includes an SBP Request frame corresponding to the second frequency band; the SBP Response frame includes an SBP Response frame corresponding to the second frequency band; the SBP Report frame includes an SBP Report frame corresponding to the second frequency band; and the SBP Termination frame includes an SBP Termination frame corresponding to the second frequency band.

In some embodiments, the Sub-7 device requests the SBP responder to perform DMG sensing measurement in a proxy mode by transmitting an SBP Request frame corresponding to the DMG device to the SBP responder, and accordingly, the SBP Response frame includes a DMG SBP Response frame; the SBP Report frame includes a DMG SBP Report frame; and the SBP Termination frame includes a DMG SBP Termination frame.

In some embodiments, at least one of a DMG SBP Request field, a DMG SBP Response field, a DMG SBP Report field, or a DMG SBP Termination field is added to the Public Action field of the Sub-7 device, such that at least one of the processes that the Sub-7 device transmits the DMG SBP Request frame, the SBP responder transmits the DMG SBP Response frame, the SBP responder transmits the DMG SBP Report frame, and the low-frequency band device transmits the DMG SBP Termination frame is realized.

In some embodiments, the field structure of the Public Action field of the Sub-7 device is illustrated in FIG. 28, and includes: a Sensing Measurement Setup Request field, a Sensing Measurement Setup Response field, a Sensing Measurement Report field, a Sensing Measurement Setup Termination field, an SBP Request field, an SBP Response field, an SBP Termination field, an SBP Report field, a DMG SBP Request field, a DMG SBP Response field, a DMG SBP Report field, and a DMG SBP Termination field which are sequentially arranged.

### 4.1.2 A Low-Frequency Band Device Requests to Perform SBP in a High-Frequency Band.

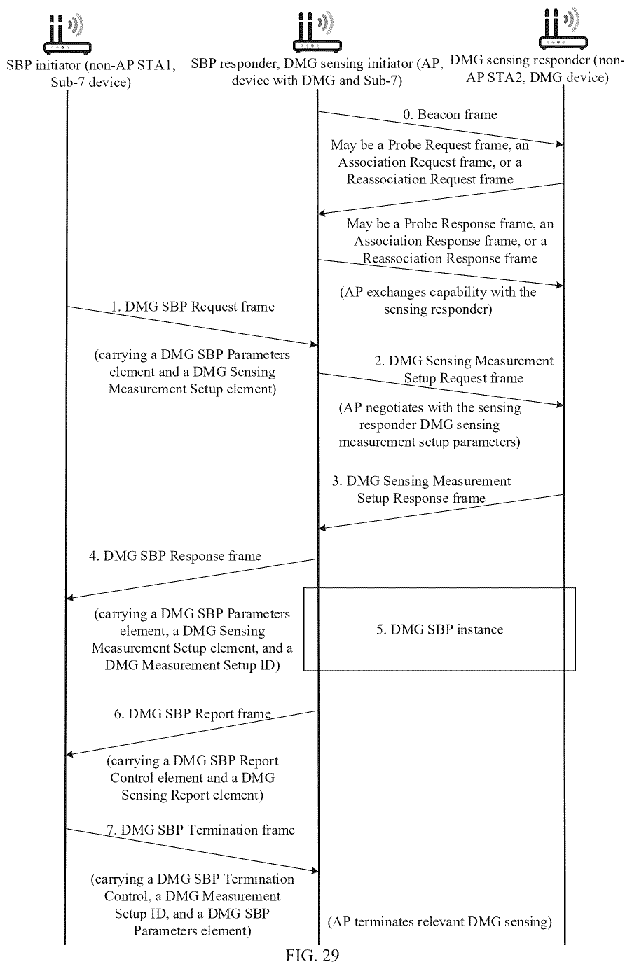

FIG. 29 is a flowchart in which a low-frequency band device requests to perform SBP in a high-frequency band according to some embodiments of the present disclosure.

FIG. 29 relates to an SBP initiator (STA1, a Sub-7 device), an SBP responder (AP, a device with both DMG and Sub-7 sensing capabilities), a DMG sensing initiator (AP), and a DMG sensing responder (STA2, a DMG device). The SBP responder is used to respond to an SBP request of the SBP initiator, and meanwhile acts as the DMG sensing initiator for initiating sensing.

The process in which the low-frequency band device requests to perform SBP in the high-frequency band is briefly described hereinafter.

In process 0, the DMG sensing initiator broadcasts a Beacon frame, and the sensing responder actively transmits a Probe Request frame, an Association Request frame, or a Reassociation Request frame to the DMG sensing initiator and receives the Probe Request frame, the Association Request frame, or the Reassociation Request frame returned by the DMG sensing initiator for exchanging sensing capability information of the DMG sensing initiator and the DMG sensing responder.

In process 1, the SBP initiator (STA1, the Sub-7 device) initiates a DMG SBP process by transmitting a DMG SBP Request frame to the SBP responder (AP).

In some embodiments, the DMG SBP Request frame carries at least one of a DMG SBP Parameters element, or a DMG Sensing Measurement Setup element.

In process 2, the SBP responder (AP) negotiates with the DMG sensing responder (STA2, the DMG device) operation parameters in a DMG sensing measurement process by transmitting a DMG Sensing Measurement Setup Request frame to the DMG sensing responder (STA2, the DMG device).

In process 3, the DMG sensing responder (STA2, the DMG device) indicates confirmation of establishing the DMG sensing measurement by transmitting a DMG Sensing Measurement Setup Response frame to the SBP responder (AP).

In process 4, the SBP responder (AP) indicates acceptance of the SBP task by transmitting a DMG SBP Response frame to the SBP initiator (STA1, the Sub-7 device).

In some embodiments, the DMG SBP Response frame carries at least one of the DMG SBP Parameters element, the DMG Sensing Measurement Setup element, or a DMG Measurement Setup ID field.

In process 5, the SBP responder (AP) and the DMG sensing responder (STA2, the DMG device) complete the DMG sensing measurement process based on the setting in the DMG SBP Request frame.

In process 6, the SBP responder (AP) notifies a DMG sensing measurement result by transmitting a DMG SBP Report frame to the SBP initiator (STA1, the Sub-7 device).

In some embodiments, the DMG SBP Report frame carries at least one of a DMG Sensing Report Control element, or a DMG Sensing Report element.

In process 7, the SBP initiator (STA1, the Sub-7 device) indicates termination of the related DMG sensing by transmitting a DMG SBP Termination frame to the SBP responder (AP).

In some embodiments, the DMG SBP Termination frame carries at least one of the DMG Measurement Setup ID field, or a DMG SBP Termination Control field.

### 4.2 High-Frequency Band Device

### 4.2.1 Another Frame Format of a High-Frequency Band Device

In some other embodiments, in a case where the SBP Request frame is used to request the SBP responder to perform sensing measurement of the second frequency band in a proxy mode, the SBP Request frame includes an SBP Request frame corresponding to the second frequency band; the SBP Response frame includes an SBP Response frame corresponding to the second frequency band; the SBP Report frame includes an SBP Report frame corresponding to the second frequency band; and the SBP Termination frame includes an SBP Termination frame corresponding to the second frequency band.

In some embodiments, the DMG device requests the SBP responder to perform Sub-7 sensing measurement in a proxy mode by transmitting an SBP Request frame corresponding to the Sub-7 device to the SBP responder, and accordingly, the SBP Response frame includes an SBP Response frame corresponding to the Sub-7 frequency band; the SBP Report frame includes an SBP Report frame corresponding to the Sub-7 frequency band; and the SBP Termination frame includes an SBP Termination frame corresponding to the Sub-7 frequency band.

In some embodiments, at least one of an SBP Request field, an SBP Response field, an SBP Report field, or an SBP Termination field is added to the Unprotected DMG Action field of the DMG device, such that at least one of the processes that the DMG device transmits the SBP Request frame of the Sub-7 frequency band, the SBP responder transmits the SBP Response frame of the Sub-7 frequency band, the SBP responder transmits the SBP Report frame of the Sub-7 frequency band, and the DMG device transmits the SBP Termination frame of the Sub-7 frequency band is realized.

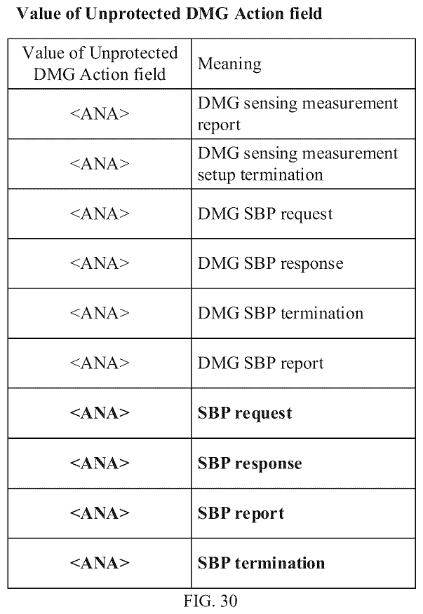

In some embodiments, the field structure of the Unprotected DMG Action field of the DMG device is illustrated in FIG. 30, and includes: a DMG Sensing Measurement Report field, a DMG Sensing Measurement Setup Termination field, a DMG SBP Request field, a DMG SBP Response field, a DMG SBP Termination field, a DMG SBP Report field, an SBP Request field, an SBP Response field, an SBP Report field, and an SBP Termination field which are sequentially arranged.

### 4.2.2 A High-Frequency Band Device Requests to Perform SBP in a Low-Frequency Band.

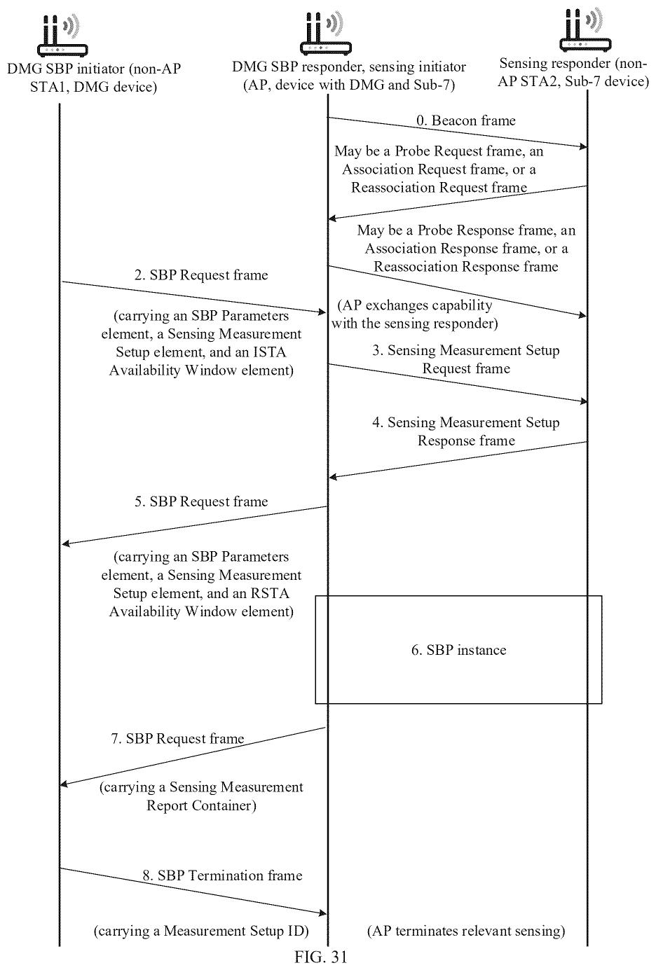

FIG. 31 is a flowchart in which a high-frequency band device requests to perform SBP in a low-frequency band according to some embodiments of the present disclosure.

FIG. 31 relates to a DMG SBP initiator (STA1, a DMG device), a DMG SBP responder (AP, a device with both DMG and Sub-7 sensing capabilities), a sensing initiator (AP), and a sensing responder (STA2, a Sub-7 device). The DMG SBP responder is used to respond to an SBP request of the DMG SBP initiator, and meanwhile acts as the sensing initiator for initiating sensing.

The process in which the high-frequency band device requests to perform SBP in the low-frequency band is briefly described hereinafter.

In process 0, the sensing initiator (AP) broadcasts a Beacon frame, and the sensing responder (STA2, the Sub-7 device) actively transmits a Probe Request frame, an Association Request frame, or a Reassociation Request frame to the sensing initiator and receives the Probe Request frame, the Association Request frame, or the Reassociation Request frame returned by the sensing initiator (AP) for exchanging sensing capability information of the sensing initiator and the sensing responder.

In process 1, the DMG SBP initiator (STA1, the DMG device) initiates a Sub-7 SBP process by transmitting an SBP Request frame to the DMG SBP responder (AP).

In some embodiments, the SBP Request frame carries at least one of an SBP Parameters element, a Sensing Measurement Parameters element, or an ISTA Availability Window element.

In process 2, the DMG SBP responder (AP) negotiates with the sensing responder (STA2, the Sub-7 device) the operation parameters in the Sub-7 sensing measurement process by transmitting a Sensing Measurement Setup Request frame to the sensing responder (STA2, the Sub-7 device).

In process 3, the sensing responder (STA2, the Sub-7 device) indicates confirmation of establishing the Sub-7 sensing measurement by transmitting the Sensing Measurement Setup Response frame to the DMG SBP responder (AP).

In process 4, the DMG SBP responder (AP) indicates acceptance of the SBP task by transmitting a DMG SBP Response frame to the DMG SBP initiator (STA1, the DMG device).

In some embodiments, the SBP Response frame carries at least one of the SBP Parameters element, the Sensing Measurement Parameters element, or an RSTA Availability Window element.

In process 5, the DMG SBP responder (AP) and the sensing responder (STA2, the Sub-7 device) complete the Sub-7 sensing measurement process based on the setting in the SBP Request frame.

In process 6, the DMG SBP responder (AP) notifies a Sub-7 sensing measurement result by transmitting an SBP Report frame to the DMG SBP initiator (STA1, the DMG device).

In some embodiments, the SBP Report frame carries a Sensing Measurement Report Container field.

In process 7, the DMG SBP initiator (STA1, the DMG device) indicates termination of the related Sub-7 sensing by transmitting an SBP Termination frame to the DMG SBP responder (AP).

In some embodiments, the SBP Termination frame carries a Measurement Setup ID field.

Through another frame format of the above embodiments, the designs of the SBP Request frame, the SBP Response frame, the SBP Report frame, and the SBP Termination frame, and the designs of the DMG SBP Request frame, the DMG SBP Response frame, the DMG SBP Report frame, and the DMG SBP Termination frame can be replaced respectively, thereby simplifying the processing flow.

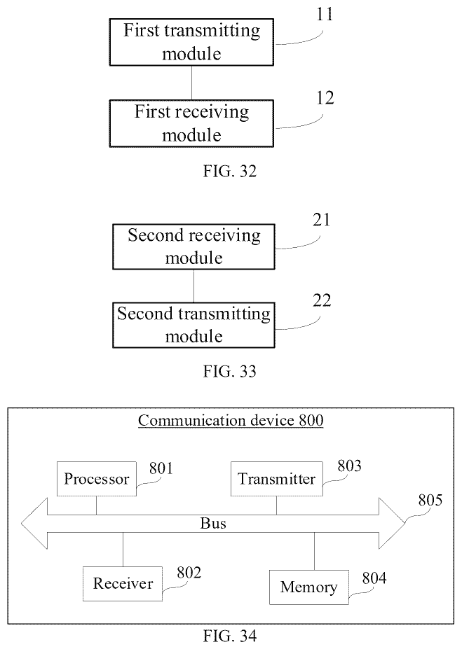

FIG. 32 is a structural block diagram of an apparatus for SBP according to some embodiments of the present disclosure. The apparatus includes: a first transmitting module 11 and a first receiving module 12.

The first transmitting module is configured to transmit an SBP Request frame to an SBP responder, wherein the SBP Request frame is used to request the SBP responder to perform sensing measurement of a second frequency band in a proxy mode, or request the SBP responder to perform sensing measurement of the first frequency band and the second frequency band in a proxy mode. The first receiving module 12 is configured to receive an SBP Response frame from the SBP responder, wherein the SBP responder is a device that supports both the first frequency band and the second frequency band.

The apparatus for SBP illustrated in FIG. 32 is applicable to the SBP initiator supporting the first frequency band.

In some embodiments, the SBP Request frame carries at least one of the following elements or fields: an SBP Type field; an SBP Parameters element corresponding to the first frequency band, wherein the SBP Parameters element indicates operation parameters of an SBP process; a Sensing Measurement Parameters element corresponding to the first frequency band, wherein Sensing Measurement Parameters element indicates operation parameters of a sensing measurement process; an ISTA Availability Window element, wherein the ISTA Availability Window element indicates when the SBP initiator is capable of receiving a sensing report and/or participating in a trigger frame-based sensing measurement instance; an SBP Parameters element corresponding to the second frequency band; or a Sensing Measurement Setup element corresponding to the second frequency band.

In some embodiments, in a case where the SBP Request frame is used to request the SBP responder to perform sensing measurement of the second frequency band in a proxy mode, the SBP Request frame carries at least one of the following elements or fields: the SBP Type field; the SBP Parameters element corresponding to the second frequency band; or the Sensing Measurement Setup element corresponding to the second frequency band.

In some embodiments, in a case where the SBP Request frame is used to request the SBP responder to perform sensing measurement of the first frequency band and the second frequency band in a proxy mode, the SBP Request frame carries at least one of the following elements or fields: the SBP Type field; the SBP Parameters element corresponding to the first frequency band; the Sensing Measurement Parameters element corresponding to the first frequency band; the ISTA Availability Window element; the SBP Parameters element corresponding to the second frequency band; or the Sensing Measurement Setup element corresponding to the second frequency band.

In some embodiments, in a case where the first frequency band is a Sub-7 frequency band, the SBP Request frame carries at least one of the following elements or fields: the SBP Type field; a Sub-7 Frequency Band SBP Parameters element; a Sub-7 Frequency Band Sensing Measurement Parameters element; the ISTA Availability Window element; a DMG Sensing Measurement Setup element; or a DMG SBP Parameters element.

In some embodiments, in a case where the first frequency band is the Sub-7 frequency band, and the SBP Request frame is used to request the SBP responder to perform sensing measurement of the second frequency band in a proxy mode, the SBP Request frame carries at least one of the following elements or fields: the SBP Type field; the DMG Sensing Measurement Setup element; or the DMG SBP Parameters element.

In some embodiments, in a case where the first frequency band is the Sub-7 frequency band, and the SBP Request frame is used to request the SBP responder to perform sensing measurement of the first frequency band and the second frequency band in a proxy mode, the SBP Request frame carries at least one of the following elements or fields: the SBP Type field; the DMG SBP Parameters element; the DMG Sensing Measurement Setup element; the Sub-7 Frequency Band SBP Parameters element; the Sub-7 Frequency Band Sensing Measurement Parameters element; or the ISTA Availability Window element.

In some embodiments, in a case where the first frequency band is a DMG frequency band, the SBP Request frame carries at least one of the following elements or fields: the SBP Type field; a DMG Sensing Measurement Setup element; a DMG SBP Parameters element; the ISTA Availability Window element; a Sub-7 Frequency Band SBP Parameters element; or a Sub-7 Frequency Band Sensing Measurement Parameters element.

In some embodiments, in a case where the first frequency band is the DMG frequency band, and the SBP Request frame is used to request the SBP responder to perform sensing measurement of the second frequency band in a proxy mode, the SBP Request frame carries at least one of the following elements or fields: the SBP Type field; the Sub-7 Frequency Band SBP Parameters element; the Sub-7 Frequency Band Sensing Measurement Parameters element; or the ISTA Availability Window element.

In some embodiments, in a case where the first frequency band is the DMG frequency band, and the SBP Request frame is used to request the SBP responder to perform sensing measurement of the first frequency band and the second frequency band in a proxy mode, the SBP Request frame carries at least one of the following elements or fields: the SBP Type field; the DMG Sensing Measurement Setup element; the DMG SBP Parameters element; the ISTA Availability Window element; the Sub-7 Frequency Band SBP Parameters element; or the Sub-7 Frequency Band Sensing Measurement Parameters element.

In some embodiments, the SBP Response frame carries at least one of the following elements or fields: an SBP Type field; an SBP Parameters element corresponding to the first frequency band; a Sensing Measurement Parameters element corresponding to the first frequency band; a Measurement Setup ID corresponding to the first frequency band, wherein the Measurement Setup ID identifies a sensing measurement process established by the SBP responder; an RSTA Availability Window element, wherein the RSTA Availability Window element indicates when the SBP responder is capable of transmitting a sensing report and/or participating in a frame-based sensing measurement instance; a Measurement Setup ID corresponding to the second frequency band; an SBP Parameters element corresponding to the second frequency band; a Sensing Measurement Setup element corresponding to the second frequency band; a Sensing Image Range Axis LUT element corresponding to the second frequency band; or a Sensing Image Doppler Axis LUT element corresponding to the second frequency band.

In some embodiments, in a case where the SBP Request frame is used to request the SBP responder to perform sensing measurement of the second frequency band in a proxy mode, the SBP Response frame carries at least one of the following elements or fields: the SBP Type field; the Measurement Setup ID corresponding to the second frequency band; the SBP Parameters element corresponding to the second frequency band; the Sensing Measurement Setup element corresponding to the second frequency band; the Sensing Image Range Axis LUT element corresponding to the second frequency band; or the Sensing Image Doppler Axis LUT element corresponding to the second frequency band.

In some embodiments, in a case where the SBP Request frame is used to request the SBP responder to perform sensing measurement of the first frequency band and the second frequency band in a proxy mode, the SBP Response frame carries at least one of the following elements or fields: the SBP Type field; the Measurement Setup ID corresponding to the first frequency band; the SBP Parameters element corresponding to the first frequency band; the Sensing Measurement Parameters element corresponding to the first frequency band; the RSTA Availability Window element; the Measurement Setup ID corresponding to the second frequency band; the SBP Parameters element corresponding to the second frequency band; the Sensing Measurement Setup element corresponding to the second frequency band; the Sensing Image Range Axis LUT element corresponding to the second frequency band; or the Sensing Image Doppler Axis LUT element corresponding to the second frequency band.

In some embodiments, in a case where the first frequency band is a Sub-7 frequency band, the SBP Response frame carries at least one of the following elements or fields: the SBP Type field; a Sub-7 Frequency Band Measurement Setup ID; a Sub-7 Frequency Band SBP Parameters element; a Sub-7 Frequency Band Sensing Measurement Parameters element; the RSTA Availability Window element; a DMG Measurement Setup ID; a DMG Sensing Measurement Setup element; a DMG SBP Parameters element; a DMG Sensing Image Range Axis LUT element; or a DMG Sensing Image Doppler Axis LUT element.

In some embodiments, in a case where the first frequency band is the Sub-7 frequency band, and the SBP Request frame is used to request the SBP responder to perform sensing measurement of the second frequency band in a proxy mode, the SBP Response frame carries at least one of the following elements or fields: the SBP Type field; the DMG Measurement Setup ID; the DMG Sensing Measurement Setup element; the DMG SBP Parameters element; the DMG Sensing Image Range Axis LUT element; or the DMG Sensing Image Doppler Axis LUT element.

In some embodiments, in a case where the first frequency band is the Sub-7 frequency band, and the SBP Request frame is used to request the SBP responder to perform sensing measurement of the first frequency band and the second frequency band in a proxy mode, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; the RSTA Availability Window element; the DMG Measurement Setup ID; the DMG Sensing Measurement Setup element; the DMG SBP Parameters element; the DMG Sensing Image Range Axis LUT element; or the DMG Sensing Image Doppler Axis LUT element.

In some embodiments, in a case where the first frequency band is a DMG frequency band, the SBP Response frame carries at least one of the following elements or fields: the SBP Type field; a Sub-7 Frequency Band Measurement Setup ID; a Sub-7 Frequency Band SBP Parameters element; a Sub-7 Frequency Band Sensing Measurement Parameters element; the RSTA Availability Window element; a DMG Measurement Setup ID; a DMG Sensing Measurement Setup element; a DMG SBP Parameters element; a DMG Sensing Image Range Axis LUT element; or a DMG Sensing Image Doppler Axis LUT element.

In some embodiments, in a case where the first frequency band is the DMG frequency band, and the SBP Request frame is used to request the SBP responder to perform sensing measurement of the second frequency band in a proxy mode, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; or the RSTA Availability Window element.

In some embodiments, in a case where the first frequency band is the DMG frequency band, and the SBP Request frame is used to request the SBP responder to perform sensing measurement of the first frequency band and the second frequency band in a proxy mode, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; the RSTA Availability Window element; the DMG Measurement Setup ID; the DMG Sensing Measurement Setup element; the DMG SBP Parameters element; the DMG Sensing Image Range Axis LUT element; or the DMG Sensing Image Doppler Axis LUT element.

In some embodiments, the first receiving module 12 is further configured to receive an SBP Report frame from the SBP responder.

In some embodiments, the SBP Report frame carries at least one of the following elements or fields: an SBP Type field; a Sensing Measurement Report Container corresponding to the first frequency band; a Sensing Report Control element corresponding to the second frequency band; or a Sensing Report element corresponding to the second frequency band.

In some embodiments, in a case where the SBP Request frame is used to request the SBP responder to perform sensing measurement of the second frequency band in a proxy mode, the SBP

Report frame carries at least one of the following elements or fields: the SBP Type field; the Sensing Report Control element corresponding to the second frequency band; or the Sensing Report element corresponding to the second frequency band.

In some embodiments, in a case where the SBP Request frame is used to request the SBP responder to perform sensing measurement of the first frequency band and the second frequency band in a proxy mode, the SBP Report frame carries at least one of the following elements or fields: the SBP Type field; the Sensing Measurement Report Container corresponding to the first frequency band; the Sensing Report Control element corresponding to the second frequency band; or the Sensing Report element corresponding to the second frequency band.

In some embodiments, in a case where the first frequency band is a Sub-7 frequency band, the SBP Report frame carries at least one of the following elements or fields: the SBP Type field; a Sensing Measurement Report Container corresponding to the Sub-7 frequency band; a DMG Sensing Report Control element; or a DMG Sensing Report element.

In some embodiments, in a case where the first frequency band is the Sub-7 frequency band, and the SBP Request frame is used to request the SBP responder to perform sensing measurement of the second frequency band in a proxy mode, the SBP Report frame carries at least one of the following elements or fields: the SBP Type field; the DMG Sensing Report Control element; or the DMG Sensing Report element.

In some embodiments, in a case where the first frequency band is the Sub-7 frequency band, and the SBP Request frame is used to request the SBP responder to perform sensing measurement of the first frequency band and the second frequency band in a proxy mode, the SBP Report frame carries at least one of the following elements or fields: the SBP Type field; the Sensing Measurement Report Container corresponding to the Sub-7 frequency band; the DMG Sensing Report Control element; or the DMG Sensing Report element.

In some embodiments, in a case where the first frequency band is a DMG frequency band, the SBP Report frame carries at least one of the following elements or fields: the SBP Type field; a Sensing Measurement Report Container corresponding to a Sub-7 frequency band; a DMG Sensing Report Control element; or a DMG Sensing Report element.

In some embodiments, in a case where the first frequency band is the DMG frequency band, and the SBP Request frame is used to request the SBP responder to perform sensing measurement of the second frequency band in a proxy mode, the SBP Report frame carries at least one of the following elements or fields: the SBP Type field; or the Sensing Measurement Report Container corresponding to the Sub-7 frequency band.

In some embodiments, in a case where the first frequency band is the DMG frequency band, and the SBP Request frame is used to request the SBP responder to perform sensing measurement of the first frequency band and the second frequency band in a proxy mode, the SBP Report frame carries at least one of the following elements or fields: the SBP Type field; the Sensing Measurement Report Container corresponding to the Sub-7 frequency band; the DMG Sensing Report Control element; or the DMG Sensing Report element.

In some embodiments, the first transmitting module is further configured to transmit an SBP Termination frame to the SBP responder.

In some embodiments, the SBP Termination frame carries at least one of the following elements or fields: an SBP Type field; a Measurement Setup ID corresponding to the first frequency band; a Measurement Setup ID corresponding to the second frequency band; an SBP Termination Control corresponding to the second frequency band; or an SBP Parameters element corresponding to the second frequency band.

In some embodiments, in a case where the SBP Termination frame is used to request the SBP responder to terminate the sensing measurement of the second frequency band in a proxy mode, the SBP Termination frame carries at least one of the following elements or fields: the SBP Type field; the Measurement Setup ID corresponding to the second frequency band; the SBP Termination Control corresponding to the second frequency band; or the SBP Parameters element corresponding to the second frequency band.

In some embodiments, in a case where the SBP Termination frame is used to request the SBP responder to terminate the sensing measurement of the first frequency band and the second frequency band in a proxy mode, the SBP Termination frame carries at least one of the following elements or fields: the SBP Type field; the Measurement Setup ID corresponding to the first frequency band; the Measurement Setup ID corresponding to the second frequency band; the SBP Termination Control corresponding to the second frequency band; or the SBP Parameters element corresponding to the second frequency band.

In some embodiments, in a case where the first frequency band is a Sub-7 frequency band, the SBP Termination frame carries at least one of the following elements or fields: the SBP Type field; a Sub-7 Frequency Band Measurement Setup ID; a DMG Measurement Setup ID; a DMG SBP Termination Control; or a DMG SBP Parameters element.

In some embodiments, in a case where the first frequency band is the Sub-7 frequency band, and the SBP Termination frame is used to request the SBP responder to terminate the sensing measurement of the second frequency band in a proxy mode, the SBP Termination frame carries at least one of the following elements or fields: the SBP Type field; the DMG Measurement Setup ID; the DMG SBP Termination Control; or the DMG SBP Parameters element.

In some embodiments, in a case where the first frequency band is the Sub-7 frequency band, and the SBP Termination frame is used to request the SBP responder to terminate the sensing measurement of the first frequency band and the second frequency band in a proxy mode, the SBP Termination frame carries at least one of the following elements or fields: the SBP Type field; the Sub-7 Frequency Band Measurement Setup ID; the DMG Measurement Setup ID; the DMG SBP Termination Control; or the DMG SBP Parameters element.

In some embodiments, in a case where the first frequency band is a DMG frequency band, the SBP Termination frame carries at least one of the following elements or fields: the SBP Type field; a Sub-7 Frequency Band Measurement Setup ID; a DMG Measurement Setup ID; a DMG SBP Termination control; or a DMG SBP Parameters element.

In some embodiments, in a case where the first frequency band is the DMG frequency band, and the SBP Termination frame is used to request the SBP responder to terminate the sensing measurement of the second frequency band in a proxy mode, the SBP Termination frame carries at least one of the following elements or fields: the SBP Type field; or the Sub-7 Frequency Band Measurement Setup ID.

In some embodiments, in a case where the first frequency band is the DMG frequency band, and the SBP Termination frame is used to request the SBP responder to terminate the sensing measurement of the first frequency band and the second frequency band in a proxy mode, the SBP Termination frame carries at least one of the following elements or fields: the SBP Type field; the Sub-7 Frequency Band Measurement Setup ID; the DMG Measurement Setup ID; the DMG SBP Termination Control; or the DMG SBP Parameters element.

In some embodiments, a value of an SBP Type field includes a first value, wherein the first value indicates that the SBP Request frame is used to request the SBP responder to perform sensing measurement of the second frequency band in a proxy mode.

In some embodiments, a value of an SBP Type field includes a second value, wherein the second value indicates that the SBP Request frame is used to request the SBP responder to perform sensing measurement of the first frequency band and the second frequency band in a proxy mode.

In some embodiments, a value of an SBP Type field includes a first value, wherein the first value indicates that the SBP Request frame is used to request the SBP responder to perform sensing measurement of the second frequency band in a proxy mode.

In some embodiments, a value of an SBP Type field includes a second value, wherein the second value indicates that the SBP Request frame is used to request the SBP responder to perform sensing measurement of the first frequency band and the second frequency band in a proxy mode.

In some embodiments, in a case where the SBP Request frame is used to request the SBP responder to perform sensing measurement of the second frequency band in a proxy mode, the SBP Request frame includes an SBP Request frame corresponding to the second frequency band.

In some embodiments, in a case where the SBP Request frame is used to request the SBP responder to perform sensing measurement of the second frequency band in a proxy mode, the SBP Response frame includes an SBP Response frame corresponding to the second frequency band.

In some embodiments, in a case where the SBP Request frame is used to request the SBP responder to perform sensing measurement of the second frequency band in a proxy mode, an SBP Report frame includes an SBP Report frame corresponding to the second frequency band.

In some embodiments, the first transmitting module 11 is implemented based on a transmitter in a communication device, the first receiving module 12 is implemented based on a receiver in the communication device, and the respective frames may be generated, processed, and parsed based on a processor in the communication device.

FIG. 33 is a structural block diagram of an apparatus for SBP according to some embodiments of the present disclosure. The apparatus includes: a second receiving module 21 and a second transmitting module 22.

The second receiving module 21 is configured to receive an SBP Request frame from an SBP initiator, wherein the SBP Request frame is used to request the SBP responder to perform sensing measurement of the second frequency band in a proxy mode, or request the SBP responder to perform sensing measurement of the first frequency band and the second frequency band in a proxy mode. The second transmitting module 22 is configured to transmit an SBP Response frame to the SBP initiator. The SBP initiator is a device that supports the first frequency band but does not support the second frequency band.

The apparatus for SBP illustrated in FIG. 25 is applicable to the SBP responder supporting the first frequency band and the second frequency band.

In some embodiments, the SBP Request frame carries at least one of the following elements or fields: an SBP Type field; an SBP Parameters element corresponding to the first frequency band, wherein the SBP Parameters element indicates operation parameters of an SBP process; a Sensing Measurement Parameters element corresponding to the first frequency band, wherein the Sensing Measurement Parameters element indicates operation parameters of a sensing measurement process; an ISTA Availability Window element, wherein the ISTA Availability Window element indicates when the SBP initiator is capable of receiving a sensing report and/or participating in a trigger frame-based sensing measurement instance; an SBP Parameters element corresponding to the second frequency band; or a Sensing Measurement Setup element corresponding to the second frequency band.

In some embodiments, in a case where the SBP Request frame is used to request the SBP responder to perform sensing measurement of the second frequency band in a proxy mode, the SBP Request frame carries at least one of the following elements or fields: the SBP Type field; the SBP Parameters element corresponding to the second frequency band; or the Sensing Measurement Setup element corresponding to the second frequency band.

In some embodiments, in a case where the SBP Request frame is used to request the SBP responder to perform sensing measurement of the first frequency band and the second frequency band in a proxy mode, the SBP Request frame carries at least one of the following elements or fields: the SBP Type field; the SBP Parameters element corresponding to the first frequency band; the Sensing Measurement Parameters element corresponding to the first frequency band; the ISTA Availability Window element; the SBP Parameters element corresponding to the second frequency band; or the Sensing Measurement Setup element corresponding to the second frequency band.

In some embodiments, in a case where the first frequency band is a Sub-7 frequency band, the SBP Request frame carries at least one of the following elements or fields: the SBP Type field; a Sub-7 Frequency Band SBP Parameters element; a Sub-7 Frequency Band Sensing Measurement Parameters element; the ISTA Availability Window element; a DMG Sensing Measurement Setup element; or a DMG SBP Parameters element.

In some embodiments, in a case where the first frequency band is the Sub-7 frequency band, and the SBP Request frame is used to request the SBP responder to perform sensing measurement of the second frequency band in a proxy mode, the SBP Request frame carries at least one of the following elements or fields: the SBP Type field; the DMG Sensing Measurement Setup element; or the DMG SBP Parameters element.

In some embodiments, in a case where the first frequency band is the Sub-7 frequency band, and the SBP Request frame is used to request the SBP responder to perform sensing measurement of the first frequency band and the second frequency band in a proxy mode, the SBP Request frame carries at least one of the following elements or fields: the SBP Type field; the DMG SBP Parameters element; the DMG Sensing Measurement Setup element; the Sub-7 Frequency Band SBP Parameters element; the Sub-7 Frequency Band Sensing Measurement Parameters element; or the ISTA Availability Window element.

In some embodiments, in a case where the first frequency band is a DMG frequency band, the SBP Request frame carries at least one of the following elements or fields: the SBP Type field; a DMG Sensing Measurement Setup element; a DMG SBP Parameters element; the ISTA Availability Window element; a Sub-7 Frequency Band SBP Parameters element; or a Sub-7 Frequency Band Sensing Measurement Parameters element.

In some embodiments, in a case where the first frequency band is the DMG frequency band, and the SBP Request frame is used to request the SBP responder to perform sensing measurement of the second frequency band in a proxy mode, the SBP Request frame carries at least one of the following elements or fields: the SBP Type field; the Sub-7 Frequency Band SBP Parameters element; the Sub-7 Frequency Band Sensing Measurement Parameters element; or the ISTA Availability Window element.

In some embodiments, in a case where the first frequency band is the DMG frequency band, and the SBP Request frame is used to request the SBP responder to perform sensing measurement of the first frequency band and the second frequency band in a proxy mode, the SBP Request frame carries at least one of the following elements or fields: the SBP Type field; the DMG Sensing Measurement Setup element; the DMG SBP Parameters element; the ISTA Availability Window element; the Sub-7 Frequency Band SBP Parameters element; or the Sub-7 Frequency Band Sensing Measurement Parameters element.

In some embodiments, the SBP Response frame carries at least one of the following elements or fields: an SBP Type field; an SBP Parameters element corresponding to the first frequency band; a Sensing Measurement Parameters element corresponding to the first frequency band; a Measurement Setup ID corresponding to the first frequency band, wherein the Measurement Setup ID identifies a sensing measurement process established by the SBP responder; an RSTA Availability Window element, wherein the RSTA Availability Window element indicates when the SBP responder is capable of transmitting a sensing report and/or participating in a frame-based sensing measurement instance; a Measurement Setup ID corresponding to the second frequency band; an SBP Parameters element corresponding to the second frequency band; a Sensing Measurement Setup element corresponding to the second frequency band; a Sensing Image Range Axis LUT element corresponding to the second frequency band; or a Sensing Image Doppler Axis LUT element corresponding to the second frequency band.

In some embodiments, in a case where the SBP Request frame is used to request the SBP responder to perform sensing measurement of the second frequency band in a proxy mode, the SBP Response frame carries at least one of the following elements or fields: the SBP Type field; the Measurement Setup ID corresponding to the second frequency band; the SBP Parameters element corresponding to the second frequency band; the Sensing Measurement Setup element corresponding to the second frequency band; the Sensing Image Range Axis LUT element corresponding to the second frequency band; or the Sensing Image Doppler Axis LUT element corresponding to the second frequency band.

In some embodiments, in a case where the SBP Request frame is used to request the SBP responder to perform sensing measurement of the first frequency band and the second frequency band in a proxy mode, the SBP Response frame carries at least one of the following elements or fields: the SBP Type field; the Measurement Setup ID corresponding to the first frequency band; the SBP Parameters element corresponding to the first frequency band; the Sensing Measurement Parameters element corresponding to the first frequency band; the RSTA Availability Window element; the Measurement Setup ID corresponding to the second frequency band; the SBP Parameters element corresponding to the second frequency band; the Sensing Measurement Setup element corresponding to the second frequency band; the Sensing Image Range Axis LUT element corresponding to the second frequency band; or the Sensing Image Doppler Axis LUT element corresponding to the second frequency band.

In some embodiments, in a case where the first frequency band is a Sub-7 frequency band, the SBP Response frame carries at least one of the following elements or fields: the SBP Type field; a Sub-7 Frequency Band Measurement Setup ID; a Sub-7 Frequency Band SBP Parameters element; a Sub-7 Frequency Band Sensing Measurement Parameters element; the RSTA Availability Window element; a DMG Measurement Setup ID; a DMG Sensing Measurement Setup element; a DMG SBP Parameters element; a DMG Sensing Image Range Axis LUT element; or a DMG Sensing Image Doppler Axis LUT element.

In some embodiments, in a case where the first frequency band is the Sub-7 frequency band, and the SBP Request frame is used to request the SBP responder to perform sensing measurement of the second frequency band in a proxy mode, the SBP Response frame carries at least one of the following elements or fields: the SBP Type field; the DMG Measurement Setup ID; the DMG Sensing Measurement Setup element; the DMG SBP Parameters element; the DMG Sensing Image Range Axis LUT element; or the DMG Sensing Image Doppler Axis LUT element.

In some embodiments, in a case where the first frequency band is the Sub-7 frequency band, and the SBP Request frame is used to request the SBP responder to perform sensing measurement of the first frequency band and the second frequency band in a proxy mode, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; the RSTA Availability Window element; the DMG Measurement Setup ID; the DMG Sensing Measurement Setup element; the DMG SBP Parameters element; the DMG Sensing Image Range Axis LUT element; or the DMG Sensing Image Doppler Axis LUT element.

In some embodiments, in a case where the first frequency band is a DMG frequency band, the SBP Response frame carries at least one of the following elements or fields: the SBP Type field; a Sub-7 Frequency Band Measurement Setup ID; a Sub-7 Frequency Band SBP Parameters element; a Sub-7 Frequency Band Sensing Measurement Parameters element; the RSTA Availability Window element; a DMG Measurement Setup ID; a DMG Sensing Measurement Setup element; a DMG SBP Parameters element; a DMG Sensing Image Range Axis LUT element; or a DMG Sensing Image Doppler Axis LUT element.

In some embodiments, in a case where the first frequency band is the DMG frequency band, and the SBP Request frame is used to request the SBP responder to perform sensing measurement of the second frequency band in a proxy mode, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; or the RSTA Availability Window element.

In some embodiments, in a case where the first frequency band is the DMG frequency band, and the SBP Request frame is used to request the SBP responder to perform sensing measurement of the first frequency band and the second frequency band in a proxy mode, the SBP Response frame carries at least one of the following elements or fields: the SBP Type field; the Sub-7 Frequency Band Measurement Setup ID; the Sub-7 Frequency Band SBP Parameters element; the Sub-7 Frequency Band Sensing Measurement Parameters element; the RSTA Availability Window element; the DMG Measurement Setup ID; the DMG Sensing Measurement Setup element; the DMG SBP Parameters element; the DMG Sensing Image Range Axis LUT element; or the DMG Sensing Image Doppler Axis LUT element.

In some embodiments, the second transmitting module 22 is further configured to receive an SBP Report frame from the SBP responder.

In some embodiments, the SBP Report frame carries at least one of the following elements or fields: an SBP Type field; a Sensing Measurement Report Container corresponding to the first frequency band; a Sensing Report Control element corresponding to the second frequency band; or a Sensing Report element corresponding to the second frequency band.

In some embodiments, in a case where the SBP Request frame is used to request the SBP responder to perform sensing measurement of the second frequency band in a proxy mode, the SBP Report frame carries at least one of the following elements or fields: the SBP Type field; the Sensing Report Control element corresponding to the second frequency band; or the Sensing Report element corresponding to the second frequency band.

In some embodiments, in a case where the SBP Request frame is used to request the SBP responder to perform sensing measurement of the first frequency band and the second frequency band in a proxy mode, the SBP Report frame carries at least one of the following elements or fields: the SBP Type field; the Sensing Measurement Report Container corresponding to the first frequency band; the Sensing Report Control element corresponding to the second frequency band; or the Sensing Report element corresponding to the second frequency band.

In some embodiments, in a case where the first frequency band is a Sub-7 frequency band, the SBP Report frame carries at least one of the following elements or fields: the SBP Type field; a Sensing Measurement Report Container corresponding to the Sub-7 frequency band; a DMG Sensing Report Control element; or a DMG Sensing Report element.

In some embodiments, in a case where the first frequency band is the Sub-7 frequency band, and the SBP Request frame is used to request the SBP responder to perform sensing measurement of the second frequency band in a proxy mode, the SBP Report frame carries at least one of the following elements or fields: the SBP Type field; the DMG Sensing Report Control element; or the DMG Sensing Report element.

In some embodiments, in a case where the first frequency band is the Sub-7 frequency band, and the SBP Request frame is used to request the SBP responder to perform sensing measurement of the first frequency band and the second frequency band in a proxy mode, the SBP Report frame carries at least one of the following elements or fields: the SBP Type field; the Sensing Measurement Report Container corresponding to the Sub-7 frequency band; the DMG Sensing Report Control element; or the DMG Sensing Report element.

In some embodiments, in a case where the first frequency band is a DMG frequency band, the SBP Report frame carries at least one of the following elements or fields: the SBP Type field; a

Sensing Measurement Report Container corresponding to a Sub-7 frequency band; a DMG Sensing Report Control element; or a DMG Sensing Report element.

In some embodiments, in a case where the first frequency band is the DMG frequency band, and the SBP Request frame is used to request the SBP responder to perform sensing measurement of the second frequency band in a proxy mode, the SBP Report frame carries at least one of the following elements or fields: the SBP Type field; or the Sensing Measurement Report Container corresponding to the Sub-7 frequency band.

In some embodiments, in a case where the first frequency band is the DMG frequency band, and the SBP Request frame is used to request the SBP responder to perform sensing measurement of the first frequency band and the second frequency band in a proxy mode, the SBP Report frame carries at least one of the following elements or fields: the SBP Type field; the Sensing Measurement Report Container corresponding to the Sub-7 frequency band; the DMG Sensing Report Control element; or the DMG Sensing Report element.

In some embodiments, the second receiving module is further configured to transmit an SBP Termination frame to the SBP responder.

In some embodiments, the SBP Termination frame carries at least one of the following elements or fields: an SBP Type field; a Measurement Setup ID corresponding to the first frequency band; a Measurement Setup ID corresponding to the second frequency band; an SBP Termination Control corresponding to the second frequency band; or the SBP Parameters element corresponding to the second frequency band.

In some embodiments, in a case where the SBP Termination frame is used to request the SBP responder to terminate the sensing measurement of the second frequency band in a proxy mode, the SBP Termination frame carries at least one of the following elements or fields: the SBP Type field; the Measurement Setup ID corresponding to the second frequency band; the SBP Termination Control corresponding to the second frequency band; or the SBP Parameters element corresponding to the second frequency band.

In some embodiments, in a case where the SBP Termination frame is used to request the SBP responder to terminate the sensing measurement of the first frequency band and the second frequency band in a proxy mode, the SBP Termination frame carries at least one of the following elements or fields: the SBP Type field; the Measurement Setup ID corresponding to the first frequency band; the Measurement Setup ID corresponding to the second frequency band; the SBP Termination Control corresponding to the second frequency band; or the SBP Parameters element corresponding to the second frequency band.

In some embodiments, in a case where the first frequency band is a Sub-7 frequency band, the SBP Termination frame carries at least one of the following elements or fields: the SBP Type field; a Sub-7 Frequency Band Measurement Setup ID; a DMG Measurement Setup ID; a DMG SBP Termination Control; or the DMG SBP Parameters element.

In some embodiments, in a case where the first frequency band is the Sub-7 frequency band, and the SBP Termination frame is used to request the SBP responder to terminate the sensing measurement of the second frequency band in a proxy mode, the SBP Termination frame carries at least one of the following elements or fields: the SBP Type field; the DMG Measurement Setup ID; the DMG SBP Termination Control; or the DMG SBP Parameters element.

In some embodiments, in a case where the first frequency band is the Sub-7 frequency band, and the SBP Termination frame is used to request the SBP responder to terminate the sensing measurement of the first frequency band and the second frequency band in a proxy mode, the SBP Termination frame carries at least one of the following elements or fields: the SBP Type field; the Sub-7 Frequency Band Measurement Setup ID; the DMG Measurement Setup ID; the DMG SBP Termination Control; or the DMG SBP Parameters element.

In some embodiments, in a case where the first frequency band is a DMG frequency band, the SBP Termination frame carries at least one of the following elements or fields: the SBP Type field; a Sub-7 Frequency Band Measurement Setup ID; a DMG Measurement Setup ID; a DMG SBP Termination Control; or a DMG SBP Parameters element.

In some embodiments, in a case where the first frequency band is the DMG frequency band, and the SBP Termination frame is used to request the SBP responder to terminate the sensing measurement of the second frequency band in a proxy mode, the SBP Termination frame carries at least one of the following elements or fields: the SBP Type field; or the Sub-7 Frequency Band Measurement Setup ID.

In some embodiments, in a case where the first frequency band is the DMG frequency band, and the SBP Termination frame is used to request the SBP responder to terminate the sensing measurement of the first frequency band and the second frequency band in a proxy mode, the SBP Termination frame carries at least one of the following elements or fields: the SBP Type field; the Sub-7 Frequency Band Measurement Setup ID; the DMG Measurement Setup ID; the DMG SBP Termination Control; or the DMG SBP Parameters element.

In some embodiments, a value of an SBP Type field includes a first value, wherein the first value indicates that the SBP Request frame is used to request the SBP responder to perform sensing measurement of the second frequency band in a proxy mode.

In some embodiments, a value of an SBP Type field includes a second value, wherein the second value indicates that the SBP Request frame is used to request the SBP responder to perform sensing measurement of the first frequency band and the second frequency band in a proxy mode.

In some embodiments, in a case where the SBP Request frame is used to request the SBP responder to perform sensing measurement of the second frequency band in a proxy mode, the SBP Request frame includes an SBP Request frame corresponding to the second frequency band.

In some embodiments, in a case where the SBP Request frame is used to request the SBP responder to perform sensing measurement of the second frequency band in a proxy mode, the SBP Response frame includes an SBP Response frame corresponding to the second frequency band.

In some embodiments, in a case where the SBP Request frame is used to request the SBP responder to perform sensing measurement of the second frequency band in a proxy mode, an SBP Report frame includes an SBP Report frame corresponding to the second frequency band.

In some embodiments, the second transmitting module 22 is implemented based on a transmitter in a communication device, the second receiving module 21 is implemented based on a receiver in the communication device, and the respective frames may be generated, processed, and parsed based on a processor in the communication device.

FIG. 34 is a structural block diagram of a communication device according to some embodiments of the present disclosure. The communication device may be at least one of an AP, an STA, an SBP initiator, an SBP responder, a sensing initiator, a sensing responder, a DMG SBP initiator, a DMG sensing responder, a DMG sensing initiator, or a DMG sensing responder.

In some embodiments, the communication device 800 includes a processor 801, a receiver 802, a transmitter 803, a memory 804, and a bus 805.

The processor 801 includes one or more processing cores, and the processor 801 executes various functional applications and performs information processing by running software programs and modules.

The processor 801 may implement the processes of the method for SBP in the above embodiments, such as generating an SBP Request frame, an SBP Response frame, an SBP Report frame, an SBP Termination frame, or the like.

The receiver 802 and the transmitter 803 may be implemented as one communication assembly, wherein the communication assembly may be a communication chip.

The receiver 802 may implement each transmitting process of the method for SBP in the above embodiments, and the transmitter 803 may implement each receiving process of the method for SBP in the above embodiments.

The memory 804 is connected to the processor 801 over the bus 805. The memory 804 is configured to store at least one executable instruction, and the processor 801 is configured to execute the at least one executable instruction to perform the processes in the above method embodiments.

In addition, the memory 804 may be implemented by any type or combination of volatile or non-volatile storage devices including, but not limited to: a magnetic or optical disk, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

Those skilled in the art should understand that the structure illustrated in FIG. 29 does not limit the communication device 800, and the communication device may include more or fewer components than those illustrated, or some of the components may be combined, or a different arrangement of components may be employed.

In some embodiments, the embodiments of the present disclosure further provide a computer-readable storage medium. The computer-readable storage medium stores one or more executable instructions. The one or more executable instructions, when loaded and executed by a processor, cause a communication device to perform the method for SBP as described above.

In some embodiments, the embodiments of the present disclosure further provide a chip. The chip includes one or more programmable logic circuits or one or more programs. The chip is configured to, based on the one or more programmable logic circuits or the one or more programs, cause a communication device to perform the method for SBP as described above.

In some embodiments, the embodiments of the present disclosure further provide a computer program product. The computer program product includes one or more computer instructions stored in a computer-readable storage medium. The one or more computer instructions, when read by a processor of a communication device from the computer-readable storage medium and executed by the processor, cause the communication device to perform the method for SBP as described above.

Those skilled in the art should recognize that in the one or more examples described above, the functions described in the embodiments of the present disclosure may be implemented using hardware, software, firmware, or any combination thereof. The functions, when implemented using software, are stored in a computer-readable medium or transmitted as one or more instructions or codes on the computer-readable medium. The computer-readable medium includes a computer storage medium and a communication medium, wherein the communication medium includes any medium that facilitates the transfer of a computer program from one place to another. The storage medium is any available medium that is accessible by a general-purpose or special-purpose computer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described above are merely optional embodiments of the present disclosure and are not intended to limit the present disclosure. Any modifications, equivalent substitutions, improvements, and the like, made within the spirit and principle of the present disclosure should fall within the protection scope of the present disclosure.

1. A method for sensing by proxy (SBP), applicable to an SBP initiator supporting a first frequency band, the method comprising:
transmitting an SBP Request frame to an SBP responder, wherein the SBP Request frame is used to request the SBP responder to perform sensing measurement of a second frequency band in a proxy mode, or request the SBP responder to perform sensing measurement of the first frequency band and the second frequency band in a proxy mode; and
receiving an SBP Response frame from the SBP responder,
wherein the SBP responder is a device that supports both the first frequency band and the second frequency band.

2. The method according to claim 1, wherein the SBP Request frame carries at least one of the following elements or fields:
an SBP Type field;
an SBP Parameters element corresponding to the first frequency band, wherein the SBP Parameters element indicates operation parameters of an SBP process;
a Sensing Measurement Parameters element corresponding to the first frequency band, wherein Sensing Measurement Parameters element indicates operation parameters of a sensing measurement process;
an ISTA Availability Window element, wherein the ISTA Availability Window element indicates when the SBP initiator is capable of receiving a sensing report and/or participating in a trigger frame-based sensing measurement instance;
an SBP Parameters element corresponding to the second frequency band; or
a Sensing Measurement Setup element corresponding to the second frequency band.

3. The method according to claim 2, wherein in a case where the SBP Request frame is used to request the SBP responder to perform sensing measurement of the second frequency band in a proxy mode, the SBP Request frame carries at least one of the following elements or fields:
the SBP Type field;
the SBP Parameters element corresponding to the second frequency band; or
the Sensing Measurement Setup element corresponding to the second frequency band;
or
in a case where the SBP Request frame is used to request the SBP responder to perform sensing measurement of the first frequency band and the second frequency band in a proxy mode, the SBP Request frame carries at least one of the following elements or fields:
the SBP Type field;
the SBP Parameters element corresponding to the first frequency band;
the Sensing Measurement Parameters element corresponding to the first frequency band;
the ISTA Availability Window element;
the SBP Parameters element corresponding to the second frequency band; or
the Sensing Measurement Setup element corresponding to the second frequency band.

4. The method according to claim 2, wherein in a case where the first frequency band is a Sub-7 frequency band, the SBP Request frame carries at least one of the following elements or fields:
the SBP Type field;
a Sub-7 Frequency Band SBP Parameters element;
a Sub-7 Frequency Band Sensing Measurement Parameters element;
the ISTA Availability Window element;
a Directional Multi-Gigabit (DMG) Sensing Measurement Setup element; or
a DMG SBP Parameters element.

5. The method according to claim 4, wherein in a case where the first frequency band is the Sub-7 frequency band, and the SBP Request frame is used to request the SBP responder to perform sensing measurement of the second frequency band in a proxy mode, the SBP Request frame carries at least one of the following elements or fields:
the SBP Type field;
the DMG Sensing Measurement Setup element; or
the DMG SBP Parameters element;
or
in a case where the first frequency band is the Sub-7 frequency band, and the SBP Request frame is used to request the SBP responder to perform sensing measurement of the first frequency band and the second frequency band in a proxy mode, the SBP Request frame carries at least one of the following elements or fields:
the SBP Type field;
the DMG SBP Parameters element;
the DMG Sensing Measurement Setup element;
the Sub-7 Frequency Band SBP Parameters element;
the Sub-7 Frequency Band Sensing Measurement Parameters element; or the ISTA Availability Window element.

6. The method according to claim 2, wherein in a case where the first frequency band is a Directional Multi-Gigabit (DMG) frequency band, the SBP Request frame carries at least one of the following elements or fields:
the SBP Type field;
a DMG Sensing Measurement Setup element;
a DMG SBP Parameters element;
the ISTA Availability Window element;
a Sub-7 Frequency Band SBP Parameters element; or
a Sub-7 Frequency Band Sensing Measurement Parameters element.

7. The method according to claim 6, wherein in a case where the first frequency band is the DMG frequency band, and the SBP Request frame is used to request the SBP responder to perform sensing measurement of the second frequency band in a proxy mode, the SBP Request frame carries at least one of the following elements or fields:
the SBP Type field;
the Sub-7 Frequency Band SBP Parameters element;
the Sub-7 Frequency Band Sensing Measurement Parameters element; or
the ISTA Availability Window element;
or
in a case where the first frequency band is the DMG frequency band, and the SBP Request frame is used to request the SBP responder to perform sensing measurement of the first frequency band and the second frequency band in a proxy mode, the SBP Request frame carries at least one of the following elements or fields:
the SBP Type field;
the DMG Sensing Measurement Setup element;
the DMG SBP Parameters element;
the ISTA Availability Window element;
the Sub-7 Frequency Band SBP Parameters element; or
the Sub-7 Frequency Band Sensing Measurement Parameters element.

8. A communication device, applicable to a sensing by proxy (SBP) initiator supporting a first frequency band, the communication device comprising:
a processor;
a memory, configured to store one or more executable instructions of the processor,
wherein the processor is configured to load the one or more executable instructions to cause the communication device to:
transmit an SBP Request frame to an SBP responder, wherein the SBP Request frame is used to request the SBP responder to perform sensing measurement of a second frequency band in a proxy mode, or request the SBP responder to perform sensing measurement of the first frequency band and the second frequency band in a proxy mode; and
receive an SBP Response frame from the SBP responder,
wherein the SBP responder is a device that supports both the first frequency band and the second frequency band.

9. The communication device according to claim 8, wherein the SBP Response frame carries at least one of the following elements or fields:
an SBP Type field;
an SBP Parameters element corresponding to the first frequency band;
a Sensing Measurement Parameters element corresponding to the first frequency band;
a Measurement Setup Identifier (ID) corresponding to the first frequency band, wherein the Measurement Setup ID identifies a sensing measurement process established by the SBP responder;
an RSTA Availability Window element, wherein the RSTA Availability Window element indicates when the SBP responder is capable of transmitting a sensing report and/or participating in a frame-based sensing measurement instance;
a Measurement Setup ID corresponding to the second frequency band;
an SBP Parameters element corresponding to the second frequency band;
a Sensing Measurement Setup element corresponding to the second frequency band;
a Sensing Image Range Axis Look-Up Table (LUT) element corresponding to the second frequency band; or
a Sensing Image Doppler Axis LUT element corresponding to the second frequency band.

10. The communication device according to claim 9, wherein in a case where the SBP Request frame is used to request the SBP responder to perform sensing measurement of the second frequency band in a proxy mode, the SBP Response frame carries at least one of the following elements or fields:
the SBP Type field;
the Measurement Setup ID corresponding to the second frequency band;
the SBP Parameters element corresponding to the second frequency band;
the Sensing Measurement Setup element corresponding to the second frequency band;
the Sensing Image Range Axis LUT element corresponding to the second frequency band; or
the Sensing Image Doppler Axis LUT element corresponding to the second frequency band;
or
in a case where the SBP Request frame is used to request the SBP responder to perform sensing measurement of the first frequency band and the second frequency band in a proxy mode, the SBP Response frame carries at least one of the following elements or fields:
the SBP Type field;
the Measurement Setup ID corresponding to the first frequency band;
the SBP Parameters element corresponding to the first frequency band;
the Sensing Measurement Parameters element corresponding to the first frequency band;
the RSTA Availability Window element;
the Measurement Setup ID corresponding to the second frequency band;
the SBP Parameters element corresponding to the second frequency band;
the Sensing Measurement Setup element corresponding to the second frequency band;
the Sensing Image Range Axis LUT element corresponding to the second frequency band; or
the Sensing Image Doppler Axis LUT element corresponding to the second frequency band.

11. The communication device according to claim 9, wherein in a case where the first frequency band is a Sub-7 frequency band, the SBP Response frame carries at least one of the following elements or fields:
the SBP Type field;
a Sub-7 Frequency Band Measurement Setup ID;
a Sub-7 Frequency Band SBP Parameters element;
a Sub-7 Frequency Band Sensing Measurement Parameters element;
the RSTA Availability Window element;
a Directional Multi-Gigabit (DMG) Measurement Setup ID;
a DMG Sensing Measurement Setup element;
a DMG SBP Parameters element;
a DMG Sensing Image Range Axis LUT element; or
a DMG Sensing Image Doppler Axis LUT element.

12. The communication device according to claim 11, wherein in a case where the first frequency band is the Sub-7 frequency band, and the SBP Request frame is used to request the SBP responder to perform sensing measurement of the second frequency band in a proxy mode, the SBP Response frame carries at least one of the following elements or fields:
the SBP Type field;
the DMG Measurement Setup ID;
the DMG Sensing Measurement Setup element;
the DMG SBP Parameters element;
the DMG Sensing Image Range Axis LUT element; or
the DMG Sensing Image Doppler Axis LUT element;
or
in a case where the first frequency band is the Sub-7 frequency band, and the SBP Request frame is used to request the SBP responder to perform sensing measurement of the first frequency band and the second frequency band in a proxy mode, the SBP Response frame carries at least one of the following elements or fields:
the SBP Type field;
the Sub-7 Frequency Band Measurement Setup ID;
the Sub-7 Frequency Band SBP Parameters element;
the Sub-7 Frequency Band Sensing Measurement Parameters element;
the RSTA Availability Window element;
the DMG Measurement Setup ID;
the DMG Sensing Measurement Setup element;
the DMG SBP Parameters element;
the DMG Sensing Image Range Axis LUT element; or
the DMG Sensing Image Doppler Axis LUT element.

13. The communication device according to claim 9, wherein in a case where the first frequency band is a Directional Multi-Gigabit (DMG) frequency band, the SBP Response frame carries at least one of the following elements or fields:
the SBP Type field;
a Sub-7 Frequency Band Measurement Setup ID;
a Sub-7 Frequency Band SBP Parameters element;
a Sub-7 Frequency Band Sensing Measurement Parameters element;
the RSTA Availability Window element;
a DMG Measurement Setup ID;
a DMG Sensing Measurement Setup element;
a DMG SBP Parameters element;
a DMG Sensing Image Range Axis LUT element; or
a DMG Sensing Image Doppler Axis LUT element.

14. The communication device according to claim 13, wherein in a case where the first frequency band is the DMG frequency band, and the SBP Request frame is used to request the SBP responder to perform sensing measurement of the second frequency band in a proxy mode, the SBP Response frame carries at least one of the following elements or fields:
the SBP Type field;
the Sub-7 Frequency Band Measurement Setup ID;
the Sub-7 Frequency Band SBP Parameters element;
the Sub-7 Frequency Band Sensing Measurement Parameters element; or
the RSTA Availability Window element;
or
in a case where the first frequency band is the DMG frequency band, and the SBP Request frame is used to request the SBP responder to perform sensing measurement of the first frequency band and the second frequency band in a proxy mode, the SBP Response frame carries at least one of the following elements or fields:
the SBP Type field;
the Sub-7 Frequency Band Measurement Setup ID;
the Sub-7 Frequency Band SBP Parameters element;
the Sub-7 Frequency Band Sensing Measurement Parameters element;
the RSTA Availability Window element;
the DMG Measurement Setup ID;
the DMG Sensing Measurement Setup element;
the DMG SBP Parameters element;
the DMG Sensing Image Range Axis LUT element; or
the DMG Sensing Image Doppler Axis LUT element.

15. A communication device, applicable to a sensing by proxy (SBP) responder supporting a first frequency band and a second frequency band, the communication device comprising:
a processor;
a memory, configured to store one or more executable instructions of the processor,
wherein the processor is configured to load the one or more executable instructions to cause the communication device to:
receive an SBP Request frame from an SBP initiator, wherein the SBP Request frame is used to request the SBP responder to perform sensing measurement of the second frequency band in a proxy mode, or request the SBP responder to perform sensing measurement of the first frequency band and the second frequency band in a proxy mode; and
transmit an SBP Response frame to the SBP initiator,
wherein the SBP initiator is a device that supports the first frequency band but does not support the second frequency band.

16. The communication device according to claim 15, wherein the processor is configured to load the one or more executable instructions to further cause the communication device to:
transmit an SBP Report frame to the SBP initiator, wherein the SBP Report frame carries at least one of the following elements or fields:
an SBP Type field;
a Sensing Measurement Report Container corresponding to the first frequency band;
a Sensing Report Control element corresponding to the second frequency band; or
a Sensing Report element corresponding to the second frequency band.

17. The communication device according to claim 16, wherein in a case where the SBP Request frame is used to request the SBP responder to perform sensing measurement of the second frequency band in a proxy mode, the SBP Report frame carries at least one of the following elements or fields:
the SBP Type field;
the Sensing Report Control element corresponding to the second frequency band; or
the Sensing Report element corresponding to the second frequency band;
or
in a case where the SBP Request frame is used to request the SBP responder to perform sensing measurement of the first frequency band and the second frequency band in a proxy mode, the SBP Report frame carries at least one of the following elements or fields:
the SBP Type field;
the Sensing Measurement Report Container corresponding to the first frequency band;
the Sensing Report Control element corresponding to the second frequency band; or
the Sensing Report element corresponding to the second frequency band.

18. The communication device according to claim 16, wherein in a case where the first frequency band is a Sub-7 frequency band, the SBP Report frame carries at least one of the following elements or fields:
the SBP Type field;
a Sensing Measurement Report Container corresponding to the Sub-7 frequency band;
a Directional Multi-Gigabit (DMG) Sensing Report Control element; or
a DMG Sensing Report element.

19. The communication device according to claim 18, wherein in a case where the first frequency band is the Sub-7 frequency band, and the SBP Request frame is used to request the SBP responder to perform sensing measurement of the second frequency band in a proxy mode, the SBP Report frame carries at least one of the following elements or fields:
the SBP Type field;
the DMG Sensing Report Control element; or
the DMG Sensing Report element;
or
in a case where the first frequency band is the Sub-7 frequency band, and the SBP Request frame is used to request the SBP responder to perform sensing measurement of the first frequency band and the second frequency band in a proxy mode, the SBP Report frame carries at least one of the following elements or fields:
the SBP Type field;
the Sensing Measurement Report Container corresponding to the Sub-7 frequency band;
the DMG Sensing Report Control element; or
the DMG Sensing Report element.

20. The communication device according to claim 16, wherein in a case where the first frequency band is a Directional Multi-Gigabit (DMG) frequency band, the SBP Report frame carries at least one of the following elements or fields:
the SBP Type;
a Sensing Measurement Report Container corresponding to a Sub-7 frequency band;
a DMG Sensing Report Control element; or
a DMG Sensing Report element.
